(19) United States
(12) Patent Application Publication
(10) Pub. No.: US 2007/0067370 A1
(43) Pub. Date: Mar. 22, 2007

(54) Information processing apparatus, information displaying apparatus, and information processing method

(76) Inventors: Tadashi Honda, Kanagawa (JP); Katsuyuki Omura, Tokyo (JP)

Correspondence Address: COOPER & DUNHAM, LLP, 1185 AVENUE OF THE AMERICAS, NEW YORK, NY, 10036, US

(21) Appl. No.: 11/521,181

(22) Filed: Sep. 13, 2006

(30) Foreign Application Priority Data
Sep. 16, 2005 (JP) 2005-270681
Sep. 7, 2006 (JP) 2006-243120

(51) Int. Cl. G06F 17/30

(52) U.S. Cl. 707/205

(57) ABSTRACT

An association output unit associates the contents information or the contents collection information received by an input receiving unit with predetermined contents information or predetermined contents collection information, and outputs associated information. A contents output unit outputs, from the contents information or the contents collection information that forms a tree structure including the predetermined contents information or the predetermined contents collection information, arbitrary contents information or arbitrary contents collection information included in the tree structure in response to a request from a user.

### CROSS-REFERENCE TO RELATED APPLICATIONS

The present document incorporates by reference the entire contents of Japanese priority documents, 2005-270681 filed in Japan on Sep. 16, 2005 and 2006-243120 filed in Japan on Sep. 7, 2006.

### BACKGROUND OF THE INVENTION

1. Field of the Invention

The present invention relates to an information processing apparatus, an information displaying apparatus, and an information processing method, and, more particularly to a technology for processing contents and a collection of contents for managing the content and providing users with the content.

2. Description of the Related Art

In recent years, information constituting jobs tends to be complicated because of sophistication and complication of the jobs. Therefore, there is a demand for a technology for easily providing a user with information in jobs.

As a technology for providing a user with information, there is, for example, the technology described in Japanese Patent No. 3279201. In this technology, information is collected in work spaces and managed. Every time the work spaces are changed, a state before the change is stored. It is possible to invoke a work space in a desired state in response to request of the user. The user can invoke a collection of desired information by invoking the desired work space. Thus, the user can follow fluctuation in work.

However, in the technology described in Japanese Patent No. 3279201, although information is managed in the work spaces, retention of a relation among the work spaces is not taken into account. Consequently, it is impossible to manage a job in which a collection of information forms a hierarchical structure. This problem may occur, for example, when people share work.

### SUMMARY OF THE INVENTION

It is an object of the present invention to at least partially solve the problems in the conventional technology.

An information processing apparatus according to one aspect of the present invention processes contents information that holds contents and contents collection information for managing a collection of contents information in a hierarchical structure. The information processing apparatus includes an input receiving unit that receives an input of contents information or contents collection information capable of forming a hierarchical structure; an association output unit that associates the contents information or the contents collection information received by the input receiving unit with predetermined contents information or predetermined contents collection information, and outputs the contents information or the contents collection information associated with the predetermined contents information or the predetermined contents collection information, to register in a storing unit; and a contents output unit that outputs, from the contents information or the contents collection information that forms a tree structure including the predetermined contents information or the predetermined contents collection information according to the association by the association output unit, arbitrary contents information or arbitrary contents collection information included in the tree structure in response to a request from a user.

An information display apparatus according to another aspect of the present invention includes an input processing unit that inputs contents information, contents collection information for managing the contents information in a hierarchical structure, and a hierarchical structure between pieces of the contents collection information, from an information processing apparatus; and a display processing unit that displays the contents information and the contents collection information input by the input processing unit in a hierarchical structure.

An information processing method according to still another aspect of the present invention is for processing contents information that holds contents and contents collection information for managing a collection of contents information in a hierarchical structure. The information processing method includes receiving an input of contents information or contents collection information capable of forming a hierarchical structure; association outputting including associating the contents information or the contents collection information received at the receiving with predetermined contents information or predetermined contents collection information, and outputting the contents information or the contents collection information associated with the predetermined contents information or the predetermined contents collection information, to register in a storing unit; and outputting, from the contents information or the contents collection information that forms a tree structure including the predetermined contents information or the predetermined contents collection information according to the association at the association outputting, arbitrary contents information or arbitrary contents collection information included in the tree structure in response to a request from a user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a network structure including clients used by users, a repository server that manages a database, a Web server that performs processing for providing the users with information, and a local area network (LAN) that connects the apparatuses, and structures of the respective apparatuses according to an embodiment of the present invention;

FIG. 2 is a diagram of a concept of a content management table according to the present embodiment;

FIG. 3 is a diagram of a structure of the content management table according to the present embodiment;

FIG. 4 is a diagram of a concept of a pack management table according to the present embodiment;

FIG. 5 is a diagram of a structure of the pack management table according to the present embodiment;

FIG. 6 is a diagram of a concept of a personal data management table according to the present embodiment;

FIG. 7 is a diagram of a concept of a user table according to the present embodiment;

FIG. 8 is a diagram of an example of a screen of a client application displayed by a display processing unit included in a client application according to the present embodiment;

FIG. 9 is a diagram of an example of a screen in creating a new pack from a left window in which a tree of the client application according to the present embodiment is shown;

FIG. 10 is a diagram of a dialog displayed by the display processing unit when “creation of an organization” of a creation menu of the client application according to the present embodiment is selected;

FIG. 11 is a diagram of a dialog displayed by the display processing unit when an authority detail button of “creation of an organization” of the creation menu of the client application according to the present embodiment is depressed;

FIG. 12 is a diagram of an example of a tree structure displayed in the left window by the display processing unit of the client application according to the present embodiment when pack information indicating an “organization 1” is added to the pack management table of the repository server;

FIG. 13 is a diagram of an example of a tree structure displayed in the left window by the display processing unit of the client application according to the present embodiment when pack information indicating a “project 1” is added to the pack management table of the repository server;

FIG. 14 is a diagram of an example of a tree structure of users displayed by the display processing unit of the client application according to the present embodiment;

FIG. 15 is a diagram of an example of a screen of a keyword retrieval dialog displayed by the display processing unit of the client application according to the present embodiment;

FIG. 16 is a diagram of an example of a screen of a result obtained by retrieval with the keyword retrieval dialog displayed by the display processing unit of the client application according to the present embodiment;

FIG. 17 is a diagram of a detail setting dialog for authority details, in which it is possible to set a disclosure level, displayed by the display processing unit of the client application according to the present embodiment;

FIG. 18 is a diagram of an example of a screen of a “display a route of a person” menu displayed by the display processing unit according to a member name displayed in a right window group of the client application according to the present embodiment;

FIG. 19 is a diagram of an example of a retrieved route of a person displayed by the display processing unit of the client application according to the present embodiment;

FIG. 20 is a diagram of an example of a table of a correspondence relation between keywords and users displayed by the display processing unit of the client application according to the present embodiment;

FIG. 21 is a diagram of an example of an action menu displayed by the display processing unit with respect to a pack indicating subjects displayed in the right window group of the client application according to the present embodiment;

FIG. 22 is a diagram of an example of an instruction dialog displayed by the display processing unit of the client application when a user selects “issue an instruction”;

FIG. 23 is a diagram of a login screen displayed by a Web browser of a client according to the present embodiment;

FIG. 24 is a diagram of an example of a To Do detail screen displayed by the Web browser of the client according to the present embodiment;

FIG. 25 is a diagram of an example of a meeting holding dialog displayed by the display processing unit of the client application according to the present embodiment;

FIG. 26 is a diagram of an example of a detail screen of a meeting displayed by the Web browser of the client according to the present embodiment;

FIG. 27 is a diagram of an example of an appeal registration dialog displayed by the display processing unit of the client application according to the present embodiment;

FIG. 28 is a diagram of an example of a confirmation dialog displayed by the display processing unit of the client application according to the present embodiment after registration of a subject in a “worry” list is completed from the client application according to the present embodiment;

FIG. 29 is a diagram of an example of a similarity retrieval dialog displayed by the display processing unit of the client application according to the present embodiment;

FIG. 30 is a diagram of an example of a similarity retrieval result dialog in which the display processing unit of the client application displays a result obtained by retrieval by the Web server according to the present embodiment;

FIG. 31 is a diagram of an example of display of packs in the past displayed by the display processing unit of the client application according to the present embodiment;

FIG. 32 is a diagram of an example of a screen of a “To Do view” displayed by the display processing unit of the client application according to the present embodiment;

FIG. 33 is a diagram of an example of a screen of a “status view” displayed by the display processing unit of the client application according to the present embodiment;

FIG. 34 is a diagram of an example of a screen of a “period view” displayed by the display processing unit of the client application according to the present embodiment;

FIG. 35 is a diagram of an example of a screen of a “hot/stagnant view” displayed by the display processing unit of the client application according to the present embodiment;

FIG. 36 is a diagram of an example of a screen of a “worry view” displayed by the display processing unit of the client application according to the present embodiment;

FIG. 37 is a diagram of an example of a screen of an “appeal view” displayed by the display processing unit of the client application according to the present embodiment;

FIG. 38 is a diagram of an example of a retrieval dialog displayed by the display processing unit of the client application according to the present embodiment when the user depresses a retrieval button;

FIG. 39 is a diagram of an example of a notice setting dialog displayed by the display processing unit of the client application according to the present embodiment when the user depresses a notice retrieval button;

FIG. 40 is a flowchart of a processing procedure until the user is authenticated in a user authenticating unit according to the present embodiment;

FIG. 41 is a flowchart of a processing procedure until packs are added in the Web server and the client according to the present embodiment;

FIG. 42 is a flowchart of a processing procedure until a tree displayed in the client is acquired and outputted in a client-information acquiring unit of the Web server according to the present embodiment;

FIG. 43 is a flowchart of a processing procedure until hot information displayed in the client is acquired and outputted in the client-information acquiring unit according to the present embodiment;

FIG. 44 is a flowchart of a processing procedure until information for each of statuses such as “subject in progress”, “subject not started”, and “subject completed” displayed in the client is acquired and outputted in the Web server according to the present embodiment;

FIG. 45 is a flowchart of a procedure of detailed processing of client apportioning processing performed by the client-information acquiring unit of the Web server according to the present embodiment;

FIG. 46 is a flowchart of a procedure until information on a member list indicated by member names displayed in the client is acquired and outputted in the Web server according to the present embodiment;

FIG. 47 is a flowchart of a processing procedure until information on a content list displayed in the client is acquired and outputted in the Web server according to the present embodiment;

FIG. 48 is a flowchart of a processing procedure until information on a user tree displayed in the client is acquired and outputted in the Web server according to the present embodiment;

FIG. 49 is a flowchart of a processing procedure performed when packs are moved by the client application of the client in the Web server and the client according to the present embodiment;

FIG. 50 is a flowchart of a processing procedure performed when keyword retrieval is performed by the client application of the client in the Web server according to the present embodiment;

FIG. 51 is a flowchart of a procedure of detailed processing of information retrieval applied to respective packs in the Web server according to the present embodiment;

FIG. 52 is a flowchart of a processing procedure until a route to a predetermined person is acquired and outputted to the client in the Web server according to the present embodiment;

FIG. 53 is a flowchart of a processing procedure until information is retrieved with an automatically set keyword and outputted in the Web server according to the present embodiment;

FIG. 54 is a flowchart of a processing procedure performed when “issue an instruction” is selected by the client application of the client in the Web server and the client according to the present embodiment;

FIG. 55 is a flowchart of a processing procedure performed when “hold a meeting” is selected by the client application of the client in the Web server and the client according to the present embodiment;

FIG. 56 is a flowchart of a processing procedure performed when “make an appeal” is selected by the client application of the client in the Web server and the client according to the present embodiment;

FIG. 57 is a flowchart of a processing procedure performed when “worry” is selected by the client application of the client in the Web server and the client according to the present embodiment;

FIG. 58 is a flowchart of a processing procedure performed when “retrieve a similar content” is selected by the client application of the client in the Web server according to the present embodiment;

FIG. 59 is a flowchart of a processing procedure performed when “retrieve content in the past” is selected by the client application of the client in the Web server according to the present embodiment;

FIG. 60 is a flowchart of a processing procedure performed when the client application of the client receives request displaying a To Do view in the Web server and the client according to the present embodiment;

FIG. 61 is a flowchart of a processing procedure performed when the client application of the client receives request to display a status view in the Web server and the client according to the present embodiment;

FIG. 62 is a flowchart of a processing procedure performed when the client application of the client receives request to display a period view in the Web server and the client according to the present embodiment;

FIG. 63 is a flowchart of a processing procedure performed when the client application of the client receives request to display a hot/stagnant view in the Web server and the client according to the present embodiment;

FIG. 64 is a flowchart of a processing procedure performed when the client application of the client receives request to display a worry view in the Web server and the client according to the present embodiment;

FIG. 65 is a flowchart of a processing procedure performed when the client application of the client receives request to display an appeal view in the Web server and the client according to the present embodiment;

FIG. 66 is a flowchart of a processing procedure performed in an appeal display subroutine of the client-information acquiring unit of the Web server according to the present embodiment;

FIG. 67 is a flowchart of a processing procedure performed when retrieval of an appeal view displayed is selected by the client application in the Web server according to the present embodiment;

FIG. 68 is a flowchart of a processing procedure performed when an input of setting of a notice function is received in the appeal view in the Web server and the client according to the present embodiment;

FIG. 69 is a flowchart of a processing procedure for performing retrieval based on the notice function set in the Web server according to the present embodiment;

FIG. 70 is a flowchart of a procedure of detailed processing of retrieval in a periodic retrieval unit of the Web server according to the present embodiment;

FIG. 71 is a diagram of a hardware configuration of a personal computer (PC) that executes a program for realizing a function of the Web server, the client, or the repository server according to the present embodiment;

FIG. 72 is a flowchart of a processing procedure for, according to retrieval and display request for packs from a user of a client 10a according to the present embodiment, searching through a content management database 53, generating information for display corresponding to a display request using link information on packs of a retrieval result, and causing the client 10a to display a display screen based on the information for display; and

FIG. 73 is a flowchart of a processing procedure for, according to retrieval and display request for packs from the user of the client 10a according to the present embodiment, searching through the content management database 53, generating information for display corresponding to display request using link information on packs of a retrieval result, and causing the client 10a to display a display screen based on the information for display.

### DETAILED DESCRIPTION OF THE PREFERRED EMBODIMENTS

Exemplary embodiments of the present invention are explained in detail below with reference to the accompanying drawings.

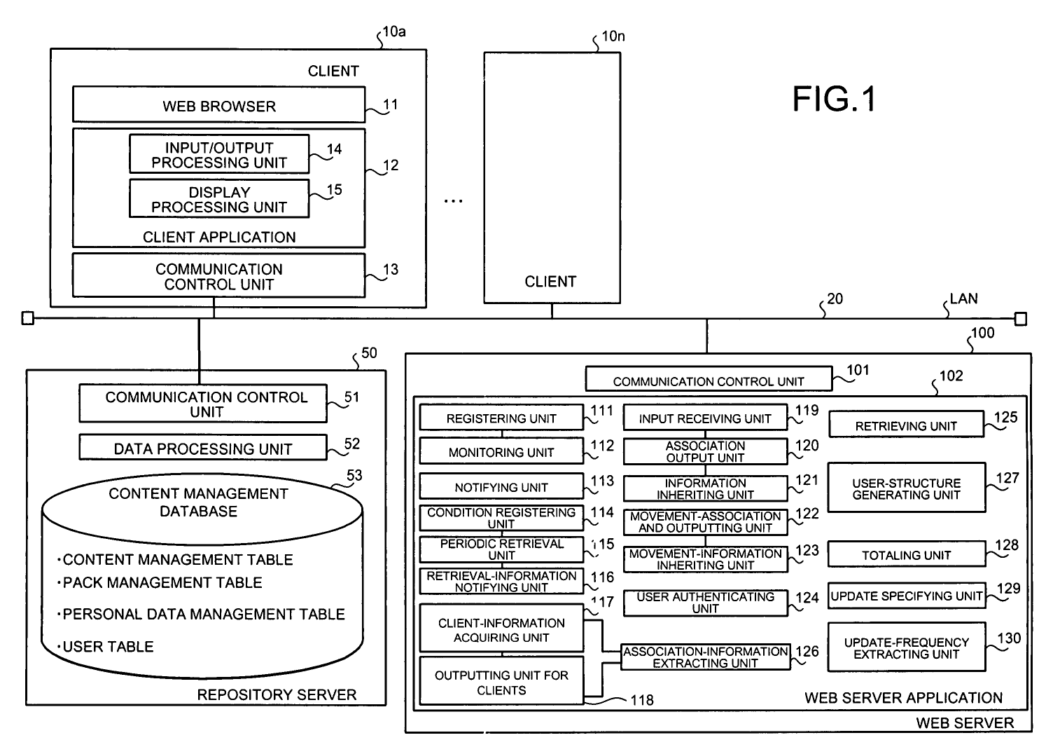

FIG. 1 is a block diagram of a network structure including clients 10a to 10n used by users, a repository server 50 that manages a database, a Web server 100 that performs processing for providing the users with information, and a local area network (LAN) 20 that connects the apparatuses, and structures of the respective apparatuses. The users can refer to contents using the clients 10a to 10n shown in the figure. When the clients 10a to 10n receive request for processing such as operation for contents from the users, the clients 10a to 10n request the Web server 100 to execute the processing. The Web server 100 applies the processing requested to the repository server 50.

Contents are information used by the users and may be any information like a file such as a text, an image, a moving image, and sound used by the users or a link associated with other information.

The repository server 50 shown in FIG. 1 includes a communication control unit 51, a data processing unit 52, and the content management database 53. The repository server 50 applies processing to the content management database 53 in response to request from the Web server 100 described later.

As a structure of the repository server 50, for example, it is conceivable to use technologies such as MySQL for a database, JavaBeans using JDBC for a processing unit, and a Web service for an interface. Since the repository server 50 has such a structure, the repository server 50 can easily operate.

The content management database 53 holds a content management table, a pack management table, a personal data management table, and a user table.

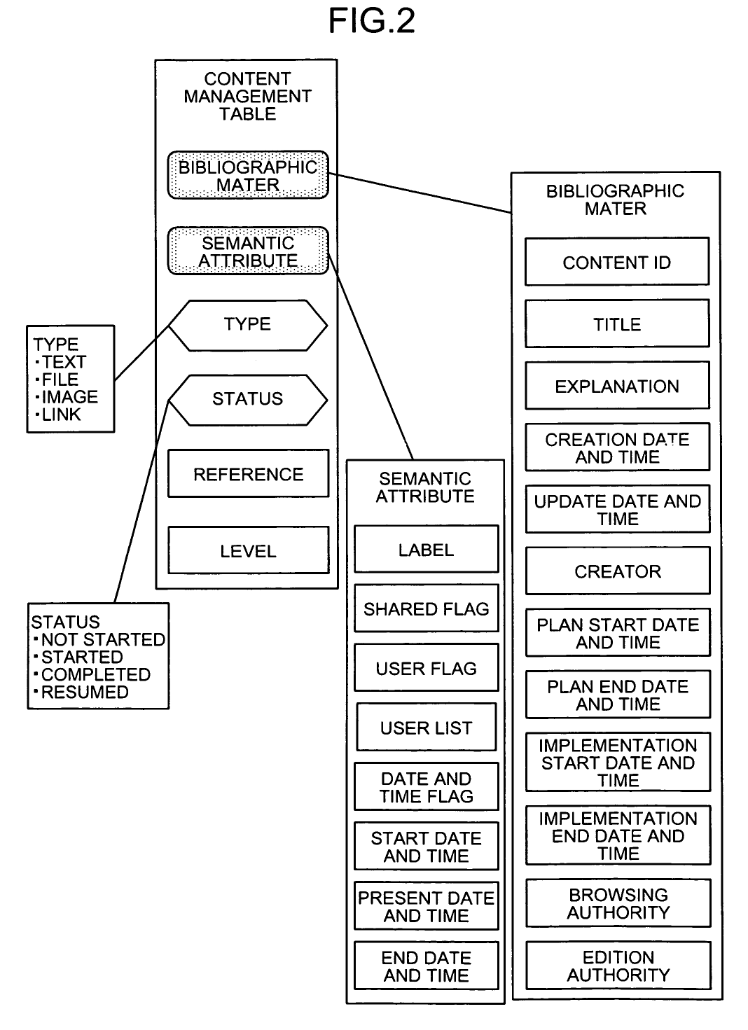

FIG. 2 is a diagram of a concept of the content management table. As shown in the figure, the content management table holds a bibliographic matter, a semantic attribute, a type, a status, a reference, and a level in association with one another. The bibliographic matter and the semantic attribute hold a plurality of elements. In the present embodiment, since the bibliographic matter and the semantic attribute are held in an XML format, it is possible to hold the respective elements in a hierarchical structure. The bibliographic matter and the semantic attribute are not limited to the XML format. Any format may be used as long as the elements can be held. The elements held by the bibliographic matter and the semantic attribute are explained in detail later.

The type holds information for specifying a type of this content. The type stores any one of a text, a file, an image, and a link as information for specifying content. The status holds information indicating a present state of this content. The status stores any one of not started/planned, started, completed, and resumed. The reference holds, when the type is any one of the file, the image, and the link, a place where substance of data of the type is present. For example, when the type is the file or the image, the reference holds a path and a file name in a hard disk. As another example, when the type is the link, the reference holds a uniform resource locator (URL) like http://xxx.yyy.co.jp. The level is an element for setting to what kind of users this content is shown. The level is described in detail later.

The bibliographic matter holds a content ID, a title, an explanation, a creation date and time, an update date and time, a creator, a plan start date and time, a plan end date and time, an implementation start date and time, an implementation end date and time, an browsing authority, and an edition authority as elements. The content ID held by the bibliographic matter is an ID for identifying content. The content ID is issued when data is created anew. When compared to a property of a file of MS-WINDOWS®, the bibliographic matter is a concept for holding a file name in the title, holding an explanation of the file in the explanation, holding a creator of the file in the creator, and holding security information on the file in the browsing authority and the edition authority. The plan start/end date and time holds a date and time planned from the start of use of the content until the end of the use. The implementation start/end date and time holds an actual date and time from the start of use of the content until the end of the use.

The semantic attribute holds data for storing an intention of the user. In the present embodiment, the semantic attribute holds a label, a shared flag, a user flag, a user list, a date and time flag, a start date and time, a present date and time, and an end date and time as elements. For example, a character string “To Do” is set in the label, ‘True’ is set in the user flag, an ID of a user who acts as a person in charge is set in the user list, ‘True’ is set in the date and time flag, and a predetermined date and time is set in the end date and time. In this case, the content means “To Do for which the predetermined date and time set in the end date and time is an appointed date of delivery and a user specified by the user ID held by the user list is a person in charge”. The information held by “To Do” is a task that should be performed for a job. In the data structure, it is possible to represent various meanings by combining the elements in the semantic attribute in this way.

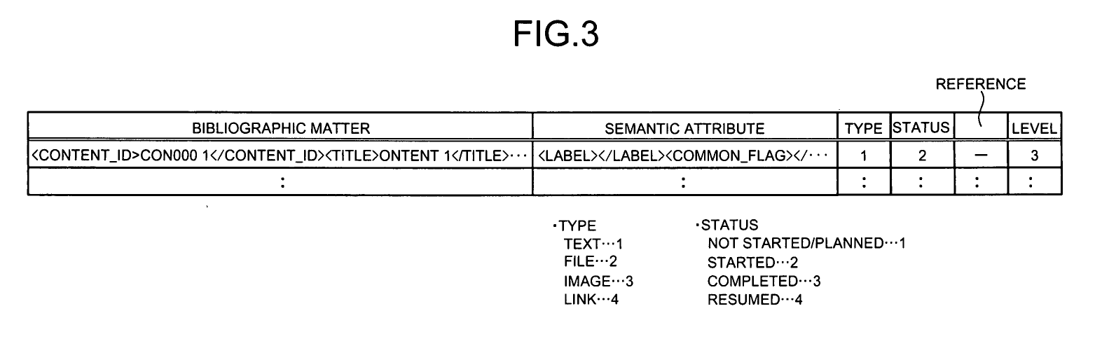

FIG. 3 is a diagram of a structure of the content management table. As shown in the figure, the content management table holds a bibliographic matter, a semantic attribute, a type, a status, a reference, and a level as fields. The bibliographic matter and the semantic attribute hold elements in the XML format. Since the content management table holds the respective elements in this way, it is possible to hold data in an object structure in a relational database. The present embodiment does not limit management of data to the relational database. For example, a database capable of holding the object structure may be used.

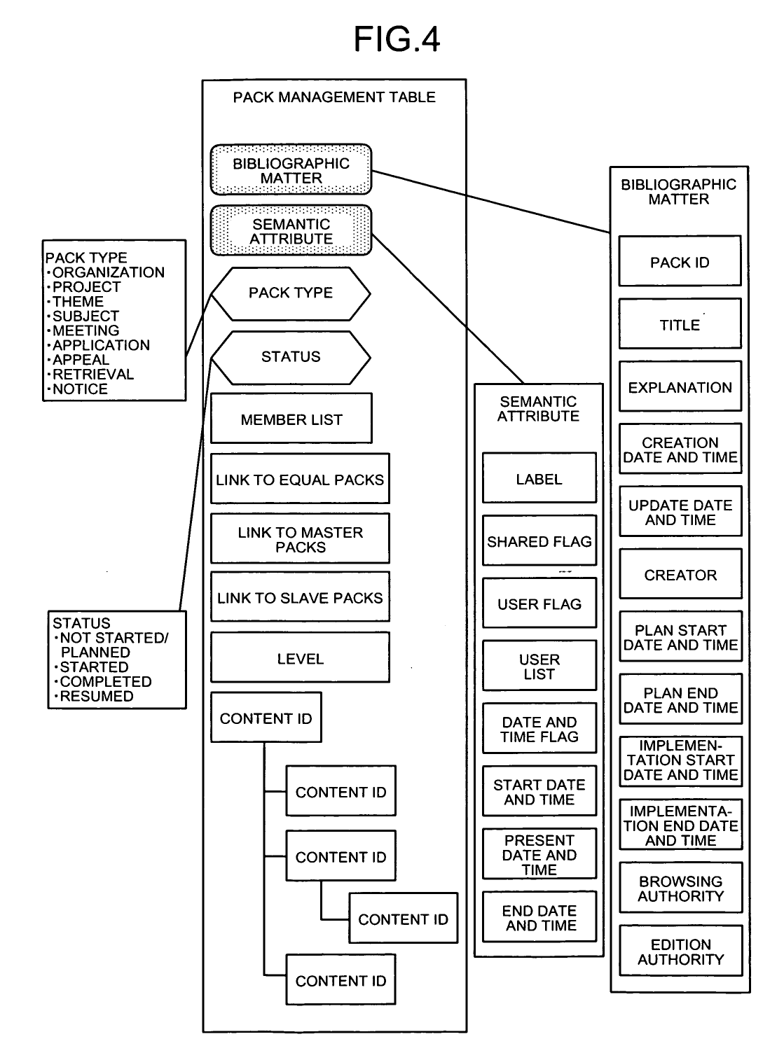

FIG. 4 is a diagram of a concept of the pack management table. As shown in the figure, the pack management table holds a bibliographic matter, a semantic attribute, a pack type, a status, a member list, a link to equal packs, a link to master packs, a link to slave packs, a level, and a content ID in association with one another.

The pack plays a role of filing content in a bundle. In other words, the pack is equivalent to contents collection information. The bibliographic matter and the semantic attribute hold a plurality of elements in the XML format in the same manner as the case of the content management table. The bibliographic matter and the semantic attribute are not limited to the XML format. Any format may be used as long as the elements can be held. The bibliographic matter is substantially the same as the bibliographic matter of the content. However, the bibliographic matter is different from the bibliographic matter of the content in that the content ID is changed to a pack ID and an element indicating a place is added. The semantic attribute holds the same elements as those held by the semantic attribute of the content. An explanation of the semantic attribute is omitted.

The pack type holds information for specifying a type of the pack. In the present embodiment, types of the pack type are an organization, a project, a theme, a subject, a meeting, an application, an appeal, retrieval, and a notice. The pack type holds information for specifying any one of these types. The status is the same as the status of the content management table. An explanation of the status is omitted. The member list holds a user ID for identifying a user involved in this pack. The member list can hold a plurality of user IDs. For example, when the pack type is an organization, the member list holds user IDs of users belonging to the organization. For example, when the pack type is a meeting, the member list stores user ID of users participating in the meeting.

The link to equal packs holds a pack ID for identifying a pack in an equal relation with the pack. The link to master packs holds a pack ID for identifying a pack in a relation of a master with the pack. The link to slave packs holds pack IDs for identifying packs in a slave relation with the pack. The link to equal packs, the link to master packs, and the link to slave packs make it possible to hold a plurality of pack IDs. Since the link to equal packs, the link to master packs, and the link to a salve pack hold the respective pack IDs, it is possible to tie (link) the pack and a pack related to the pack.

The level is the same as the level of the content and explained in detail later. The content ID holds content IDs managed by the pack. The content ID holds the content IDs in a tree structure. The tree structure of the content ID is made possible by using the XML format in the present embodiment. However, any format may be used as long as the tree structure can be realized.

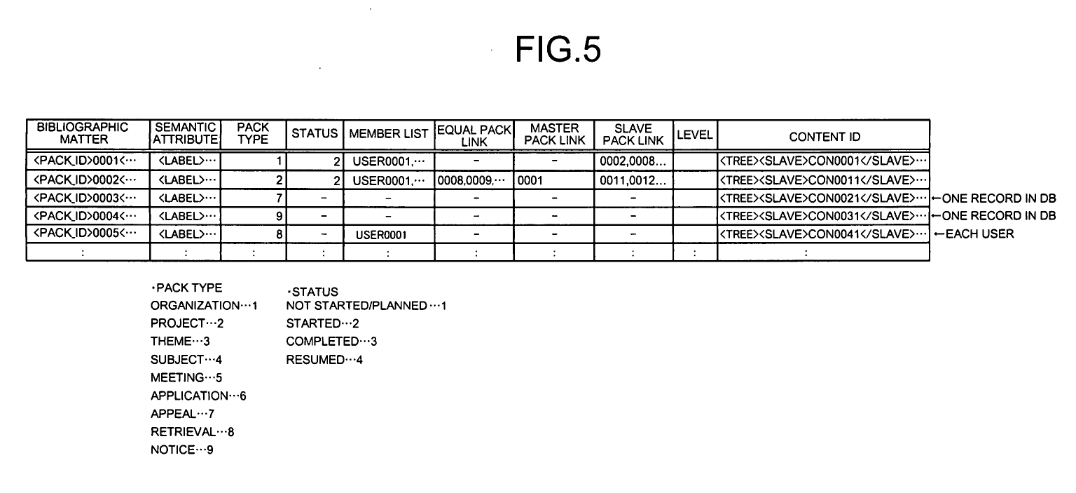

FIG. 5 is a diagram of a structure of the pack management table. As shown in the figure, the pack management table holds a bibliographic matter, a semantic attribute, a pack type, a status, a member list, a link to equal packs, a link to master packs, a link to slave packs, a level, and a content ID. The bibliographic matter and the semantic attribute hold elements in the XML format. Since the content management table holds the respective elements in this way, it is possible to hold data in the object structure in a relational database. The present embodiment does not limit management of the data to the relational database. For example, a database capable of holding the object structure may be used. One record with the pack type of an appeal and one record with the pack type of a notice are registered in the pack management table, respectively. Pack information with the pack type of the appeal holds content of a specific type, that is, contents information to be appealed. In other words, the pack information is equivalent to a predetermined type of contents collection information. One record with the pack type of retrieval is registered for each user. The use of these records is described later.

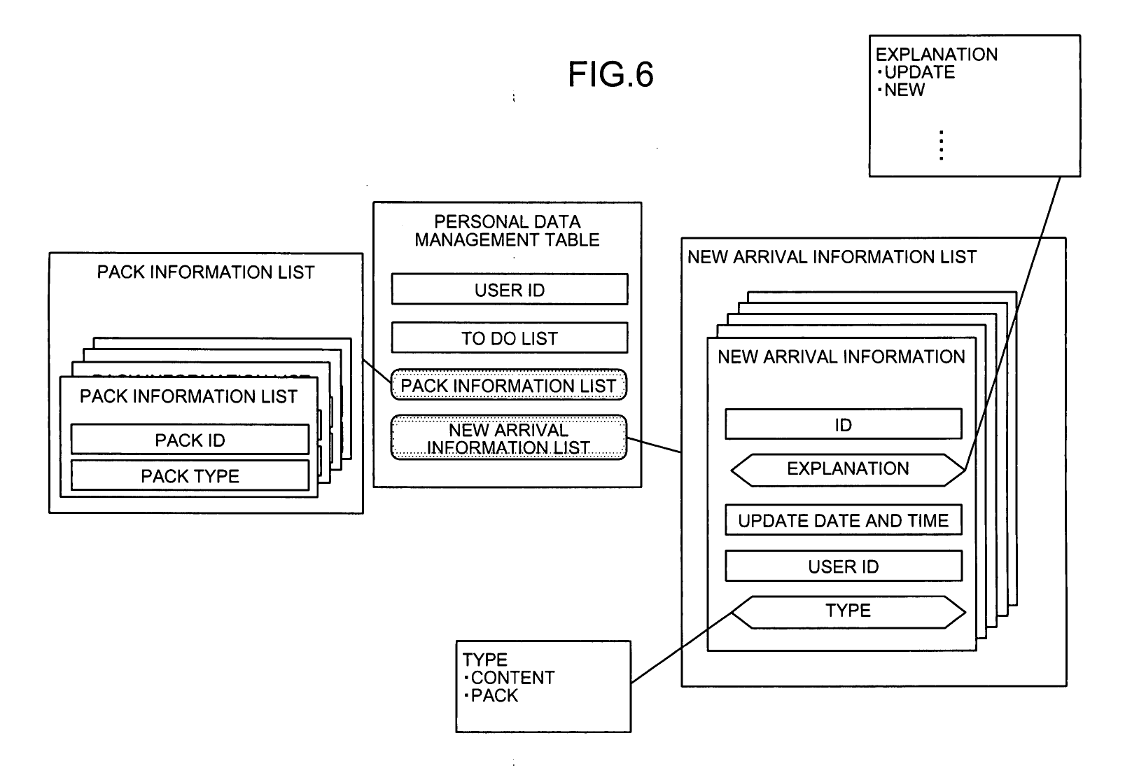

FIG. 6 is a diagram of a concept of the personal data management table. As shown in the figure, the personal data management table holds a user ID, a To Do list, a pack information list, and a new arrival information list in association with one another. Personal data held by each record performs a function of index to data owned by a user. The user ID makes it possible to identify who owns the personal data held by the record. The To Do list holds content, a type of which is “To Do”, in the content management table as a list. Consequently, it is possible to refer to To-Do contents that the user should process.

The pack information list holds a pack ID for identifying a pack, for which a user ID of the user is included in the member list, among packs held by the pack management table and a type of the pack. The pack information list holds the pack ID and the type in the XML format, it is possible to hold pack IDs and pack types of a plurality of pieces of pack information. Since the pack information list holds the pack ID, it is possible to refer to the pack information held by the pack management table.

The new arrival information list holds new arrival information generated when a pack, for which a user ID of the user is included in the member list, or a pack, for which a user ID of the user is included in the user list of the semantic attribute, is generated or updated or when content, for which a user ID of the user is included in the user list of the semantic attribute, is generated or updated. Since the new arrival information list holds the pack ID and the type of the pack in the XML format, it is possible to hold a plurality pieces of new arrival information that hold a plurality of elements. The new arrival information holds an ID, an explanation, an update date and time, a user ID, and a type as elements. The ID is a pack ID or a content ID. The type indicates a pack or content. The explanation indicates what kind of processing is applied to the pack or the content. As examples of the explanation, ‘UPDATE’, ‘NEW’, and the like are conceivable. The update date and time holds a date and time when processing is applied to the pack or the content. The user ID holds a user ID of a user who applied the processing to the pack or the content.

The number of pieces of new arrival information held by the new arrival information list is not specifically limited. For example, an infinite number of pieces of new arrival information may be held. It is also possible that one hundred pieces of new arrival information is held and, when the number of pieces of new arrival information exceeds one hundred, the new arrival information held earlier is deleted.

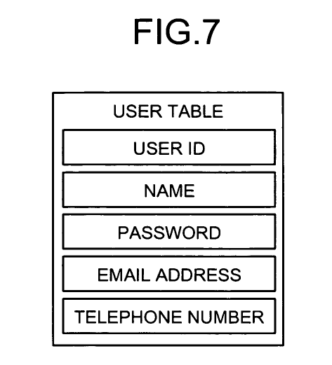

FIG. 7 is a diagram of a concept of the user table. As shown in the figure, the user table holds a user ID, a name, a password, an email address, and a telephone number in association with one another. The user table manages various kinds of information on a user who uses this system. In the present embodiment, the personal data management table and the user table are constituted as separate tables. However, user information may be managed by one table. Since the user table that manages the various kinds of information on the user is provided separately from the personal data management table, it is easy to use data held by the user table in other systems.

Referring back to FIG. 1, the communication control unit 51 is connected to the LAN 20 and performs control for transmitting and receiving information between the repository server 50 and the Web server 100 or the clients 10a to 10n. The communication control unit 51 serves as an interface that receives request from the Web server 100 and the clients 10a to 10n.

The data processing unit 52 applies processing to a table held by the content management database 53 described later. Examples of the processing performed by the data processing unit 52 include creation, update, deletion, retrieval, and acquisition of data stored in the content management database 53.

Since the data processing unit 52 uses a structured query language (SQL) sentence, it is possible to easily perform creation, update, deletion, retrieval, and acquisition of data stored in the content management database 53. Consequently, the data processing unit 52 can execute management of the data.

In adding a new record to the table, the data processing unit 52 needs to set an ID for identifying data added to the record. Various methods have been proposed as a method of issuing new ID. In the present embodiment, any one of the methods may be used.

General processing of creation, update, deletion, retrieval, and acquisition applied to the table by the data processing unit 52 is explained. First, after the communication control unit 51 receives data to be registered from the Web server 100, the data processing unit 52 issues a new ID corresponding to the data. The data processing unit 52 adds the ID issued and the data received to the table in association with each other. Processing for adding the ID and the data to the table uses an insert sentence of the SQL.

After the data processing unit 52 performs the addition processing, the communication control unit 51 transmits the issued ID to the Web server 100. Examples of information that the data processing unit 52 adds to the table by issuing the ID anew include contents information and pack information. In other words, the communication control unit 51 transmits a content ID for identifying contents information and a pack ID for identifying pack information to the Web server 100. Consequently, the Web server 100 is capable of identifying contents information or pack information requested to be added to the table.

When the communication control unit 51 receives data to be overwritten in the table together with request for the overwriting from the Web server 100 or the like, the data processing unit 52 applies update of the data to the table. The data processing unit 52 uses an update sentence of the SQL for the update of the data. When the update is successful, the communication control unit 51 transmits an indication of the success to the request source.

When the communication control unit 51 receives an ID or the like for identifying data together with request for deletion of the data from the Web server 100 or the like, the data processing unit 52 applies the deletion of the data to the table. The data processing unit 52 uses a delete sentence of the SQL for the deletion of the data. When the deletion is successful, the communication control unit 51 transmits an indication of the success to the request source.

The data processing unit 52 retrieves data from the table based on a condition. As the retrieval of data, the data processing unit 52 uses a select sentence of the SQL, and designates the condition with a WHERE phrase. The data processing unit 52 performs acquisition of data according to the same processing procedure. In this case, an ID for identifying the data is designated in the WHERE phrase. The data acquired or retrieved by the data processing unit 52 is used for various applications.

Referring back to FIG. 1, the client 10a includes a Web browser 11, a client application 12, and a communication control unit 13. The client 10a applies processing to the content management database 53 in response to request from the Web server 100 described later. Since the clients 10b to 10n have the same structure as the client 10a, explanations of the clients 10b to 10n are omitted. The clients 10a to 10n are used by users.

The communication control unit 13 is connected to the LAN 20 and performs control for transmitting and receiving information between the client 10a and the Web server 100 or the repository server 50. The communication control unit 51 serves as an interface that transmits request to or receives a result of request from the Web server 100.

The Web browser 11 may be any browser. For example, InternetExplorer® and Netscape® are conceivable.

The client application 12 includes an input/output processing unit 14 and a display processing unit 15. The client application 12 requests the Web server 100 to perform processing or displays a result of processing performed by the Web server 100.

The input/output processing unit 14 receives an input from the user and performs processing for requesting the Web server 100 to perform processing via the communication control unit 13 and processing of a result received from the Web server 100 via the communication control unit 13.

The display processing unit 15 performs processing for displaying a result of processing in the input/output processing unit 14 on a not-shown monitor.

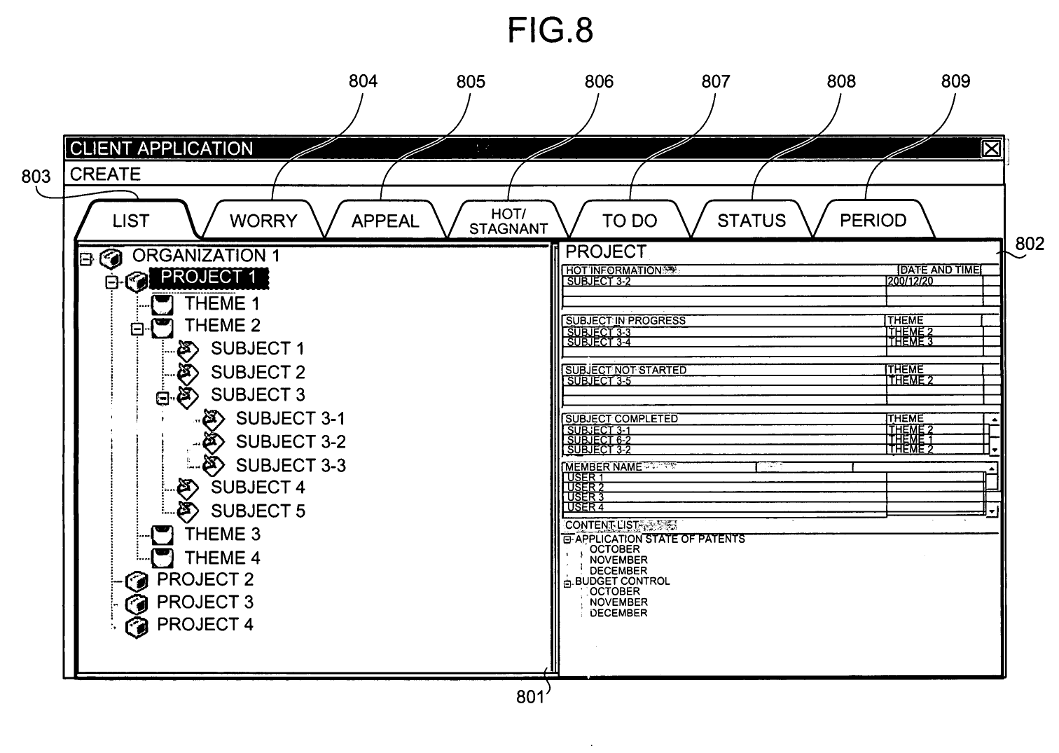

FIG. 8 is a diagram of an example of a screen of the client application 12 displayed by the display processing unit 15. As shown in the figure, the display processing unit 15 displays packs in a left window 801 in a tree structure. The display processing unit 15 displays, in a right window group 802, a list group of detailed information on a pack selected in the tree of the left window 801. When the user clicks any one of a list tag 803, a worry tag 804, an appeal tag 805, a hot/stagnant tag 806, a To-Do tag 807, a status tag 808, and a period tag 809, the client application 12 can switch a view to be displayed. The switching of a view is not limited to the switching by tags. Any method may be used for the switching.

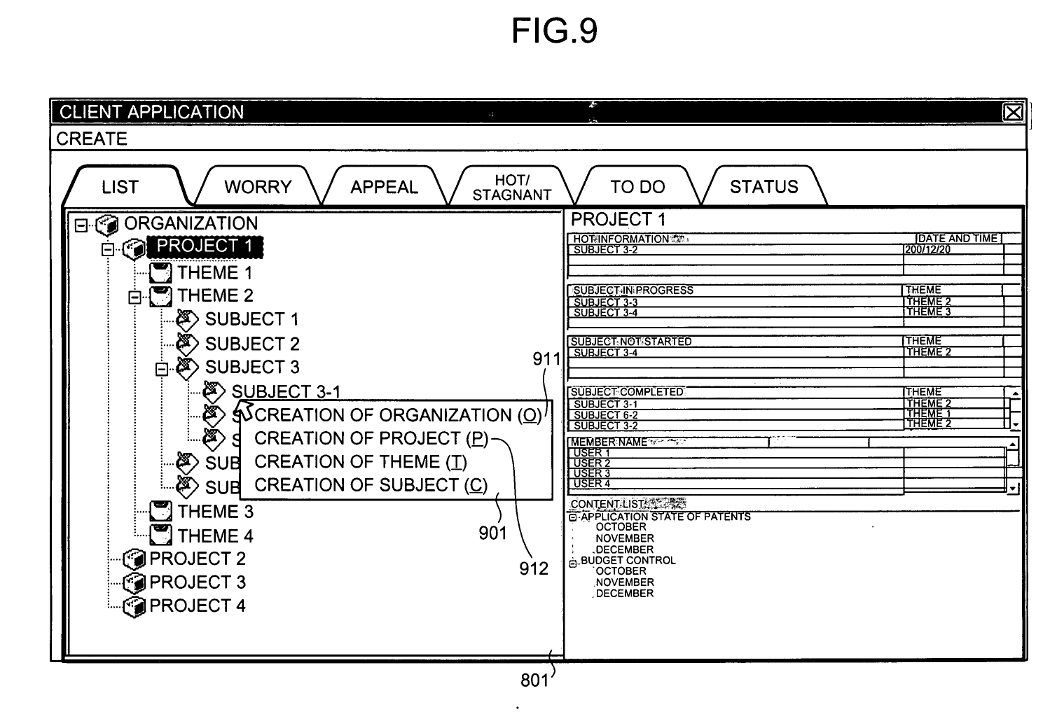

FIG. 9 is a diagram of an example of a screen in generating a new pack from the left window 801 in which the tree of the client application is shown. As shown in the figure, when the user moves a mouse cursor into a tree display section and performs right click, the display processing unit 15 displays a creation menu 901. Respective items are selected in the creation menu 901.

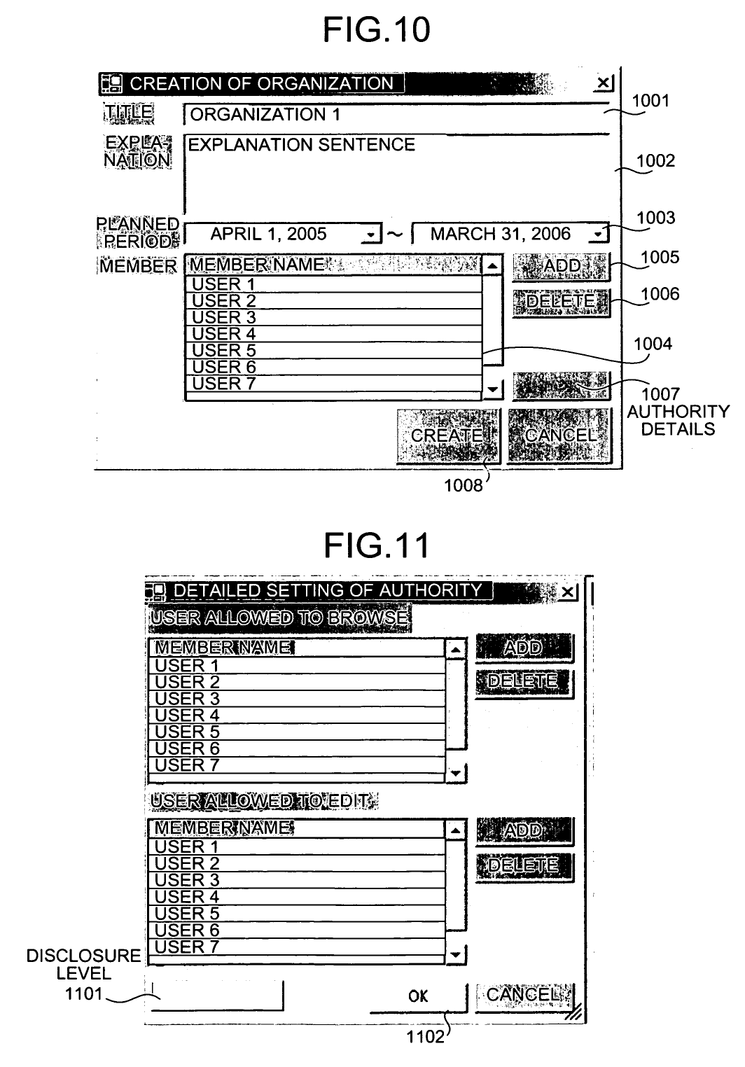

FIG. 10 is a diagram of a dialog displayed by the display processing unit 15 when the user selects “creation of an organization” 911 of the creation menu 901 shown in FIG. 9. As shown in the figure, in the dialog, the display processing unit 15 displays spaces and items for receiving inputs of a title 1001, an explanation 1002, a planned period 1003, and a member 1004. In the dialog, the user inputs a name of an organization to the title 1001 and inputs an explanatory note concerning the organization to the explanation 1002. The user inputs a start date and an end date planned of the organization to the planned period 1003. The user inputs members to the member 1004 using an addition button 1005 and a deletion button 1006′. When the user depresses the addition button 1005, the display processing unit 15 displays a user list. The user selects one or more users from the user list and adds the users to the members. When the user desires to delete one or more users from the list of the member 1004, the user selects the members and, then, depresses the deletion button 1006. Consequently, the display processing unit 15 displays a state in which the members selected are deleted from the member 1004. Processing performed when an authority detail button 1007 is depressed is described later. After inputting the data to the items and the spaces, when the user depresses a creation button 1008, processing by the input/output processing unit 14 is started. After the processing by the input/output processing unit 14 is started, pack information indicating the organization is added to the repository server 50 via the Web server 100.

The title shown in FIG. 10 needs to be input by the user. At least one member needs to be input. The explanation, the start data, and the end date do not need to be input but are desirably input. Processing performed when a pack is added is described later.

FIG. 11 is a diagram of a dialog displayed by the display processing unit 15 when the authority detail button 1007 is depressed. In the dialog shown in the figure, the user can set a browsing authority and an edition authority for a pack indicating an organization being created. After the display processing unit 15 displays the dialog, when the user does not set authority details, the browsing authority and the edition authority are given to all members displayed in the dialog of FIG. 11. The present embodiment does not limit the browsing authority and the edition authority to be given to all the members. For example, only browsing may be permitted for the members. An authority for permitting edition may be given only to a creator of the pack indicating the organization. The browsing authority and the edition authority may be permitted only for the creator of the pack indicating the organization without giving the browsing authority and the edition authority to the members. Any setting may be performed as a default value.

When the user sets one or more of a user allowed to perform browsing and a user allowed to perform edition using the addition button and the deletion button and depresses an OK button 1102 in the dialog shown in FIG. 11, the display processing unit 15 closes the dialog. The display processing unit 15 arranges the dialog shown in FIG. 10 in the front on a desktop and displays the dialog again. In the dialog shown in FIG. 10, the display processing unit 15 does not display the users for whom the browsing authority and the edition authority are set in FIG. 11. However, the input/output processing unit 14 owns a browsing authorized user list and an edition authorized user list as data. The user can set a disclosure level of the pack by depressing a disclosure level button 1101. Details of the setting are described later.

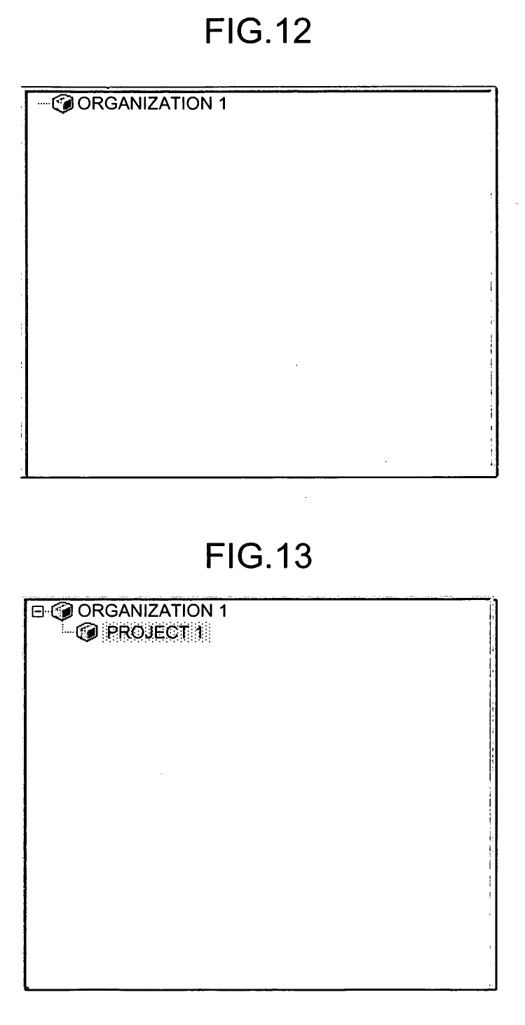

FIG. 12 is a diagram of an example of a tree structure displayed in the left window by the display processing unit 15 of the client application 12 when pack information indicating an “organization 1” is added to the pack management table of the repository server 50 by the processing described above. As shown in the figure, pack information added to the users for whom the browsing authority is set is displayed.

When the tree structure shown in FIG. 12 is displayed, the user performs right click of a not-shown mouse on the “organization 1”. Consequently, the display processing unit 15 displays the creation menu 901 shown in FIG. 9. The user selects “creation of a project” 912 from the creation menu 901. When the user performs right click of the mouse on the “organization 1”, the Web server 100 generates pack information having the “organization 1” as a master pack via the client application 12. Processing for generating a “project 1” performed by the Web server 100 is different from the processing for generating the “organization 1” in that a “project” is set in a pack type of pack information and that a pack ID for identifying the “organization 1”, which is the master pack, is set in a link to master packs of a pack. The Web server 100 adds a pack ID of the pack “project 1” to a link to slave packs of a record that holds the “organization 1” of the pack management table of the repository server 50. Otherwise, the processing for generating the “project 1” is the same as the processing for generating the “organization 1”. Specifically, this processing is performed by the Web server 100. A detailed explanation of the processing is described later.

In generating the “project 1”, when the display processing unit 15 displays the dialog shown in FIG. 11, the user list having the browsing authority and the edition authority displays a state inherited from the pack “organization 1”. Details of processing for inheriting the state are described later.

In the conventional database, projects or the like and organizations are considered different and held by separate tables. Therefore, it is necessary to change the organizations every time the projects or the like are planned. This makes processing for managing users complicated.

In the packs used in the present embodiment, user IDs are held by a member list. As the packs are layered, groups and organizations necessary for a job are formed. An information management system including the Web server 100 of the present embodiment can dynamically change, every time organizations and projects corresponding to a job are created, users participating in the job. The information management system changes members or the like participating in the job every time packs are generated, changed, or deleted as required. For example, when a job is moved from a pack of a certain project to a pack of another project, it is possible to change organizations to which the users belongs without changing the conventional organization DB or the like. In this way, it is possible to reduce processing concerning the organizations to which the users belong and reduce errors in updating the organizations to which the users belong.

FIG. 13 is a diagram of an example of a tree structure displayed in the left window by the display processing unit 15 of the client application 12 when pack information indicating the “project 1” is added to the pack management table of the repository server 50. When a slave pack is added to the pack management table of the repository server 50 in this way, the client application 12 performs transmission and reception to and from the Web server 100 to perform display with the addition reflected thereon.

Pack information that can be added is not limited to organizations and projects. It is possible to add any packs such as themes and subjects using the procedure described above.

The right window group 802 shown in FIG. 8 indicates an example of a screen displayed when the user places the cursor on the “project 1” of the left window 801 and performs left click of the mouse. Details of the right window group 802 displayed by the display processing unit 15 are “hot information2, “subject in progress”, “subject not started”, “subject completed”, “member name”, and “content list”. Information displayed in these items is based on a result of processing obtained when the client application 12 requests the Web server 100 to perform the processing. For example, when the input/output processing unit 14 of the client application 12 receives left click in a state in which the cursor is placed on the “project 1”, the input/output processing unit 14 acquires a pack ID from Tag of TreeNode. The input/output processing unit 14 transmits request to display respective items together with the pack ID to the Web server 100. Consequently, the Web server 100 can acquire information on respective items associated with a pack of the pack ID transmitted by the input/output processing unit 14 from the content management database 53 of the repository server 50. The Web server 100 performs processing associated with the pack ID and the respective items. The client 10a receives a result of the processing. This makes it possible to display detailed information on the respective items.

The information corresponding to the respective items is briefly explained. The “Hot information” is acquired from new arrival information having a pack ID input by the user from a new arrival information list held by personal data of a login user in the personal data management table.

As the “subject in progress”, the “subject not started”, and the “subject completed”, pack information corresponding to a pack ID input by the user is acquired from the pack management table, a tree is traced based on a pack ID held in a link to slave packs of the pack acquired, a pack group present in a hierarchy below the pack acquired in the pack management table is acquired, statuses of packs with a pack type “subject” are checked in respective packs of the pack group acquired, and the packs are apportioned for each of a subject in progress, a subject not started, and a subject completed. The processing for tracing the link to slave packs is executed until all links to slave packs held by the pack information are traced.

Since the Web server 100 performs such processing, it is possible to specify pack information displayed in the “subject in progress”, the “subject not started”, and the “subject completed”. When the display processing unit 15 displays the “subject in progress”, the “subject not started”, and the “subject completed”, it is necessary to display a title of a “theme” of a master pack. Since pack information on the master pack is acquired when the tree is traced, it is possible to easily extract a title of a bibliographic matter of the master pack.

Since the Web server 100 performs such processing, it is possible to extract all subjects, which are slave packs of the project 1, and apportions the subjects as a subject in progress, a subject not started, and a subject completed. The display processing unit 15 of the client application 12 displays respective apportioned lists received from the Web server 100 in the respective spaces of the “subject in progress”, the “subject not started”, and the “subject completed”.

As the “member name”, a user ID held by a member list of pack information indicating the “project 1” is acquired from the pack management table and user information associated with the user ID is acquired from the user table.

As the “content list”, a content ID held by pack information indicating the “project 1” is acquired from the pack management table and contents information associated with the content ID is acquired from the content management table. A tree structure of the content list is established based on the XML format held by the content ID of the pack management table.

In the tree structure shown in FIG. 8, a tree structure of packs is displayed. However, since the Web server 100 acquires user information associated with member lists held by the respective packs, the display processing unit 15 of the client application 12 can display a user tree structure. This user tree structure is a tree in which members belonging to each pack are displayed using the tree structures of packs. This makes it possible to grasp an arrangement of users in a structure of a job indicated by the packs.

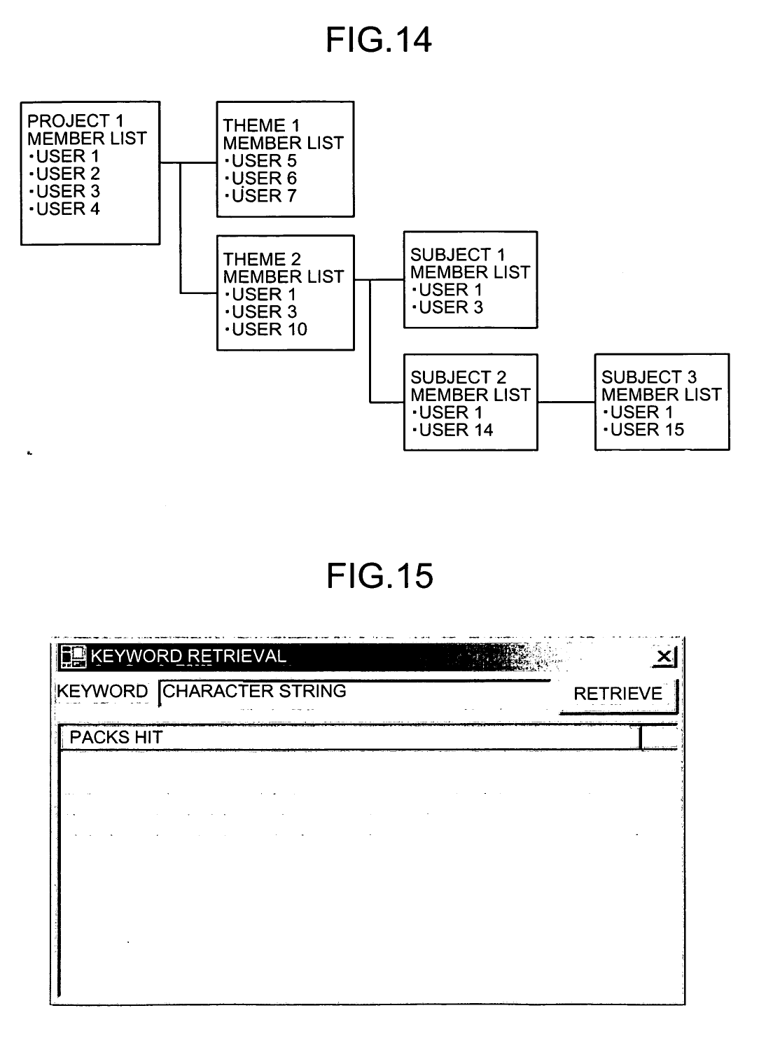

FIG. 14 is a diagram of an example of a tree structure of users displayed by the display processing unit 15. As shown in the figure, the project 1 has a theme 1 and a theme 2 as slave packs. The theme 2 has a subject 1 and a subject 2 as slave packs. The subject 2 has a subject 3 as a slave pack. The respective packs hold member lists in the pack management table. In the respective packs shown in the figure, user names of users specified from the member lists are displayed. A relation among the users is represented by connections of the packs.

The pack information holds the links to equal packs, master packs, and salve packs described above. This makes it possible to perform retrieval of information by tracing the tree.

When the user designates a pack or content from the tree or the right window group 802 displayed by the display processing unit 15, a tree with the pack or the content designated as a reference is displayed anew depending on a situation. Specifically, the client 10a outputs information indicating the pack or the content selected to the Web server 100. The Web server 100 generates, based on the information indicating the pack or the content input, a tree including the pack or the content. The client 10a acquires the tree including the pack or the content from the Web server 100. The display processing unit 15 of the client 10a displays the tree acquired. Processing of the Web server 100 for generating a tree is described later.

In outputting information indicating a pack or content for generating a tree to the Web server 100, the client 10a may designate a requirement for generating the tree. As an example of the requirement, when a tree constituted by packs is generated, it is conceivable to receive designation of a value of a pack type or a status (information indicating a value of a pack type or a status) from the user and request the Web server 100 to generate a tree constituted only by packs, pack types or statuses of which take the value. As the requirement for a pack to be generated, for example, generation of a “route of a person” described later may be requested. The same holds true for content. Thus, an explanation of the content is omitted.

FIG. 15 is a diagram of an example of a screen of a keyword retrieval dialog displayed by the display processing unit 15. A user 14 performs keyword retrieval from the keyword retrieval dialog shown in FIG. 15. The user 14 belongs to the member list of the subject 2 as shown in FIG. 14.

The user 14 inputs a keyword to the keyword retrieval dialog shown in FIG. 15 and depresses a retrieval button. Then, a retrieval request is transmitted to the Web server 100. The Web server 100 retrieves pack information on the subject 2 of the repository server 50 based on a keyword character string designated by the user 14. An object of the retrieval of the pack information is a bibliographic matter of the pack. The Web server 100 retrieves, using a content ID held by the pack information as a key, contents information associated the content ID in the content management table. When contents information coincides with the keyword as a result of the retrieval, the Web server 100 holds a pack ID and a title coinciding with the keyword. After the retrieval ends for the subject 2, the Web server 100 acquires a link to slave packs of the pack of the subject 2 and applies the same retrieval to respective packs in a hierarchy below the pack of the subject 2. After the retrieval ends for the lower hierarchy, the Web server 100 acquires a link to master packs of the pack of the subject 2 and applies the same retrieval to respective packs in a hierarchy above the pack of the subject 2. In this case, the Web server 100 acquires a link to slave packs of the respective packs in the upper hierarchy and applies the same retrieval to the respective packs in the lower hierarchy by tracing the tree in the slave direction acquired. The Web server 100 applies keyword retrieval to all packs in the tree by performing the retrieval as described above. The Web server 100 holds a list of pack IDs and titles coinciding with the keyword. The Web server 100 transmits a list of pack IDs and titles held therein to the client 10a. Consequently, the display processing unit 15 of the client application 12 displays a retrieval result based on the list of pack IDs and titles received.

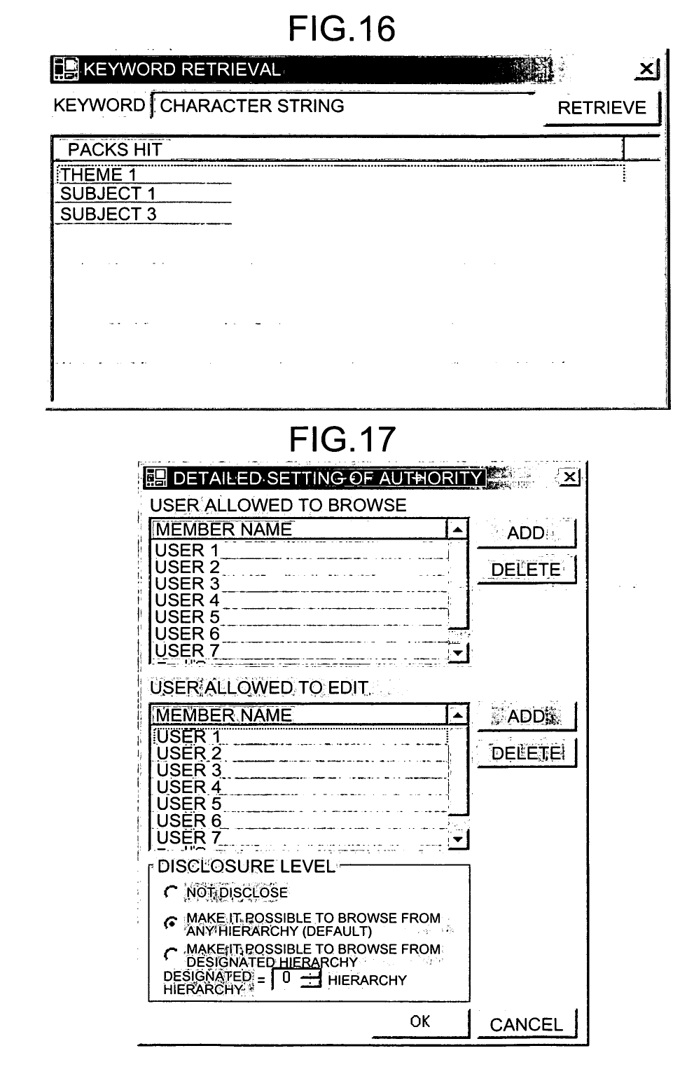

FIG. 16 is a diagram of an example of a screen of a result obtained by retrieval using the keyword retrieval dialog displayed by the display processing unit 15. As shown in the figure, in the keyword retrieval dialog, the theme 1, the subject 1, and the subject 3 are hit. As indicated by the user tree structure of FIG. 14, browsing authorities for all of the theme 1, the subject 1, and the subject 3 are not set for the user 14. However, in the processing by the Web server 100 according to the present embodiment, when predetermined operation such as keyword retrieval is performed, it is possible to perform browsing regardless of a browsing authority. Details of this processing are described later. When the user 14 selects a desired pack out of packs hit, the display processing unit 15 displays detailed information on the pack selected in the right window group of the client application 12 shown in FIG. 8. Such a procedure allows the user to browse information based on a keyword.

Even if retrieval is based on a keyword, it may be undesirable to permit the user to browse information based on the keyword. Thus, in generating pack information, information retrieval performed by tracing a tree has a function for setting a hierarchy (a level) to which information may be disclosed. Consequently, it is possible to judge whether information retrieval is permitted according to a hierarchy in which the user is present. As the setting of a disclosure level, it is possible to set a disclosure level of the pack by depressing the disclosure level button 1101 in the dialog shown in FIG. 11.

FIG. 17 is a diagram of a detail setting dialog for authority details, in which it is possible to set a disclosure level for a pack, displayed by the display processing unit 15. “Not disclose” indicates that information retrieval performed by tracing a tree is not permitted. “Browsing is allowed from any hierarchy” indicates that information retrieval by tracing a tree from any hierarchy is permitted. “Browsing is allowed from a designated hierarchy” indicates that condition retrieval is permitted when a hierarchy set is equal to or higher than the number of hierarchies traced from a retrieval source. A value set at this disclosure level is held at a level of the pack information.

The Web server 100 sets a disclosure level set in the dialog to a level of pack information on the pack management table. When “not disclose” is set, the Web server 100 sets ‘−2’ as a level. When “browsing is allowed from any hierarchy” is set, the Web server 100 sets ‘−1’ as a level. When “browsing is allowed from a designated hierarchy” is set, the Web server 100 sets a numerical value input by the user as a level. When a level is ‘0’, the Web server 100 discloses information only when the tree is traced from the same hierarchy. When a level is ‘1’, the Web server 100 discloses information only when the tree is traced from one master or slave hierarchy. When a level is ‘2’, the Web server 100 discloses information only when the tree is traced from two master or slave hierarchies. In this way, a value of a level is set to disclose information when the tree is traced from master or slave hierarchies, a number of which is equivalent to a number n of a level.

It is possible to display a route of a human relation from the user to a predetermined person using the user tree structure described above. When the user grasps presence of information requested according to the keyword information retrieval described above, since a pack including the information is displayed in, for example, the right window group 802 of FIG. 8, the user can grasp a person who has the information. When the person is not a person acquainted with the user, it is necessary to have the person introduced via an acquaintance or the like. Thus, it is possible to specify a route from the user to the person who has the information based on the route of a human relation in the user tree.

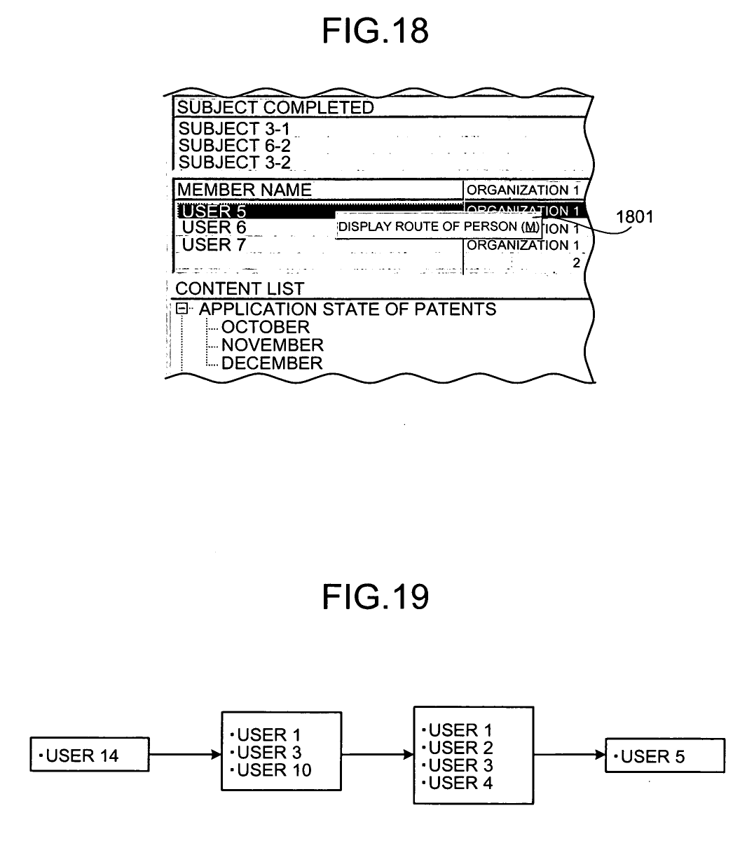

FIG. 18 is a diagram of an example of a screen of a “display a route of a person” menu displayed by the display processing unit 15 from a member name displayed in the right window group 802 of the client application 12. As shown in the figure, when the user places the cursor on a person displayed in the member name and performs right click of the mouse, the menu is displayed.

When the user clicks “display a route of a person”, request to display a route of a person is transmitted from the client 10a to the Web server 100. Consequently, the Web server 100 retrieves a route from the user 14 to a user 5. A processing procedure in retrieving a route is described later. A result of the retrieval by the Web server 100 is transmitted to the client 10a.

FIG. 19 is a diagram of an example of a retrieved route of a person displayed by the display processing unit 15 of the client application 12. As shown in the figure, the user 14 is capable of grasping a route to the user 5 who has information. Therefore, it is considered that, for example, the user 14 is capable of making contact with the user 5 through introduction of the user 1 or the user 3.

Instead of the keyword retrieval by the user, a method with which the client application 12 and the Web server 100 perform retrieval with a keyword automatically set and present a user who has information is conceivable. First, the Web server 100 extracts a keyword from an object pack referred to by the user based on information transmitted to the client application 12. Various methods have already been proposed for keyword extraction. In this case, any one of the methods may be used. For example, when keyword extraction is applied to a pack of the subject 2 to which the user 14 belongs, it is conceivable that, for example, the Web server 100 extracts two keywords, a keyword 1 and a keyword 2, from the pack. The Web server 100 performs information retrieval according to the same procedure as described above using the keywords extracted. Specifically, the Web server 100 traces the tree and holds packs hit by the respective keywords. The Web server 100 acquires a member list associated with a plurality of packs held. The Web server 100 transmits the keywords and members hit by the keywords in association with each other. The display processing unit 15 of the client application 12 displays a correspondence relation between the keywords and the users received as a table.

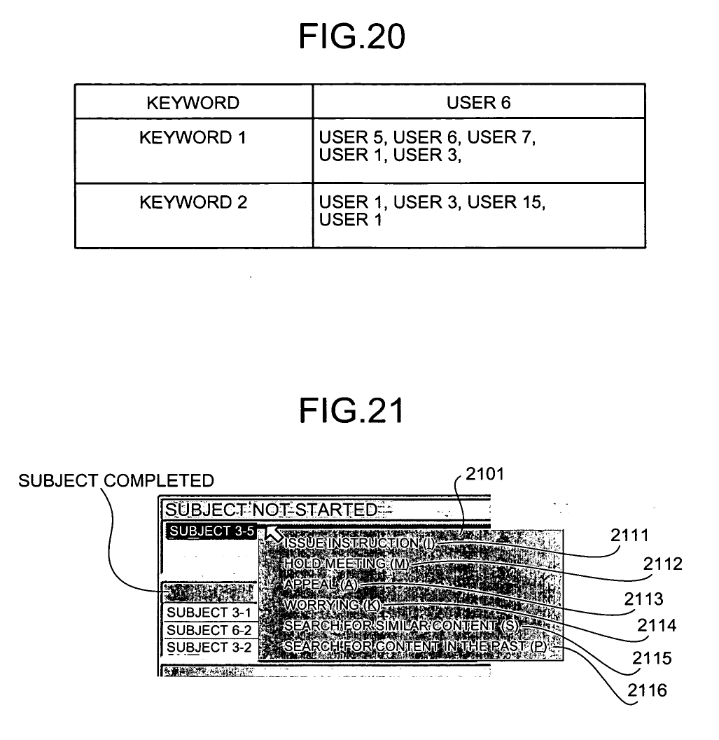

FIG. 20 is a diagram of an example of a table showing a correspondence relation between keywords and users displayed by the display processing unit 15. As shown in the figure, users 5, 6, 7, 11, and 12 have information on the keyword 1. Users 11, 12, 15, and 16 have information on the keyword 2.

The functions realized by representing a human tree have been explained. Actions that the user can take with respect to packs or contents are explained below. Actions that the user can take with respect to clients or packs are, for example, “issue an instruction”, “hold a meeting”, “make an appeal”, “worries”, “retrieve similar content”, and “retrieve content in the past”.

FIG. 21 is a diagram of an example of an action menu displayed by the display processing unit 15 with respect to packs indicating subjects displayed in the right window group 802. As shown in the figure, the user can select an action, which the user can take, by placing the cursor on a pack displayed and performing right click.

First, the user selects “issue an instruction” 2111 from an action menu 2101. The user clicks the “issue an instruction” 2111 in the action menu 2101 to select “issue an instruction”.

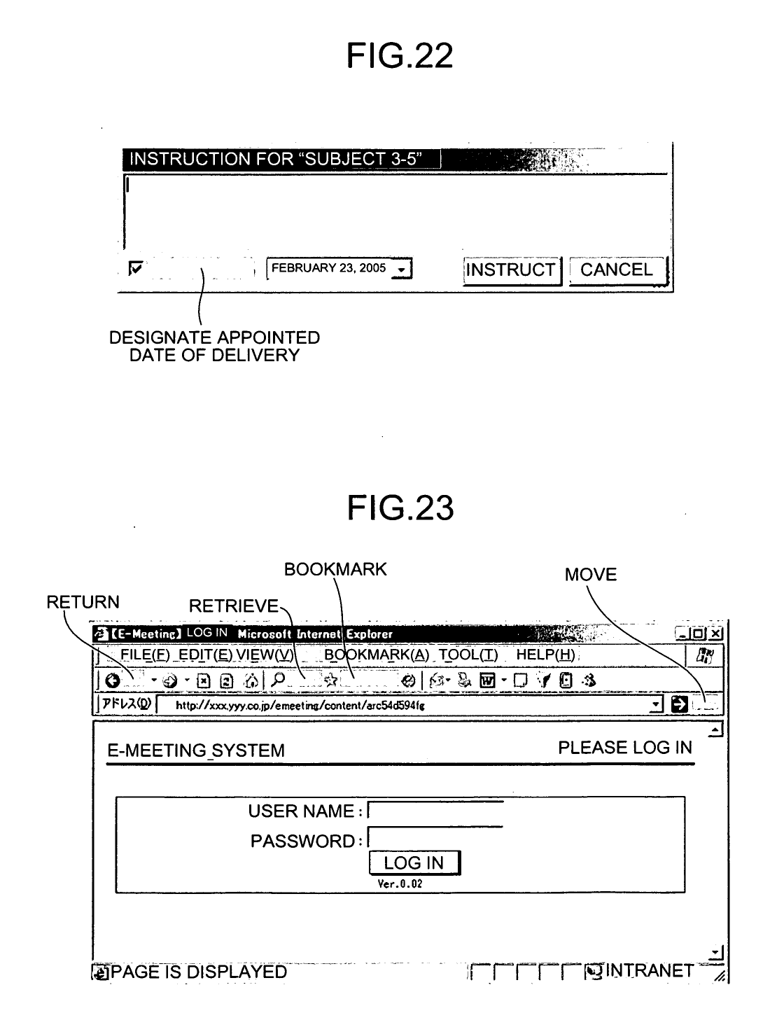

FIG. 22 is a diagram of an example of an instruction dialog displayed by the display processing unit 15 of the client application 12 when the user selects “issue an instruction”. In a dialog shown in the figure, a text box in which details of an instruction are described, a checkbox in which an indication of whether an appointed date of delivery is designated is set, a date designation box in which an appointed date of delivery is set, an “instruct” button, and a “cancel” button are displayed. When the user describes details of instruction in the text box, sets an appointed date of delivery, and depresses the “instruct” button, the Web server 100 starts processing for an instruction received.

When the Web server 100 receives an instruction, the Web server 100 acquires pack information corresponding to a pack ID of a “subject 3-5” received together with the instruction from the pack management table. The Web server 100 starts generation of new content stored in a pack acquired.

First, the Web server 100 prepares empty content on a not shown memory. The Web server 100 sets content of the text box in a title of a bibliographic matter of the content prepared. The Web server 100 sets a present date and time in a creation date and time and an update date and time of the content prepared. The Web server 100 sets a login user in a creator of the content prepared. The Web server 100 causes a browsing authority and an edition authority of the content prepared to inherit a browsing authority and an edition authority of a bibliographic matter of an object pack. The Web server 100 sets a text in a type. Moreover, the Web server 100 sets “To Do” in a label of a semantic attribute. The Web server 100 sets a user flag to “True”, sets a user of a member list of an object pack in a user list, and sets a date and time of the date and time box in an end date and time. When a checkbox is checked in the dialog, the Web server 100 sets a date and time flag to “True”. When the checkbox is not checked in the dialog, the Web server 100 sets the date and time flag to “False”. The Web server 100 sets not started/planned in a status of the content prepared.

The content created by the Web server 100 in the processing described above is added to the content management table of the repository server 50. As a result, the data processing unit 52 of the repository server 50 issues a new content ID. The Web server 100 receives the content ID issued. The Web server 100 instructs the repository server 50 to add the content ID received to a content ID list of a pack indicating the “subject 3-5” of the pack management table of the repository server 50.

In adding the content ID to the content ID list according to the processing described above, the content ID may be added to any position of a tree structure held by the content ID list. For example, When other content IDs are not added to the content ID list of the pack indicating the “subject 3-5”, the new content ID is added to a top hierarchy of the tree of the content ID list of the content.

As another example, the cursor is placed on arbitrary content to display an action menu in the content list of the tree structure shown in FIG. 8 and an action for issuing an instruction is performed by the action menu. In this case, the client application 12 transmits a content ID of the content on which the cursor is placed to the Web server 100. Consequently, the Web server 100 adds a new content ID as a slave element of a content ID received in a content ID list of an object pack.

In this way, the Web server 100 adds the new content ID to a pack. Specifically, the Web server 100 realizes the addition of the new content ID by requesting the repository server 50 to update a record of the pack with a record including the content ID added in the pack management table.

Moreover, the Web server 100 specifies a user to whom an instruction is issued according to a user ID included in the member list of the subject 3-5. The Web server 100 requests the repository server 50 to add, in the personal data management table, the new content ID to a To Do list of personal data of the user specified. The Web server 100 creates new arrival information from a creation date and time and a creator of the new content ID. The Web server 100 adds, in the personal data management table, the new arrival information created to a new information list of the personal data of the user in the member list of the subject 3-5.

Information displayed by the client application 12 used by the user in the member list of a subject 305 is updated. When the processing corresponding to “instruct” is performed by the processing described above, the display processing unit 15 of the client application 12 changes hot information to a To Do view described later and displays the To Do view. In other words, the display processing unit 15 displays a title, a date and time, and the like of the new arrival information created anew in the space of the hot information on the right window group 802.

The Web server 100 may transmits instruction content to the user in the member list of the subject 3-5 by email. This is made possible by acquiring an email address of a corresponding user from the user table managed by the repository server 50. Specifically, the Web server 100 acquires an email address of a login user from the user table as a transmission source and acquires an email address of a user included in a user list of a semantic attribute of a To-Do contents created from the user table as a transmission destination. The Web server 100 sets an instruction from the login user in a subject of the email. The Web server 100 sets a URL for referring to a title of a bibliographic matter of an object pack, content of the text box, and the To-Do contents as a text of the email. As this URL, any URL may be adopted as long as the URL is a URL that makes it possible to refer to the To-Do contents such as a URL obtained by combining a content ID with a root URL for accessing the Web server 100.

The Web server 100 performs processing for transmitting an email using the transmission source, the transmission destination, the subject, and the text set as described above. A method of email transmission may be any existing method. For example, when a MimeMessage class of the Java language is used, any method is conceivable. For example, a method of setting a transmission source with a setfrom method of the MimeMessage class, setting a transmission destination with a setRecipients method, setting a subject with a setsubject method, setting a text with a setContent method, and transmitting MimeMessage with a send method of a Transport class may be adopted.

When the user receives the email, the user clicks a URL of the To-Do contents in the text to start the Web browser 11.

FIG. 23 is a diagram of a login screen displayed by the Web browser 11. As shown in the figure, a user name and a password are received on the login screen. When the user inputs a user name and a password and depresses a login button, the Web browser 11 transmits the user ID and the password to the Web server 100 via the communication control unit 13. The Web server 100 requests the repository server 50 to transmit a password associated with a user ID designated from the user table. The Web server 100 performs collation to judge whether the password received from the repository server 50 and the password input to the Web browser 11 coincide with each other. When the Web server 100 judges that both the passwords coincide with each other, the Web server 100 performs login processing for the user.

The Web server 100 extracts a content ID from a designated URL. The Web server 100 requests the repository server 50 to acquire contents information associated with the content ID from the content management table. After acquiring the contents information from the repository server 50, the Web server 100 requests the repository server 50 to acquire pack information, which manages the contents information, from the pack management table. The Web server 100 extracts necessary information from the contents information and the pack information acquired and outputs the information to the Web browser 11.

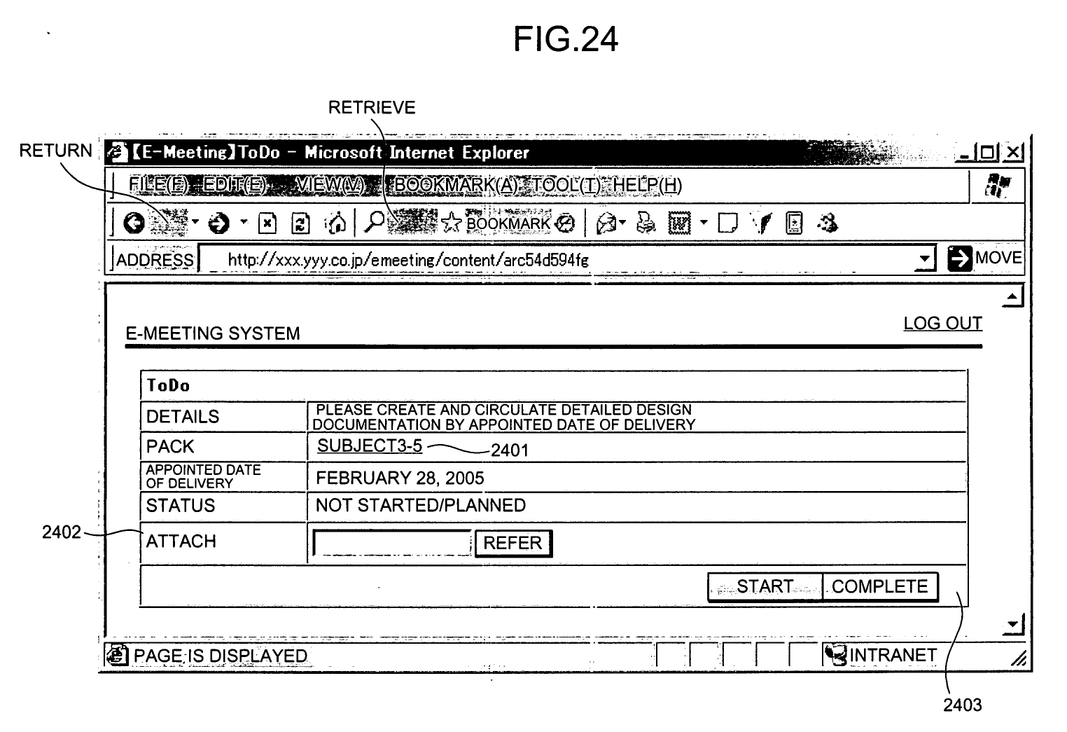

FIG. 24 is a diagram of an example of a To Do detail screen displayed by the Web browser 11. As shown in the figure, the Web browser 11 sets a title of a bibliographic matter of content in details, sets a title of a bibliographic matter of a pack that manages the content in a pack, sets an end date and time of a semantic attribute of the content in an appointed date of delivery, and sets a status of the content in a status and displays the tiles, the end date and time, and the status.

In the To Do detail screen shown in FIG. 24, an anchor is set in a pack 2401 indicating the “subject 3-5”. When the user clicks the pack 2401, the Web browser 11 displays details of the pack. As detailed display of the pack, for example, it is conceivable that the Web browser 11 displays the right window group 802 of the client application 12 as a table.

It is possible to attach a document created at the time of processing of the “To Do” to an attachment space 2402 shown in FIG. 24. In registering the document, when the user depresses a reference button, the Web browser 11 displays a file selection dialog. This allows the user to select a file to be attached.

Start and complete buttons 2403 shown in FIG. 24 are buttons for changing a status of the “To Do”. When the start button displayed on the Web browser 11 is depressed, the content ID and an indication that the start button is depressed are transmitted from the Web browser 11 to the Web server 100. Therefore, the Web server 100 requests the repository server 50 to change a status of a record specified by the content ID to “start” in the content management table. Consequently, a status of corresponding content is changed to “started” and, when the complete button is depressed, the status of the content is changed to “completed” and the content is updated in a content table.

In this way, when the user issues an instruction to other users, simply by quite naturally inputting an item necessary for issuing an instruction, the user can apply addition and update to a corresponding table of the Web server 100 without making the other users aware that registration in a database is performed. Such an effect is realized not only when the “issue an instruction” 2111 is selected from the action menu 2101 but also when “hold a meeting” 2112, “make an appeal” 2113, “worried” 2114, or the like described later is selected.

The user selects the “hold a meeting” 2112 from the action menu 2101. When the user clicks the “hold a meeting” 2112 in the action menu 2101, a meeting holding dialog is displayed.

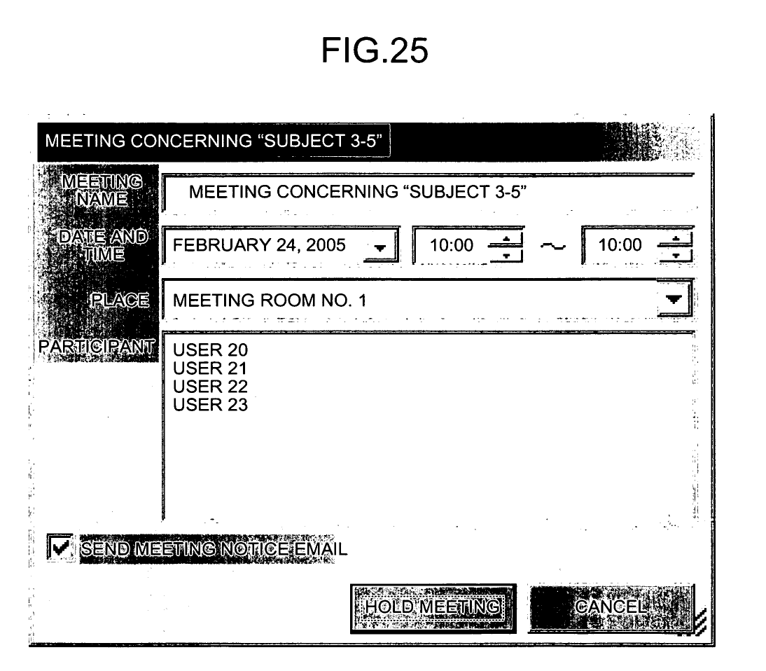

FIG. 25 is a diagram of an example of a meeting holding dialog displayed by the display processing unit 15. When the display processing unit 15 displays the meeting holding dialog as shown in the figure, the input/output processing unit 14 transmits a pack ID and an indication that the meeting holding dialog is displayed to the Web server 100. The Web server 100 requests the repository server 50 to acquire an object pack from the pack management table using the pack ID received.

The Web server 100 outputs a user ID and a user name included in a member list of pack information acquired. Consequently, in displaying the meeting holding dialog, the display processing unit 15 sets a user of the user name included in the member list as a participant. Naturally, the user can change the setting as the participant in the meeting holding dialog. The user inputs a meeting name, a date and time, and a place. The user performs setting in a checkbox to indicate whether a meeting notice email should be sent. When the setting ends, the user depresses a “hold a meeting” button. Consequently, the Web server 100 performs processing for setting the holding of a meeting. A detailed processing procedure for setting the holding of a meeting is described later.

The Web server 100 checks whether the checkbox is checked from information received. When the Web server 100 judges that the checkbox is checked, the Web server 100 sets an email address of a creator of an email as a transmission source, sets an email address of a participant as a transmission destination, sets the meeting name as a subject, and sets enumeration of the meeting name, the date and time, and the place and the participant and a link URL to the pack as a text and transmits the email with the main transmission method described above. As the link URL to the pack, any URL may be used as long as the URL is a URL with which it is possible to refer to the pack by specifying the pack indicating the meeting such as a URL obtained by combining a directory indicating the pack and the pack ID with a root URL for accessing the Web server 100. When the user clicks the URL described in the text of the email received, a detailed screen of the meeting is displayed through the login screen as described above.

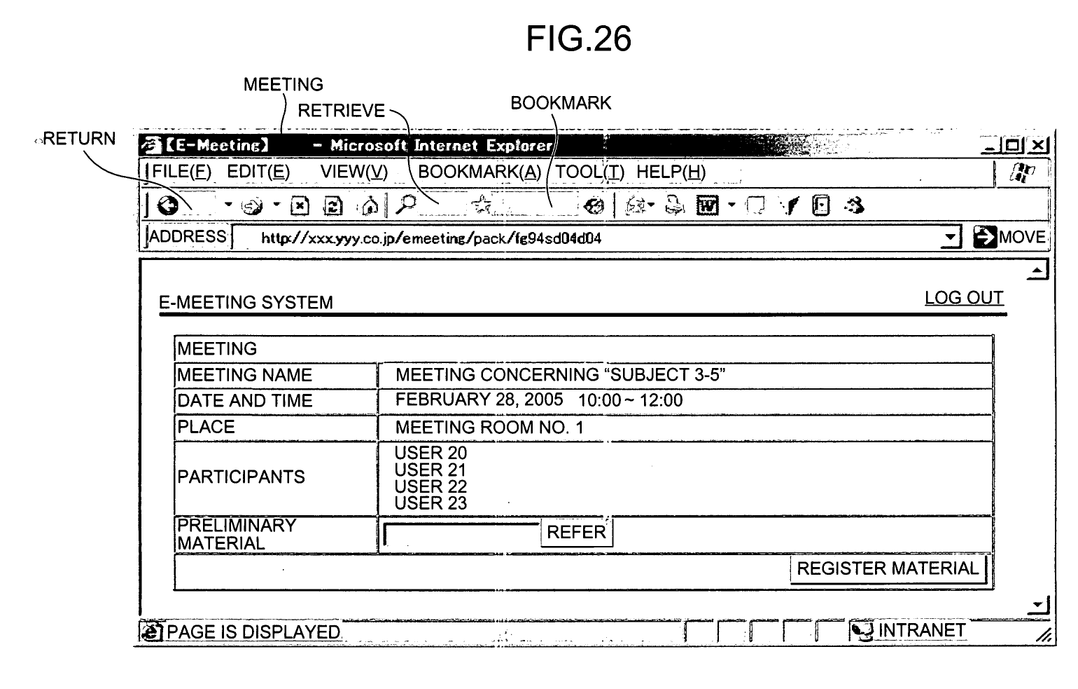

FIG. 26 is a diagram of an example of a detail screen of a meeting displayed by the Web browser 11. Information shown in the figure is information extracted from the pack information received by the Web browser 11 from the Web server 100. As shown in the figure, the Web browser 11 sets a title of a bibliographic matter in a meeting name, sets a plan start date and time and a plan end date and time of the bibliographic matter in a date and time, sets a place of the bibliographic matter in a place, and sets a user included in a member list in a participant and displays the title, the plan start date and time and the plan end date and time, the place, and the user. The Web browser 11 can register a preliminary material (a material used in a meeting). A registration method for the preliminary material is the same as the method of attaching “To Do”. The Web server 100 instructs the repository server 50 to add the preliminary material set to the content management table as contents information. The Web server 100 instructs the repository server 50 to add a new content ID indicating the preliminary material to a content ID list of the meeting pack.

The user selects the “make an appeal” 2113 from the action menu 2101. When the user clicks the “make an appeal” 2113 in the action menu 2101, an appeal registration dialog is displayed.

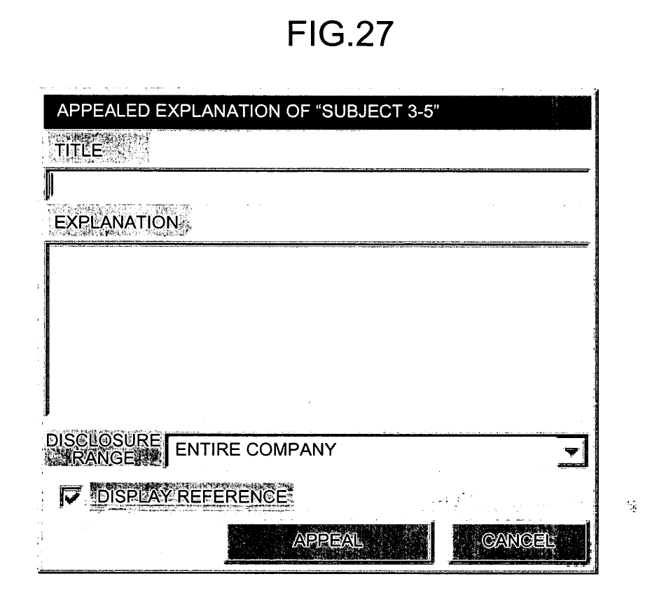

FIG. 27 is a diagram of an example of an appeal registration dialog displayed by the display processing unit 15. As shown in the figure, in the appeal registration dialog, the display processing unit 15 receives an input indicating whether a title to be appealed is displayed in a title, details of information to be appealed is displayed in an explanation, a disclosure range such as an entire company, in a department, in a project, and in a theme is displayed in a disclosure range, and a reference is displayed in a checkbox. After inputting the items described above, the user depresses an appeal button. Consequently, the input/output processing unit 14 transmits, after processing the items input, information processed to the Web server 100. A detailed processing procedure for setting an appeal is described later.

The user selects the “worried” 2114 from the action menu 2101. When the user clicks the “worried” 2114 in the action menu 2101, the client application 12 requests the Web server 100 to add a pack selected to a “worry” list. The Web server 100 performs processing for adding the pack to the “worry” list. A detailed processing procedure for adding the pack to the “worry” list is described later. After the processing ends, the display processing unit 15 of the client application 12 displays an indication that the pack selected is added to the “worry” list.

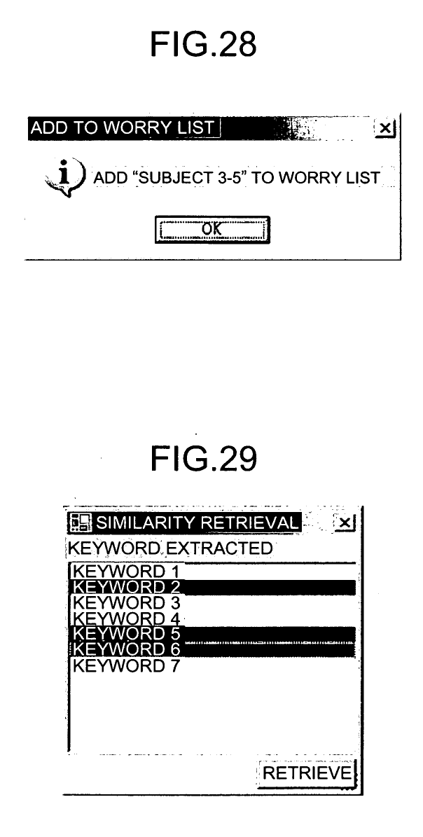

FIG. 28 is a diagram of an example of a confirmation dialog displayed by the display processing unit 15 after registration in the “worry” list ends. Since the dialog shown in the figure is displayed, the user can confirm that a pack is registered in the “worry” list. A reference procedure for worry information registered is described later.

The user selects “retrieve similar content” 2115 from the action menu 2101. When the user clicks the “retrieve similar content” 2115 in the action menu 2101, the display processing unit 15 displays a similarity retrieval dialog.

FIG. 29 is a diagram of an example of the similarity retrieval dialog displayed by the display processing unit 15. As shown in the figure, in the similarity retrieval dialog, keywords extracted from a pack right-clicked by the user in displaying the action menu 2101 are displayed as a list.

As a method for keyword extraction, any method may be used as described above. Keywords are extracted from a bibliographic matter of an object pack and respective bibliographic matters of contents information associated with content IDs in the content ID list in the content management table.

The user selects desired one or more keywords out of the keywords displayed in the list of the similarity retrieval dialog and depresses a retrieval button. Then, the input/output processing unit 14 transmits the keywords selected to the Web server 100. The Web server 100 retrieves information by tracing a tree in the same manner as the keyword retrieval described above. Thus, a detailed explanation of the retrieval is omitted.

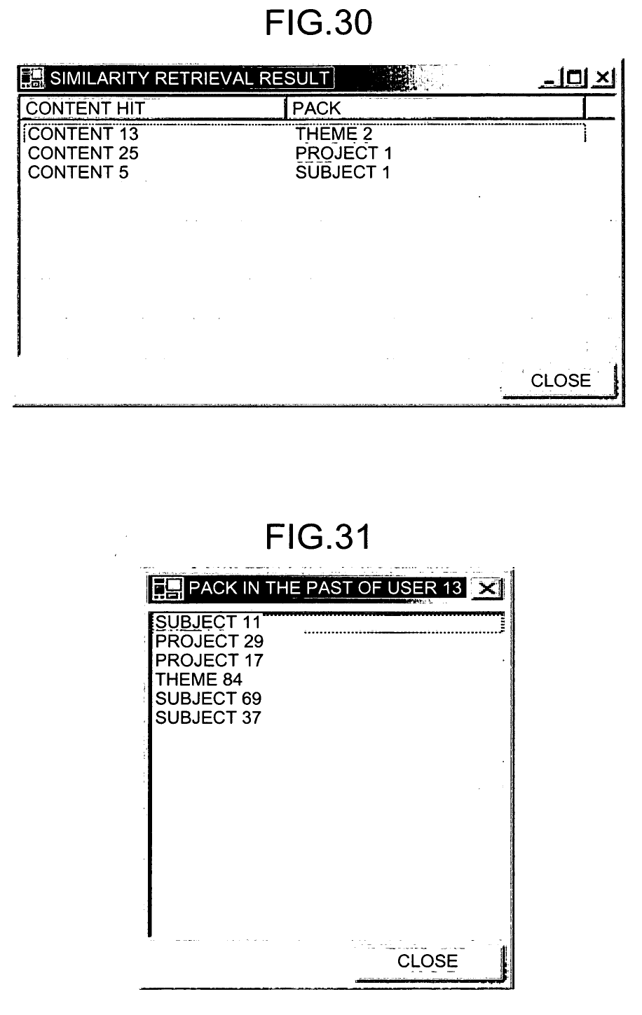

FIG. 30 is a diagram of an example of a similarity retrieval result dialog in which the display processing unit 15 displays a result obtained by retrieval with the Web server 100. In the example shown in the figure, it is indicated that, as a result of retrieving for information by tracing a tree, similar information is present in content 13 of the theme 2, content 25 of the project 1, and content 5 of the subject 1. When the user clicks the respective contents in the dialog, the client application 12 transmits and receives information to and from the Web server 100. Consequently, the display processing unit 15 displays detailed information on the respective contents.

The user selects “retrieve content in the past” 2116 from the action menu 2101. When the user clicks the “retrieve content in the past” 2116 in the action menu 2101, the client application 12 requests the Web server 100 to acquire content, in a member list of which the user is included and a status of which is complete. Content in the past also includes a pack. A procedure for retrieving a pack is described below. Since content is retrieved in the same procedure, an explanation of the retrieval of content is omitted.

First, the client application 12 requests the Web server 100 to transmit an indication that content in the past is retrieved together with a pack ID to be an object of right click by the user in displaying the action menu 2101. The Web server 100 acquires pack information associated with the pack ID received from the pack management table of the repository server 50. The Web server 100 extracts a user ID of a creator included in a bibliographic matter of the object pack acquired. The Web server 100 acquires personal data of the user ID extracted by Web server 100 from the personal data management table of the repository server 50. The Web server 100 acquires a pack ID included in pack information list of the personal data. The Web server 100 acquires pack information, which is associated with the pack ID acquired and a status of which is complete, from the pack management table of the repository server 50. The Web server 100 forms a list of titles of packs acquired and transmits the list to the client 10a. The client application 12 receives the list via the communication control unit. Consequently, the display processing unit 15 can display content in the past.

FIG. 31 is a diagram of an example of display of packs in the past displayed by the display processing unit 15. As shown in the figure, packs completed are displayed as a list. When the user clicks a pack in the list, details of the pack are displayed in the right window group of the client application 12 by the display processing unit 15.

As described above, the Web server 100 can create or update content or a pack in response to reception of an action from the user. Consequently, the client application 12 can provide various views by transmitting and receiving various kinds of information via the Web server 100. A “To Do view”, a “status view”, a “period view”, a “hot/stagnant view”, a “worry view”, and an “appeal view” provided to the user by the client application 12 are explained below.

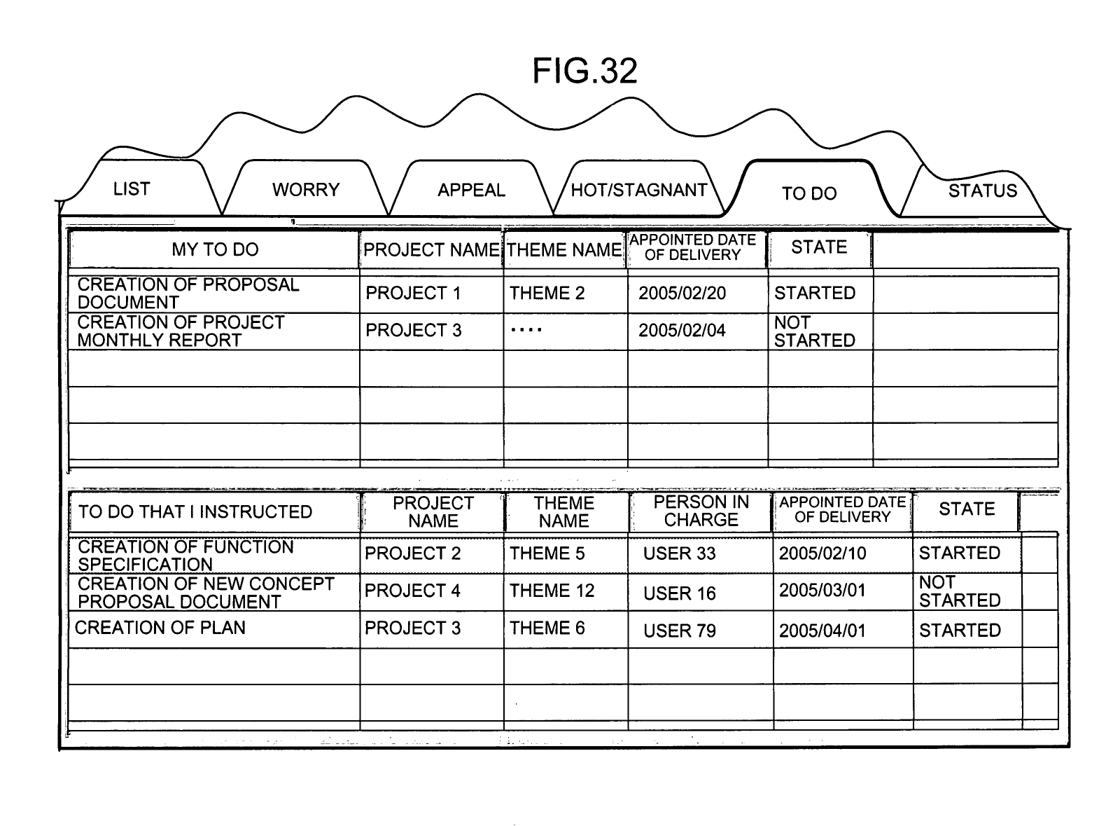

FIG. 32 is a diagram of an example of a screen of the “To Do view” displayed by the display processing unit 15 of the client application 12. As shown in the figure, the upper half of the view displays contents of “To Do”, for which the user referring to the view is set as a person in charge, as a list. The list of contents of “To Do” holds details, a project name, a theme name, an appointed date of delivery, and a state as items.

The lower half of the To Do view displays contents of “To Do”, which the user referring to the view instructs the other users to do, as a list. The list of contents of “To Do” holds details, a project name, a theme name, an appointed date of delivery, and a state and further holds a user name indicating a person in charge who issues an instruction. Detailed processing performed for displaying the To Do view is described later.

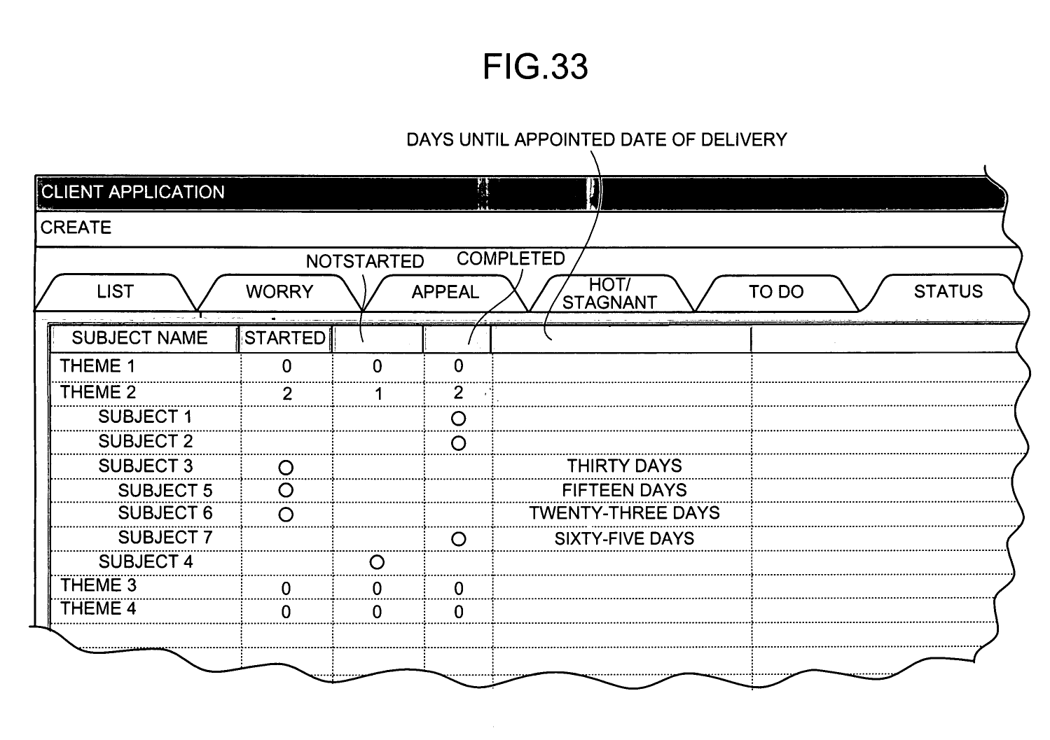

FIG. 33 is a diagram of an example of a screen of the “status view” displayed by the display processing unit 15 of the client application 12. As shown in the figure, the display processing unit 15 displays information on respective packs present in lower hierarchies in a pack selected as a list in a status view. In the example of a screen shown in the figure, the project 1 is selected. In the project 1, four themes, a theme 1, a theme 2, a theme 3, and a theme 4, are present as slave packs. In the theme 2, four subjects, a subject 1, a subject 2, a subject 3, a subject 4, are present as slave packs. In the subject 3, three subjects, a subject 5, a subject 6, and a subject 7, are present as slave packs. The display processing unit 15 displays such a tree structure in a state in which the tree structure is held in the list. This makes it possible to grasp a master slave relation. As shown in the figure, there is no slave subject in the theme 1, the theme 3, and the theme 4.

For each of the subjects of the status view shown in FIG. 33, the display processing unit 15 displays a state of a status of the subject. When a state of a status is not complete in each of the subjects, the display processing unit 15 displays the number of days until an appointed data of delivery in the status view. In a theme or a project, the display processing unit 15 displays a numerical value calculated by totaling statuses of packs indicating subjects in hierarchies below the theme or the project. The calculation of the numerical value is performed by the Web server 100. Detailed processing performed for displaying the status view is described later.

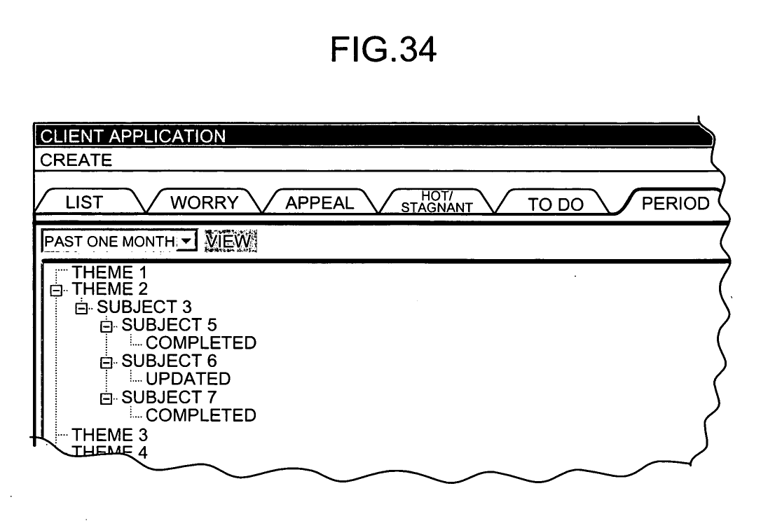

FIG. 34 is a diagram of an example of a screen of the “period view” displayed by the display processing unit 15 of the client application 12. As shown in the figure, in a period view, the display processing unit 15 displays updated information in packs present in hierarchies below a pack selected by the user. In the example shown in the figure, the pack selected by the user is the project 1. A change in a period in packs indicating themes and subjects present in hierarchies below the project 1 is displayed.

As shown in FIG. 34, a combo box for designating a period shown at the top stage of a period view receives selection of a period from the user. Examples of options that can be received in the combo box include past one month, past one week, last week, and last month. Setting of a period is not limited to such designation of a period by the combo box. Setting of a start date and time and an end date and time may be received from the user.

In an example shown in FIG. 34, past one month is selected in the combo box. The display processing unit 15 displays respective themes and respective subjects included in the project 1 in a tree structure in the period view. The display processing unit 15 displays subjects changed in the past one month among the subjects together with details of the change. Detailed processing performed for displaying the period view is described later.

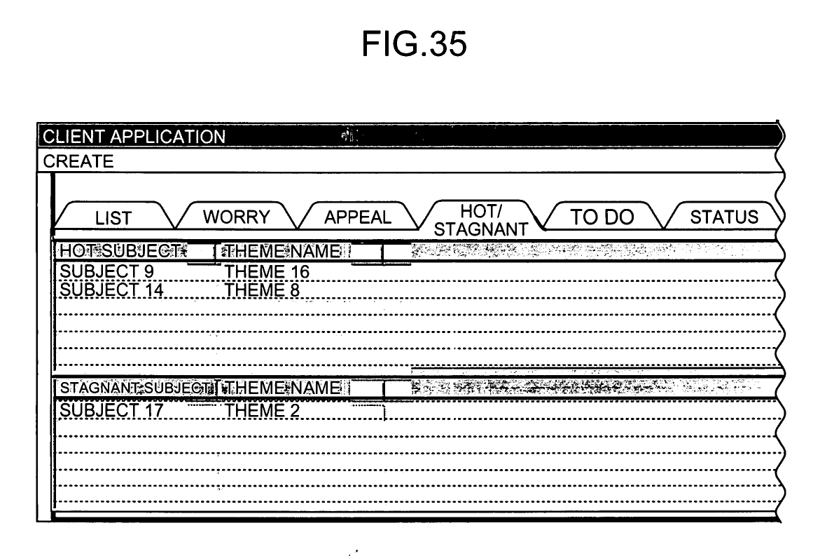

FIG. 35 is a diagram showing an example of a screen of the “hot/stagnant view” displayed by the display processing unit 15 of the client application 12. As shown in the figure, in the hot/stagnant view, the display processing unit 15 displays hot information in the upper half and displays stagnant information in the lower half.

As a judgment criterion for judging whether information is hot or stagnant, any criterion may be used. For example, it is judged whether information is hot or stagnant according to whether packs are frequently updated, document contents are frequently registered, fluctuation in statuses is intense, or the information is frequently browsed. In this way, various changes applied to pack information managed in the pack management table of the repository server 50 by the Web server 100 may be set as judgment criteria. In the present embodiment, as the judgment criterion for judging whether information is hot or stagnant, it is judged whether packs are frequently updated.

In the example shown in FIG. 35, the hot/stagnant view is displayed when the project 1 is selected. In the hot/stagnant view, among subjects included in the project 1, the display processing unit 15 displays a subject 9 and a subject 14 judged as hot, update frequencies of which are equal to or higher than a predetermined frequency of update, in the upper half and displays a subject 17 judged as stagnant, an update frequency of which is lower than the predetermined frequency of update, in the lower half. Detailed processing performed for displaying the hot/stagnant view is described later.

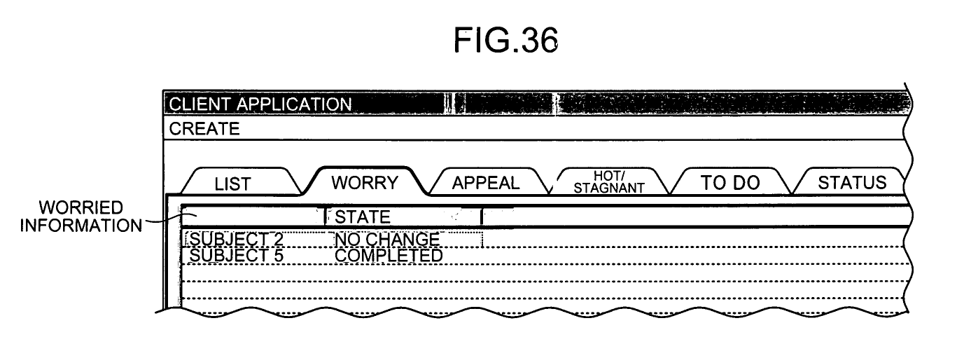

FIG. 36 is a diagram of an example of a screen of the “worry view” displayed by the display processing unit 15 of the client application 12. An object pack displayed in the worry view is a pack selected as “worried” from the action menu by the user as described above. As shown in the figure, the display processing unit 15 displays a change in a state of the pack selected by the user. Detailed processing performed for displaying the worry view is described later.

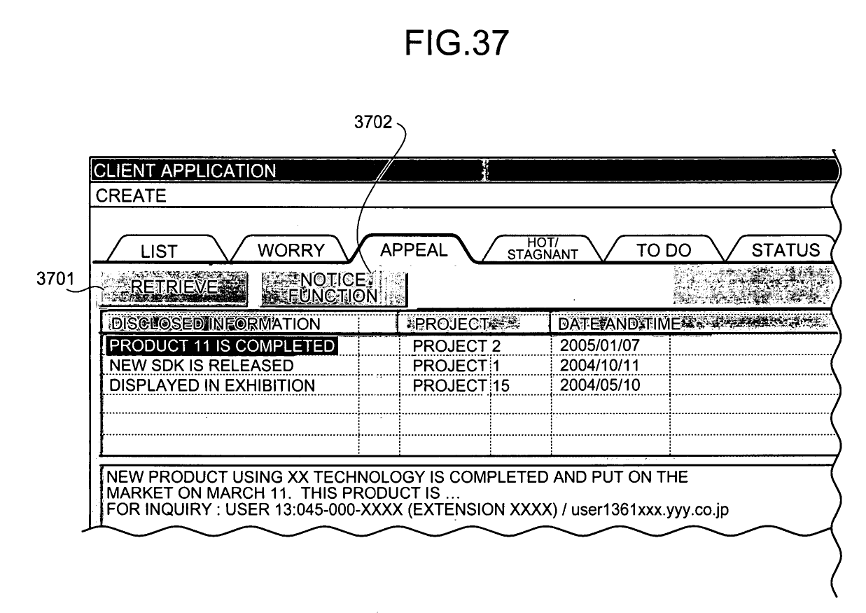

FIG. 37 is a diagram of an example of a screen of the “appeal view” displayed by the display processing unit 15 of the client application 12. As shown in the figure, the display processing unit 15 sets and displays a menu button at the top stage of the appeal view. The display processing unit 15 displays all pieces of contents information appealed below the menu button as a list. The display processing unit 15 displays detailed information on content selected from the list and a reference at the bottom stage. Specifically, when the user places the cursor on an arbitrary content among the contents displayed in the list and performs left click, the display processing unit 15 displays information held in an explanation of a bibliographic matter of the content as detailed information. Detailed processing for displaying the appeal view is described later.

A retrieval button 3701 and a notice function button 3702 are included in the menu button of the appeal view shown in FIG. 37. The user depresses the retrieval button 3701 when the user desires to retrieve all the pieces of contents information displayed in the list of the appeal view based on a key word designated by the user.

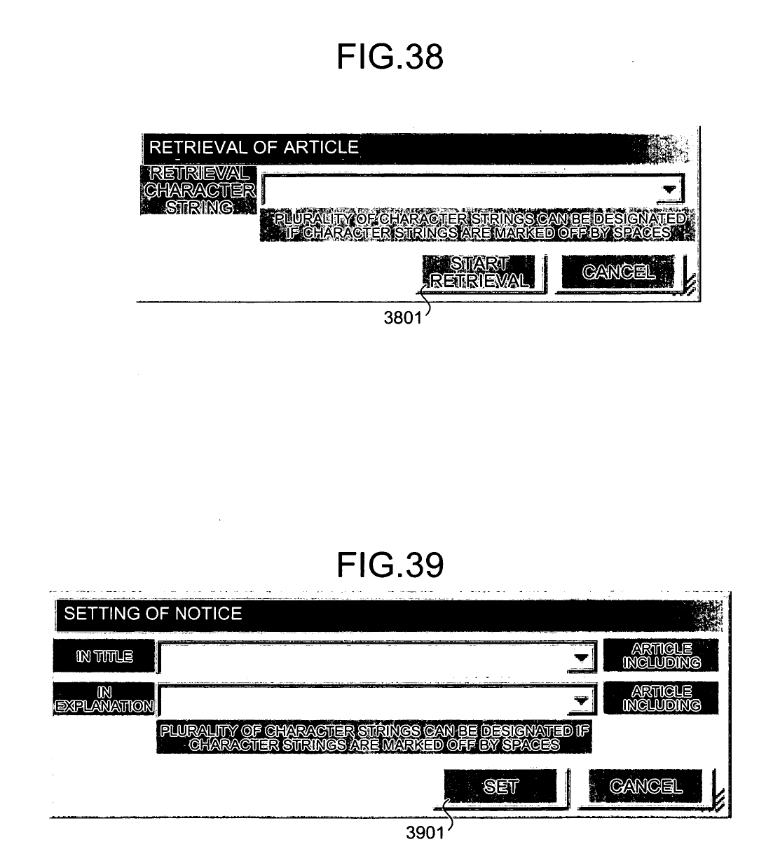

FIG. 38 is a diagram of an example of a retrieval dialog displayed when the user depresses the retrieval button 3701. The user inputs a keyword used for retrieval to a retrieval character string of the retrieval dialog shown in the figure. A plurality of keywords may be input. In this case, for example, it is conceivable to mark off the respective keywords with half-size spaces. After completing the input of the keyword, the user depresses a retrieval start button 3801 to start the retrieval. The display processing unit 15 displays, after the retrieval ends, only content hit by the keyword input in the appeal view shown in FIG. 37. Detailed processing performed for displaying the content hit by the keyword in the appeal view is described later.

The notice function button 3702 is a button for setting a notice to the user when content having a keyword designated by the user is appealed by other users.

FIG. 39 is a diagram of an example of a notice setting dialog displayed when the user depresses the notice function button 3702. The user inputs one or more of keywords included in a title or keywords included in an explanation to the notice setting dialog shown in the figure. Thereafter, when the user depresses a setting button 3901, setting necessary for a notice to the user is performed. Detailed processing for performing notification by the appeal view is described later.

Such notification is effective when, for example, the user depresses the retrieval button 3701 on the screen shown in FIG. 37 to retrieval of content but no content is hit. In such a case, if the user sets a keyword in advance, when content including the keyword is appealed, it is possible to automatically notify the user of the content.

As described above, the client application 12 and the Web browser 11 are not limited to the display of the views described above. It is possible to perform all kinds of display concerning contents or packs.

The user can register and change various kinds of information with intuitive operation from the client application 12 or the Web browser 11 without being aware that the information is registered in a database. Since the client application 12 and the Web browser 11 communicate with the Web server 100, it is possible to display information such as packs or contents in various forms corresponding to request of the user.

Referring back to FIG. 1, the Web server 100 includes a communication control unit 101 and a Web application 102. The Web server 100 receives request from the clients 10a to 10n described later or instructs the repository server 50 to perform processing such as addition, change, and acquisition of information.

The communication control unit 101 is connected to the LAN 20 and performs control for transmitting and receiving information between the Web server 100 and the clients 10a to 10n or the repository server 50. The communication control unit 101 serves as an interface that transmits an instruction to the repository server 50 or receives a result of the instruction.

The Web application 102 includes a registering unit 111, a monitoring unit 112, a notifying unit 113, a condition registering unit 114, a periodic retrieval unit 115, a retrieval-information notifying unit 116, a client-information acquiring unit 117, an output unit for clients 118, an input receiving unit 119, an association output unit 120, an information inheriting unit 121, a movement-association output unit 122, a movement-information inheriting unit 123, a user authenticating unit 124, a retrieving unit 125, an association-information extracting unit 126, a user-structure generating unit 127, a totaling unit 128, an update specifying unit 129, and an update-frequency extracting unit 130. The Web application 102 instructs, in response to request received from the clients 10a to 10n, the repository server 50 to cope with the request. When a result of the instruction is received, the Web application 102 outputs the result to the clients 10a to 10n. The communication with the repository server 50 and the clients 10a to 10n is performed via the communication control unit 101.

As a method used by the Web application 102, for example, there are the various conventional methods such as the method using the Microsoft.NET technology and the method using servlet JSP and Tomcat. In the present embodiment, any method may be used.

The user accesses the Web browser 11 or the Web application 102. Consequently, the user can use various functions and views provided by the Web application 102. The Web application 102 holds a SOAP interface to make it possible to access the database in the repository server 50 via the interface.

The user authenticating unit 124 is used in authenticating login of the user. In the present embodiment, when user IDs and passwords are received from the clients 10a to 10n, the user authenticating unit 124 receives passwords associated with the user IDs from the user table of the repository server 50 and performs authentication according to whether the passwords received from the clients 10a to 10n and the passwords received from the repository server 50 coincide with each other.

The input receiving unit 119 receives request for processing made by the clients 10a to 10n. Examples of the processing received by the input receiving unit 119 include registration and change of packs or contents, retrieval for tracing a tree, registration of a worry pack, and transmission of information necessary for display. The input receiving unit 119 receives all requests from the clients 10a to 10n.

The association output unit 120 associates contents information or pack information received from the clients 10a to 10n by the input receiving unit 119 with contents information or pack information already registered in the repository server 50. The association output unit 120 outputs the contents information and the pack information to the repository server 50 together with request for registering the contents information or the pack information in the content management table or the pack management table of the repository server 50.

The association output unit 120 performs processing when request for adding a new pack under a predetermined pack in a tree of packs displayed by the client application 12 is received or when request for adding new content under predetermined content in a tree of contents is received.

The client-information acquiring unit 117 performs, when the input receiving unit 119 receives request for transmitting information necessary for display from the clients 10a to 10n, processing for acquiring the necessary information from the repository server 50. The client-information acquiring unit 117 acquires information requested by the user using every processing method, for example, acquiring other pack information or client information by tracing a link or the like among packs or clients in the pack management table or the client management table of the repository server 50.

The association-information extracting unit 126 judges whether predetermined information such as an update date and time or a status included in the pack information or the contents information acquired by the client-information acquiring unit 117 satisfies a predetermined condition, for example, whether the status is a predetermined status or the update date and time is within a predetermined period. The association-information extracting unit 126 extracts content or a pack including predetermined information satisfying the predetermined condition.

The output unit for clients 118 includes the association-information extracting unit 126. When the client-information acquiring unit 117 acquires pack information or client information added to the respective tables of the repository server 50, the output unit for clients 118 forms the pack information or the contents information acquired in a format corresponding to request from the clients 10a to 10n. The output unit for clients 118 outputs the pack information or the contents information to the clients 10a to 10n that request the pack information or the contents information.

The registering unit 111 instructs the repository server 50 to register information received from the clients 10a to 10n in a predetermined table. As such registration, for example, it is conceivable to register, when an indication that predetermined content or pack is a “worried” object is received from the clients 10a to 10n, the content or the pack in the repository server 50.

When the registering unit 111 registers a pack or content as a “worried” object, a content ID of the content set as the “worried” object or a content ID linked to the pack set as the “worried” object is added to a content ID of a record provided for each user in the pack management table of the repository server 50. A detailed processing procedure is described later.

The monitoring unit 112 monitors whether the predetermined content or pack registered by the registering unit 111 has been changed. The monitoring unit 112 acquires a content ID of a record, a pack type of which is retrieval in the pack management table of the repository server 50, and acquires contents information associated with the acquired content ID from the content management table. The monitoring unit 112 checks whether the content is updated according to an update date and time of the contents information acquired. This makes it possible to monitor whether the content is updated. When a monitoring object is a pack, the monitoring unit 112 acquires pack information linked in the acquired contents information from the pack management table. This makes it possible to monitor whether the pack is updated. It is conceivable to, for example, notify the user of a result of the monitoring by the monitoring unit 112 with the notifying unit 113 described later.

The notifying unit 113 performs processing for notifying the clients 10a to 10n of information by email. The information notified by the notifying unit 113 may be any information, for example, a meeting notification email indicating that a meeting is held or notification by an email indicating instruction content set by “instruct”.

The condition registering unit 114 performs processing for registering a condition of a pack or content, which the user desires to acquire, in the repository server 50. Consequently, when a pack or content registered satisfies the condition registered, the user is notified of the pack or the content.

In the present embodiment, the condition registering unit 114 performs processing for registering a condition set by the notice function of the application view of the client application 12. However, a condition other than the condition set by the notice function may be registered.

The condition registering unit 114 registers contents information holding a condition input by the user in the content management table of the repository server 50. The condition registering unit 114 adds a content ID indicating content registered to a content ID list of pack information, a pack type of which is notice in the pack management table.

The periodic retrieval unit 115 performs retrieval to find whether contents information added to a predetermined pack satisfies the condition registered by the condition registering unit 114. In the present embodiment, the periodic retrieval unit 115 performs, at every predetermined time, retrieval to find whether pack information satisfying the condition added to the content ID list of the pack information on notice is present in pack information indicating an appeal. A pack to be retrieved by the periodic retrieval unit 115 is not limited to pack information indicating appeal. The retrieval may be applied to every kind of pack information.

The retrieval-information notifying unit 116 notifies, when content or a pack satisfying the condition is detected by the periodic retrieval unit 115, the user who input the condition that the content or the pack is detected.

The information inheriting unit 121 performs processing for, in generating a new pack as a slave of an arbitrary pack already registered, causing the new pack to inherit information held by the arbitrary pack already registered. The information inheriting unit 121 according to the present embodiment causes the new pack to inherit a user list and a browsing authority or a reference authority of the arbitrary pack already registered.

The information to be inherited is not limited to a user list and an access right. Any kind of information may be inherited. For example, it is conceivable that the information inheriting unit 121 causes a pack or content to be a slave to inherit a standard sentence.

The movement-association output unit 122 instructs the repository server 50 to perform processing for moving a movement object pack linked as a slave of an arbitrary pack such that the movement object pack becomes a slave of a pack except the arbitrary pack.

The movement-association output unit 122 requests the pack management table of the repository server 50 to change a pack ID held by a link to master packs of a record of a movement object pack of the pack management table from a pack ID of an arbitrary pack to a pack ID of another pack.

The movement-association output unit 122 requests the pack management table of the repository server 50 to delete a pack ID of a movement object pack from a link to slave packs in a record of an arbitrary pack of the pack management table. The movement-association output unit 122 requests the pack management table of the repository server 50 to add a pack ID of a movement object pack to a link to slave packs of another pack record of the pack management table.

The movement-information inheriting unit 123 performs processing for, in changing a movement object pack from a slave of an arbitrary pack to a slave of another pack, causing the movement object pack to inherit information on another pack. Information that the movement-information inheriting unit 123 according to the present embodiment causes the movement object pack to inherit is a member list, a reference authority, and an edition authority. This makes it possible to prevent a situation in which members included in the same tree cannot refer to a pack after movement.

The retrieving unit 125 retrieves, based on retrieval conditions input by the clients 10a to 10n, at least one of contents information managed by the content management table and pack information managed by the pack management table.

The retrieving unit 125 according to the present embodiment retrieves, based on the retrieval conditions input, a pack or content by tracing a tree constituted by packs or a tree constituted by contents. The retrieval by the retrieving unit 125 is used, for example, when the keyword retrieval shown in FIG. 15 is performed.

The user-structure generating unit 127 generates the user tree shown in FIG. 14. The user-structure generating unit 127 generates a tree constituted by packs from a link to master packs or a link to slave packs of a pack of the pack information managed by the pack management table. The user-structure generating unit 127 acquires a member list included in each pack based on a user ID included in the member list of each pack. In this case, it is possible to acquire a user name associated with the user ID from the user table of the repository server 50.

The totaling unit 128 totals, in a tree of packs that can be generated by a link to master packs, a link to slave packs, or the like held by pack information, values held by predetermined information held by the respective packs and acquires a count number for each pack to be a slave. In the present embodiment, the totaling unit 128 acquires, in statuses held by the respective packs included in the tree, a count number for each of started, not started, and completed. Predetermined information totaled by the totaling unit 128 is not limited to a status. The totaling unit 128 may apply totaling to all items such as a bibliographic matter.

The update specifying unit 129 specifies new arrival information included in a new arrival information list of the personal data management table of the repository server 50 and updated within a predetermined period. The update specifying unit 129 specifies one or more of contents information and pack information updated according to a type and an ID included in the new arrival information.

The update specifying unit 129 performs the processing described above every time a period is designated in the period view shown in FIG. 34.

The update-frequency extracting unit 130 checks an update date and time of new arrival information included in a new arrival information list of the personal data management table of the repository server 50 and calculates a distribution of update frequencies with respect to a time axis. According to the distribution of update frequencies calculated by the update-frequency extracting unit 130, the output unit for clients 118 can compare distributions calculated for all subjects and judge that a pack having a high update frequency and a center of gravity of a distribution close to the present date and time is a hot subject and a pack having a low update frequency and a center of gravity of a distribution far from the present date and time is a stagnant subject. Judgment according to such frequencies is not limited to judgment on whether a subject is hot or stagnant. For example, it may be judged whether a subject is hot or stagnant according to whether the number of times of update in a predetermined period exceeds a predetermined number of times.

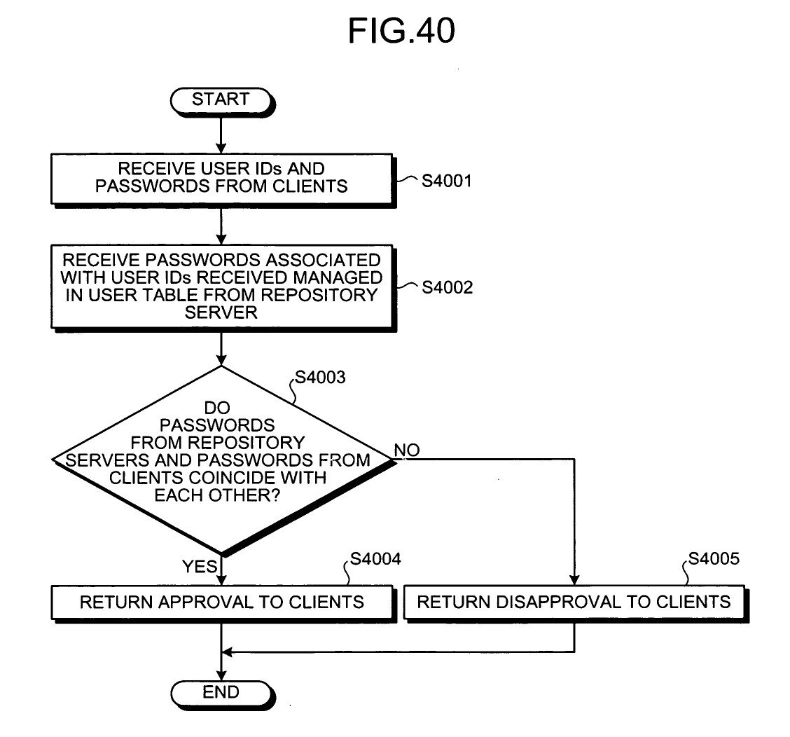

FIG. 40 is a flowchart of a processing procedure until a user is authenticated in the user authenticating unit 124 according to the present embodiment constituted as described above.

The user authenticating unit 124 receives user IDs and passwords from the clients 10a to 10n via the communication control unit 101 (step S4001). The user IDs and the passwords are input when users log in the client application 12 or when pack information or client information is displayed on the Web server 100.

The user authenticating unit 124 transmits the user IDs to the repository server 50 and requests passwords associated with the user IDs. The user authenticating unit 124 receives passwords, which are associated with the user IDs transmitted, held by the user table from the repository server 50 (step S4002).

The user authenticating unit 124 collates the passwords received from the clients 10a to 10n and the passwords received from the repository server 50 to judge whether the passwords coincide with each other (step S4003).

When the user authenticating unit 124 judges that the passwords coincide with each other (“Yes” at step S4003), the user authenticating unit 124 outputs an indication of approval to the clients 10a to 10n, which requested authentication, via the communication control unit 101 (step S4004).

When the user authenticating unit 124 judges that the passwords do not coincide with each other (“No” at step S4003), the user authenticating unit 124 outputs an indication of disapproval to the clients 10a to 10n, which requested authentication, via the communication control unit 101 (step S4005).

The processing procedure described above makes it possible to log in the client application 12 in the clients 10a to 10n. The processing procedure described above is an example of a processing procedure until a user is authenticated in the user authenticating unit 124 according to the present embodiment. The present invention is not limited to this processing procedure.

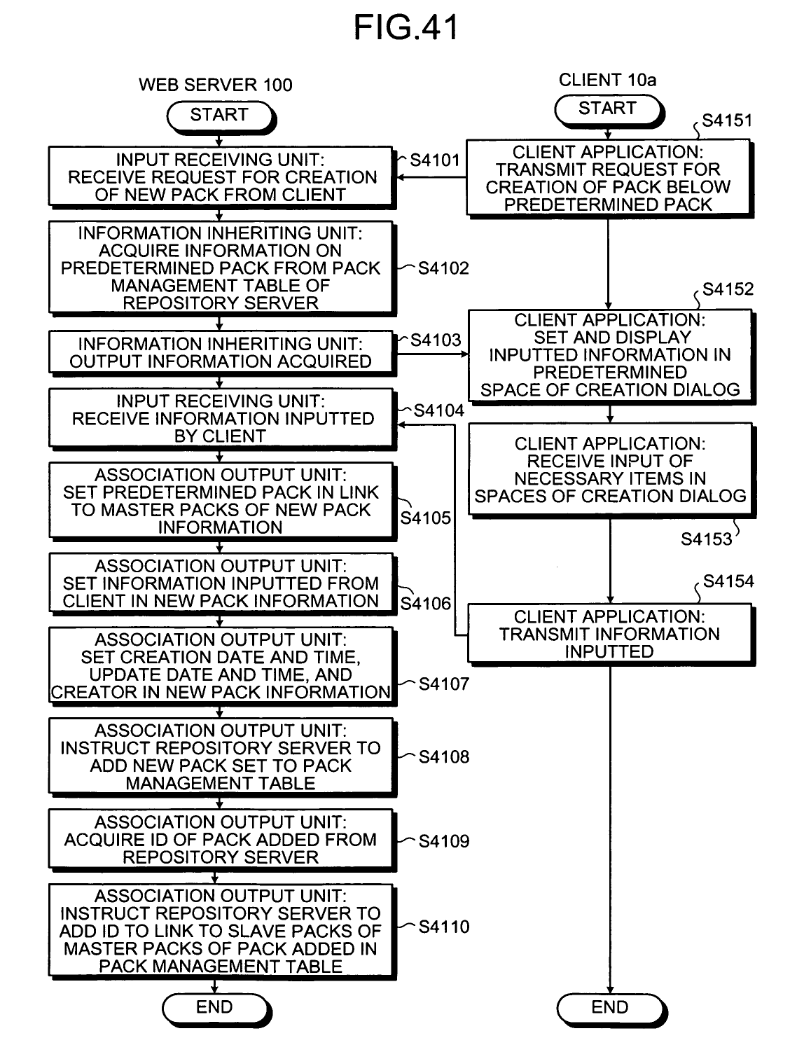

FIG. 41 is a flowchart of a processing procedure until a pack is added in the Web server 100 and the client 10a according to the present embodiment.

First, the client application 12 receives request for creation of a pack to be a slave for a predetermined pack of a tree of packs displayed by the display processing unit 15. The client application 12 receives the request for creation of a pack when a user selects a pack from the creation menu shown in FIG. 9. The client application 12 transmits the request for creation of a pack to the Web server 100 together with a pack ID indicating a predetermined pack (step S4151).

The input receiving unit 119 of the Web server 100 receives the request for creation of a pack input from the client 10a and the pack ID of the predetermined pack (step S4101).

The information inheriting unit 121 acquires, to cause a new pack to inherit information held by the predetermined pack, pack information associated with the pack ID of the predetermined pack from the pack management table of the repository server 50 (step S4102).

The information inheriting unit 121 transmits information to be inherited of the pack information acquired to the client 10a via the communication control unit 101 (step S4103). The information to be inherited is a member list, a browsing authority, and an edition authority.

The client application 12 receives the member list, the browsing authority, and the edition authority to be inherited. The display processing unit 15 of the client application 12 displays a creation dialog that reflects the member list and the like received (step S4152). The dialog is the same as that shown in FIGS. 10 and 11. In the creation dialog, a member included in the predetermined pack is displayed in a state in which the member is already selected. The browsing authority and the edition authority are displayed in a state in which a user permitted by the predetermined pack is selected.

The client application 12 receives input of necessary items from the user in respective spaces of the dialog (step S4153).

The client application 12 transmits the information input and the pack ID of the predetermined pack to the Web server 100 (step S4154).

The input receiving unit 119 receives input of information necessary for pack creation from the client 10a (step S4104).

The association output unit 120 sets the pack ID of the predetermined pack input in a link to master packs of a pack to be created anew (step S4105).

The association output unit 120 sets the information input in respective items of the pack to be created anew (step S4106). As a detailed example, the association output unit 120 sets a title, input of which is received in the dialog, as title information on a bibliographic item, sets an explanation, input of which is received in the dialog, as explanatory information on the bibliographic matter, sets a plan start date and time, input of which is received in the dialog, as a plan start date and time of the bibliographic matter, sets a plan end date and time, input of which is received in the dialog, as a plan end date and time of the bibliographic matter, sets a browsing authority, input of which is received in the dialog, as a browsing authority user list, and sets an edition authority, input of which is received in the dialog, as an edition authority user list of the bibliographic matter.

The association output unit 120 sets member information, input of which is received in the dialog, in the member list of the pack. The association output unit 120 sets “not started/planned” in the status.

As another example, when the association output unit 120 creates an organization as a pack in a state in which there is no tree display, an “organization” is stored in a pack type of a pack. Since a new organization is created in a state in which there is no data in tree display, the association output unit 120 does not set a link to master packs of the pack.

Referring back to the processing shown in FIG. 41, the association output unit 120 sets a creation date and time, an update date and time, and a creator of the bibliographic matter of the pack (step S4107). The association output unit 12G sets the same date and time in the creation date and time and the update date and time. The association output unit 120 sets a user ID of the user, who requested creation of the pack, in the creator.

The association output unit 120 instructs the repository server 50 to add the information set as a new pack by the processing described above in the pack management table of the repository server 50 as a new record (step S4108).

In this case, the data processing unit 52 of the repository server 50 issues a pack ID associated with the pack added, further adds the pack ID to the bibliographic matter of the pack, and adds the pack ID to the pack management table together with the information input from the association output unit 120. The data processing unit 52 outputs the pack ID issued to the Web server 100 via the communication control unit 51.

The association output unit 120 acquires the pack ID issued by the repository server 50 (step S4109). The association output unit 120 instructs the repository server 50 to add the pack ID acquired to a link to salve packs of a predetermined pack to be a master of the pack created.

Consequently, the repository server 50 performs processing for adding the pack ID acquired to a link to slave packs of a record of the predetermined pack and updating the link (step S4110).

Consequently, the addition of the pack and the linking with the pack to be a master has ended. However, the association output unit 120 further updates a creator and personal data of respective users included in the member list of the pack based on the information on the pack. Specifically, the association output unit 120 adds, in the personal data management table, the pack information created to a pack information list held by personal data provided for each user. The pack information added consists of a pack ID and a pack type.

The association output unit 120 creates new arrival information constituted by the pack ID, a creation date and time, and a user ID indicating the creator. The association output unit 120 adds, in the personal data management table, the new arrival information created to a new arrival information list provided in the personal data of each user included in the member list of the pack.

The processing procedure described above makes it possible to create a tree of packs. The processing procedure indicates an example of a processing procedure until a pack is added in the Web server 100 and the client 10a according to the present embodiment. The present invention is not limited to this processing procedure. For example, when the user sets a disclosure level in the creation dialog, the association output unit 120 sets, in a flow of the processing described above, a level value input as the disclosure level in a level of a new pack and adds the pack, for which the level value is set, to the pack management table.

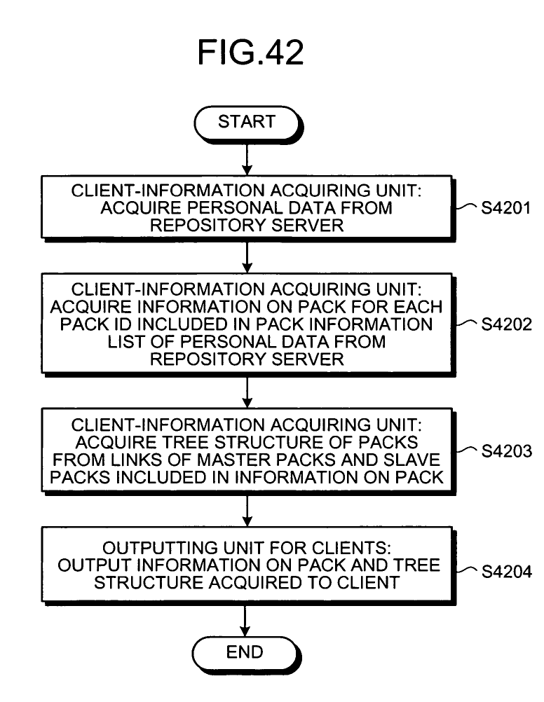

FIG. 42 is a flowchart of a processing procedure until the client-information acquiring unit 117 of the Web server 100 according to the present embodiment acquires a tree displayed in the clients 10a to 10n and outputs the tree.

First, the client-information acquiring unit 117 acquires a pack information list included in personal data of a user of the client 10a, who requested display of a tree, from the personal table of the repository server 50 (step S4201). In the repository server 50, the data processing unit 52 creates a query for searching through the content management database 53 in response to request from the Web server 100. The data processing unit 52 searches through the pack management table held by the content management database 53 using the query. The data processing unit 52 generates a pack information list L including information on a pack ID of a pack matching the request from the Web server 100 and transmits the pack information list L to the Web server 100 via the communication control unit 51. As a result, the client-information acquiring unit 117 of the Web server 100 can acquire the pack information list from the repository server 50.

The client-information acquiring unit 117 acquires pack information associated with a pack ID included in the pack information list from the pack management table of the repository server 50 (step S4202). In the repository server 50, the data processing unit 52 acquires pack information associated with a pack ID requested by the Web server 100 and transmits the pack information to the Web server 100. As a result, the client-information acquiring unit 117 of the Web server 100 can acquire the pack information from the repository server 50.

The client-information acquiring unit 117 generates a tree structure including an acquired pack from links to master packs and slave packs included in the pack information acquired (step S4203).

The output unit for clients 118 outputs the tree structure generated and information on packs necessary for display of a tree to the client 10a that requested transmission of the tree (step S4204).

Consequently, the client 10a can display a tree of packs. In the present embodiment, means used by the client 10a to display a tree of packs is not limited. Any means may be used. For example, if the TreeView control of Microsoft is used, respective packs correspond to TreeNode and the client application 12 can perform tree display by storing a title in Text of TreeNode, storing a display icon in ImageIndex, storing TreeNode of a slave pack in Nodes, and storing top level TreeNode in Nodes of the TreeView control. In this case, pack IDs are stored in Tags of the respective TreeNodes. Then, when the display processing unit 15 displays the tree of packs, the input/output processing unit 14 receives execution of left click of the not-shown mouse from the user. Thus, if any one of the TreeNodes is present under a position of the click, it is possible to extract the Tag and limit a pack ID. This pack ID is used as a master pack ID. Consequently, the display processing unit 15 can display the tree.

The processing procedure described above makes it possible to display a tree of packs by outputting the tree acquired to the clients 10a to 10n. The processing procedure indicates an example of processing until the client-information acquiring unit 117 according to the present embodiment acquires a tree displayed in the clients 10a to 10n. The present invention is not limited to this processing procedure.

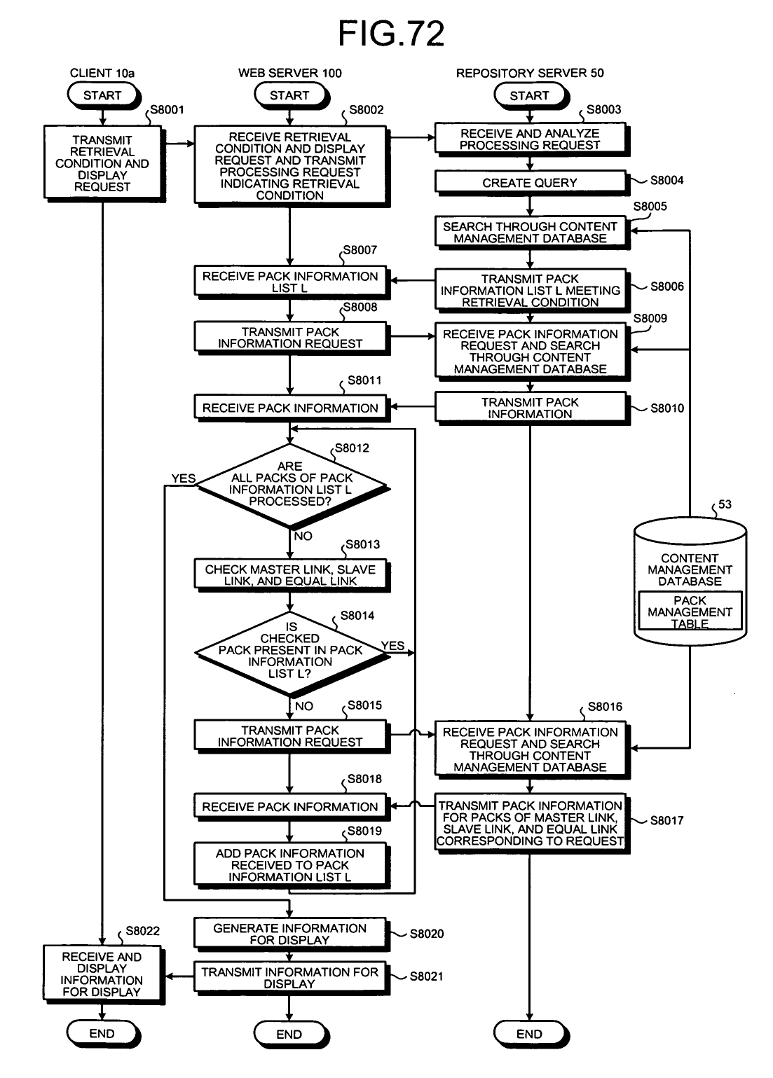

Processing for searching through the content management database 53 in response to request for retrieval and display of a pack from the user of the client 10a, generating information for display corresponding to the display request using link information on a pack of a result of the retrieval, and causing the client 10a to display a display screen based on the information for display is explained. FIG. 72 is a sequence chart of a flow of the processing.

First, when the user inputs a retrieval condition and display request from a Web browser displayed on a monitor in the client 10a, the input/output processing unit 14 of the client 10a receives this input and transmits the retrieval condition and the display request to the Web server 100 via the communication control unit 13 (step S8001). The retrieval condition is a condition for limiting a part or all of elements constituting a pack. The retrieval condition is, for example, “a character string ‘test’ is included in a title”, “a creation date and time is from ‘2006/01/01’to ‘2006/06/30’”, or “a pack type is ‘meeting’ ”. It is possible to limit any element constituting the pack. The display request is a condition for designating how a pack retrieved according to the retrieval condition is displayed. The display request is, for example, “display a link of member lists”, “display a link of pack types”, “display a link of statuses”, or “display a link of browsing authorities”. It is also possible to display a link of any elements constituting the pack using link information.

When the communication control unit 101 of the Web server 100 receives the retrieval condition and the display request transmitted from the client 10a, the communication control unit 101 analyzes the retrieval condition and the display request received and transmits processing request indicating the retrieval condition to the repository server 50 (step S8002).

When the data processing unit 52 of the repository server 50 receives the processing request transmitted from the Web server 100 via the communication control unit 1, the data processing unit 52 analyzes the retrieval condition indicated by the processing request (step S8003). The data processing unit 52 creates a query for searching through the content management database 53 using the retrieval condition (step S8004). Subsequently, the data processing unit 52 searches through the pack management table held by the content management database 53 using the query (step S8005). The data processing unit 52 generates a pack information list L including information on a pack ID of a pack corresponding to the retrieval condition and transmits the pack information list L to the Web server 100 via the communication control unit 51 (step S8006).

When the client-information acquiring unit 117 of the Web server 100 receives the pack information list L transmitted from the repository server 50 via the communication control unit 101 (step S8007), the client-information acquiring unit 117 associates a retrieval acquisition flag 1′ with the pack ID included in the pack information list. The retrieval acquisition flag is a flag for distinguishing pack information, a pack ID of which is indicated in the pack information list L acquired at step S8007, and pack information obtained at step S8015 described later. In other words, the retrieval acquisition flag is a flag indicating whether pack information meets the retrieval condition input at step S8001. When the pack information meets the retrieval condition, a value of the retrieval acquisition flag is ‘1’ and, when the pack information does not meet the retrieval condition, a value of the retrieval acquisition flag is ‘0’. The client-information acquiring unit 117 transmits pack information request for requesting pack information associated with the pack ID included in the pack information list to the repository server 50 (step S8008).

When the data processing unit 52 of the repository server 50 receives the pack information request via the communication control unit 51, the data processing unit 52 acquires pack information corresponding to the pack information request from the pack management table (step S8009) and transmits the pack information to the Web server 100 (step S8010).

When the client-information acquiring unit 117 of the Web server 100 receives the pack information transmitted from the repository server 50 via the communication control unit 101 (step S8011), the client-information acquiring unit 117 judges whether the processing is completed for all packs indicated in the pack information list L (step S8012). Since the processing has not been completed for all the packs, a result of the judgment at step S8012 is negative and the client-information acquiring unit 117 proceeds to step S8013. At step S8013, the client-information acquiring unit 117 checks, for all pieces of pack information, IDs of which are indicated in the pack information list L, a link to master packs (a master link), a link to slave packs (a slave link), and a link to equal packs (an equal link). Since a pack ID is indicated for each of the links, the client-information acquiring unit 117 refers to the pack ID and judges whether the pack ID referred to is present in the list L (step S8014). When a result of the judgment at step S8014 is negative, the client-information acquiring unit 117 transmits transmission request for pack information (a master link, a slave link, and an equal link) of the pack ID to the repository server 50 via the communication control unit 101 (step S8015). When the data processing unit 52 of the repository server 50 receives the transmission request via the communication control unit 51, the data processing unit 52 acquires pack information (a master link, a slave link, and an equal link) of a pack ID corresponding to the transmission request from the pack management table (step S8016) and transmits the pack information to the Web server 100 (step S8017).

When the client-information acquiring unit 117 of the Web server 100 receives the pack information transmitted from the repository server 50 via the communication control unit 101 (step S8018), the client-information acquiring unit 117 adds a pack ID of the pack information to the pack information list L and associates the retrieval acquisition flag ‘0’ with the pack ID (step S8019). Subsequently, the client-information acquiring unit 117 proceeds to step S8012. When a result of the judgment at step S8014 is affirmative, the client-information acquiring unit 117 also proceeds to step S8012. A result of the judgment at step S8012 is affirmative when the processing is completed for all the packs indicated in the pack information list L. In this case, the client-information acquiring unit 117 proceeds to step S8020.

At step S8020, the client-information acquiring unit 117 generates, based on pack information, an ID of which is indicated in the pack information list L, information for display to be displayed in the client 10a. In this case, the client-information acquiring unit 117 generates the information for display using the display request received from the client 10a at step S8002. A data format of the information for display generated is, for example, the Hyper Text Markup Language (HTML) or the extensible Markup Language (XML). For example, if the display request is “display a link of member lists”, the client-information acquiring unit 117 extracts, for pack information, an ID of which is indicated in the pack information list L, a member list indicated in the pack information, creates a tree structure from a master link, a slave link, and an equal link, and generates a tree structure of the member list explained in the present embodiment described above. When an object, for which a link is displayed, is a pack type, a status, or a browsing authority, the client-information acquiring unit 117 generates a tree structure of the pack type, a tree structure of the status, or a tree structure of the browsing authority in the same manner. In an HTML page, it is possible to represent a tree structure by using a Table element. If a Web application establishment technology such as ASP.NET, servlet/JSP of Java, Perl/CGI, PHP, or Ruby is used, since a tree view component is present in the standard, it is possible to more easily represent a tree structure using the component. The client-information acquiring unit 117 sets, in the information for display, display colors in displaying pack information on the client 10a, for example, as described below. For pack information, an ID of which is indicated in the pack information list L, the client-information acquiring unit 117 sets a display color for pack information associated with the retrieval acquisition flag ‘1’ to red and sets a display color for pack information associated with the retrieval acquisition flag ‘0’ to black. Other display setting items may be changed according to a value of the retrieval acquisition flag. The display setting items are, for example, emphasis of characters, a font size, and indent in displaying pack information. A table in which pack information is displayed may be changed. Display setting items changed according to a value of the retrieval acquisition flag, respective settings in the display setting items, and the like are stored in a storing unit (not shown) in advance as a program, a parameter, and the like.

Subsequently, the output unit for clients 118 transmits the information for display generated by the client-information acquiring unit 117 in this way to the client 10a via the communication control unit 101 (step S8021).

When the input/output processing unit 14 of the client 10a receives the information for display transmitted from the Web server 100 via the communication control unit 13, the input/output processing unit 14 generates a display screen using the information for display and supplies the display screen to the display processing unit 15. The display processing unit 15 causes a monitor to display a Web browser including the display screen supplied from the input/output processing unit 14 (step S8022). As a result, the user can browse information matching the retrieval condition and the display request.

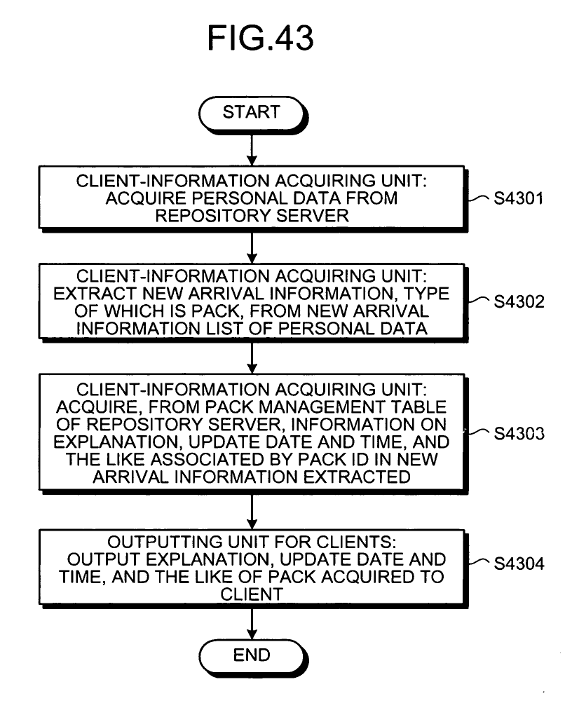

FIG. 43 is a flowchart of a processing procedure until the client-information acquiring unit 117 of the Web server 100 according to the present embodiment acquires and outputs hot information displayed on the client 10a.

First, the client-information acquiring unit 117 acquires personal data of a user using the client 10a from the personal data management table of the repository server 50 (step S4301).

The client-information acquiring unit 117 extracts new arrival information, a type of which is a pack, in a new arrival information list included in the personal data acquired (step S4302).

The client-information acquiring unit 117 acquires information such as an explanation and an update date and time of pack information associated with an ID included in the new arrival information from the pack management table of the repository server 50 (step S4303).

The output unit for clients 118 outputs the explanation, the update date and time, and the like of the pack acquired to the client 10a (step S4304).

The processing procedure described above allows the client application 12 to display hot information in the right window group 802 shown in FIG. 8. The processing procedure indicates an example of a processing procedure until the client-information acquiring unit 117 according to the present embodiment acquires and outputs hot information displayed on the client 10a. The present invention is not limited to this processing procedure.

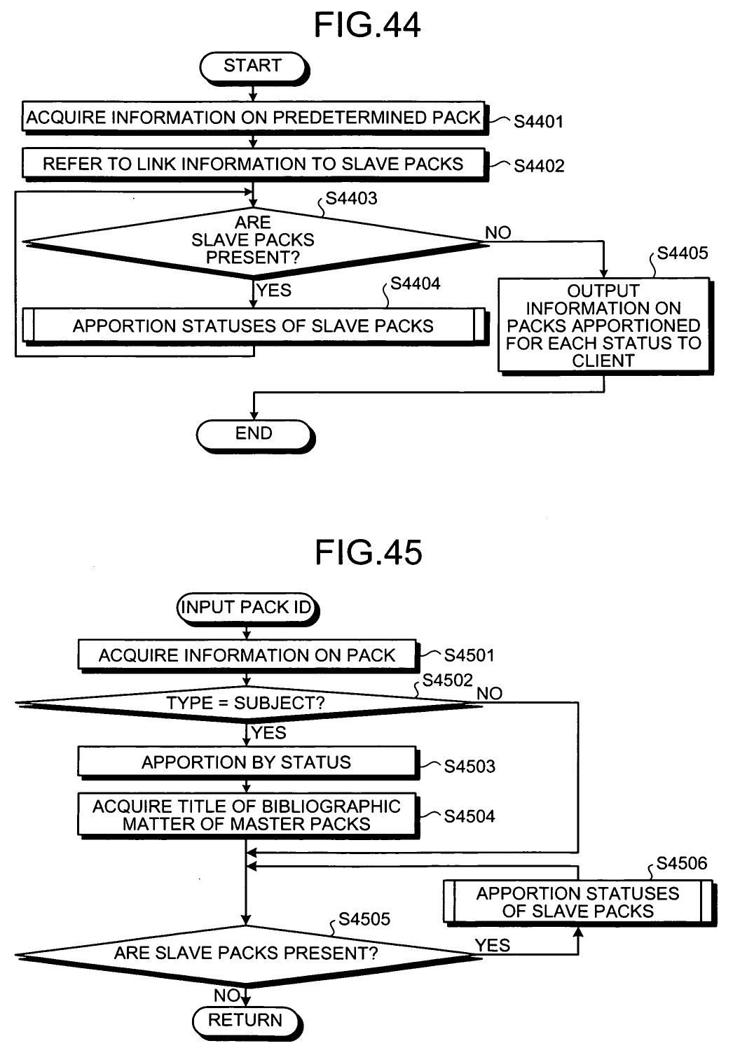

FIG. 44 is a flowchart of a processing procedure until the Web server 100 according to the present embodiment acquires and outputs information for each status such as a “subject in progress”, a “subject not started”, or a “subject completed” displayed on the client 10a.

First, the client-information acquiring unit 117 acquires predetermined pack information from the pack management table (step S4401). This predetermined pack is a pack selected from a tree in the left window 801 in FIG. 8 and displayed in the right window group 802.

The client-information acquiring unit 117 refers to information held in a link to slave packs of the pack information acquired (step S4402).

The client-information acquiring unit 117 judges whether there is a slave pack not subjected to status apportioning processing (step S4403). When the client-information acquiring unit 117 judges that there is such a slave pack (“Yes” at step S4403), the client-information acquiring unit 117 applies the status apportioning processing to the slave pack (step S4404). The status apportioning processing is explained with reference to FIG. 45 in detail.

When the client-information acquiring unit 117 judges that there is no such slave pack (“No” at step S4403), the output unit for clients 118 outputs pack information apportioned for each status by the status apportioning processing to the client 10a (step S4405).

The processing procedure described above allows the client application 12 to display information on a pack for each status in the right window group 802 shown in FIG. 8. The processing procedure indicates an example of a processing procedure until the client-information acquiring unit 117 according to the present embodiment apportions and outputs information on a pack for each status displayed on the client 10a. The present invention is not limited to this processing procedure.

FIG. 45 is a flowchart of a detailed processing procedure of the client apportioning processing performed by the client-information acquiring unit 117 shown in FIG. 44 according to the present embodiment.

First, as status apportioning processing for slave packs, the client-information acquiring unit 117 starts processing in a state in which a pack ID held in a link to slave packs is input.

The client-information acquiring unit 117 acquires pack information associated with the pack ID from the pack management table of the repository server 50 (step S4501).

The client-information acquiring unit 117 judges whether a type included in the pack information acquired is a subject (step S4502). When the client-information acquiring unit 117 judges that the type is not a subject (“No” at step S4502), the client-information acquiring unit 117 does not perform processing in particular.

When the client-information acquiring unit 117 judges that the type is a subject, the client-information acquiring unit 117 apportions the pack information according to a status (step S4503). Consequently, the pack information is apportioned for each of a “subject in progress”, a “subject not started”, and a “subject completed”.

The client-information acquiring unit 117 acquires, based on a pack ID included in a link to master packs of the pack, a title from a bibliographic matter of pack information on the master pack held in the pack management table of the repository server 50 (step S4504). When the client application 12 displays the title in the right window group 802, the title is displayed in a space of a theme of the pack apportioned. When the master pack is not a theme, the client-information acquiring unit 117 further acquires a title from the bibliographic matter of the pack information on the master pack.

The client-information acquiring unit 117 judges, according to a link to slave packs of the pack information apportioned, whether there is a slave pack not subjected to status apportioning processing (step S4505). When the client-information acquiring unit 117 judges that there is such a slave pack (“Yes” at step S4505), the client-information acquiring unit 117 performs status apportioning processing for the slave pack (step S4506). The status apportioning processing shown in FIG. 45 is recursively invoked according to a hierarchical structure of the slave pack.

When the client-information acquiring unit 117 judges that there is no such slave pack (“No” at step S450.5), the client-information acquiring unit 117 performs processing for returning to the invocation of the status apportioning processing.

By performing such processing, it is possible to apply apportioning processing to all packs provided in hierarchies below a predetermined pack. Since such apportioned pack information is input, the client application 12 is capable of displaying the pack information for each of the “subject in progress”, the “subject not started”, and the “subject completed” shown in FIG. 8.

The processing procedure described above makes it possible to apportion packs, a type of which is a subject, for each status in packs formed in a hierarchical structure. The processing procedure indicates an example of a processing procedure of the status apportioning processing performed by the client-information acquiring unit 117 according to the present embodiment. The present invention is not limited to this processing procedure.

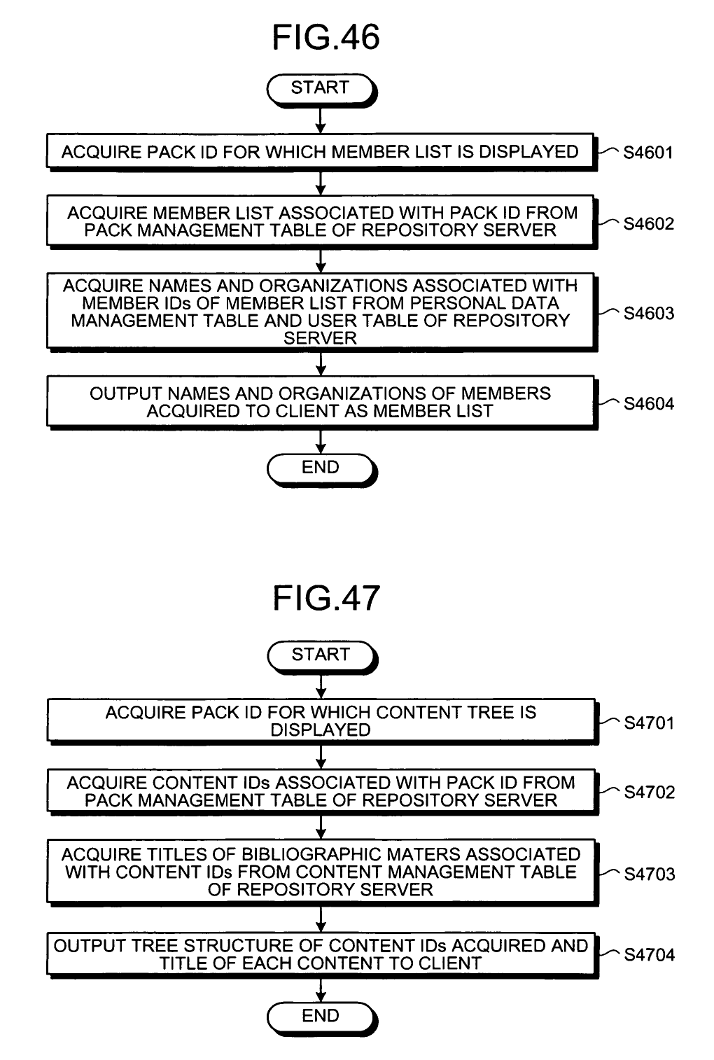

FIG. 46 is a flowchart of a processing procedure until the Web server 100 according to the present embodiment acquires and outputs information on a member list indicated by member names displayed on the client 10a.

First, the client-information acquiring unit 117 acquires a pack ID for which a member list is displayed (step S4601). This pack ID acquired is a pack ID of the “project 1” in the example of the screen shown in FIG. 8.

The client-information acquiring unit 117 acquires a member list associated with the pack ID from the pack management table of the repository server 50 (step S4602). The member list includes one or more user IDs of users belonging to a pack.

The client-information acquiring unit 117 acquires names associated with the respective user IDs of the member list from the user table of the repository server 50. The client-information acquiring unit 117 acquires organizations associated with the respective user IDs of the member list from the personal data management table of the repository server 50 (step S4603).

The output unit for clients 118 outputs the names of the members and the organizations acquired to the client 10a as a member list (step S4604).

The processing procedure described above allows the client application 12 to display the member list. The processing procedure indicates an example of a processing procedure until the Web server 100 according to the present embodiment acquires and outputs information on a member list. The present invention is not limited to this processing procedure.

FIG. 47 is a flowchart of a processing procedure until the Web server 100 according to the present embodiment acquires and outputs information on a content list displayed in a tree structure in the client 10a.

First, the client-information acquiring unit 117 acquires a pack ID for which a content tree is displayed (step S4701). This pack ID acquired is a pack ID of the “project 1” in the example of the screen shown in FIG. 8.

The client-information acquiring unit 117 acquires, from the pack management table of the repository server 50, content IDs associated with the pack ID acquired (step S4702). The content IDs are held in a state in which one or more content IDs hold a tree structure in the XML format.

The client-information acquiring unit 117 acquires titles of bibliographic matters associated with the respective content IDs from the content management table of the repository server 50 (step S4703).

The output unit for clients 118 associates the titles of the respective content IDs and outputs the titles in a state in which a tree structure is held by the content IDs acquired (step S4704).

The processing procedure described above allows the client application 12 to display a content tree. The processing procedure indicates an example of a processing procedure until the Web server 100 according to the present embodiment acquires and outputs information on a content list. The present invention is not limited to this processing procedure.

The client application 12 input with the contents information sets the titles of the bibliographic matters of the contents input in Text of TreeNode. The client application 12 represents a tree structure of the content ID list with TreeNode and displays the tree structure with the TreeView control.

By performing the processing described above, the client application 12 can display all the items shown in FIG. 8.

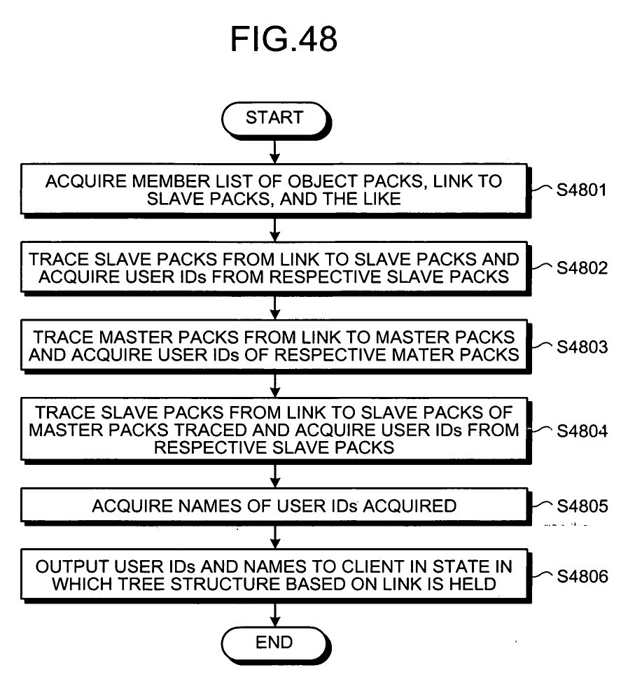

FIG. 48 is a flowchart of a processing procedure until the Web server 100 according to the present embodiment acquires and outputs information on a user tree displayed on the client 10a. In the present embodiment, the user 14 shown in FIG. 14 requests display of the user tree.

First, the client-information acquiring unit 117 acquires a member list of information on a pack to which the user 14 belongs, a link to slave packs, and a link to master packs from the pack management table of the repository server 50 (step S4801). It is seen that a user ID of the user 14 is included in the member list of the pack acquired.

The client-information acquiring unit 117 traces the link to slave packs of the pack, to which the user 14 belongs, and acquires member lists of the respective slave packs (step S4802). The member lists are acquired from the pack management table of the repository server 50. This is the same in the following processing. The client-information acquiring unit 117 applies the processing for tracing the link to slave packs to all packs in hierarchies below the pack to which the user 14 belongs.

The client-information acquiring unit 117 traces the link to master packs of the pack, to which the user 14 belongs, and acquires member lists of respective master packs (step S4803). The client-information acquiring unit 117 applies the processing for tracing the link to master packs to all packs in higher hierarchies of the pack to which the user 14 belongs.

When the client-information acquiring unit 117 traces the link to master packs, the client-information acquiring unit 117 traces a link to slave packs that are slave packs linked from the master packs and for which member lists are not acquired and acquires member lists of the respective slave packs (step S4804). The client-information acquiring unit 117 performs the processing for tracing the link to slave packs to acquire member lists of all slave packs that can be traces according to the link from the respective master packs.

When the client-information acquiring unit 117 acquires member lists of all packs included in the tree including the pack to which the user 14 belongs, the client-information acquiring unit 117 acquires names associated with user IDs included in the member lists from the user table of the repository server 50 (step S4805).

The output unit for clients 118 outputs a user ID and a name of a user of each pack to the client 10a in a state in which a tree structure by a link of the respective packs is held (step S4806).

The processing procedure described above allows the client application 12 to display a user tree. The processing procedure indicates an example of a processing procedure until the Web server 100 according to the present embodiment acquires and outputs information on the user tree. The present invention is not limited to this processing procedure.

It is possible to, for example, extract a route of a person according to the user tree generated in the processing procedure performed by the Web server 100. A retrieval procedure in the tree is not limited to the processing procedure described above. Any retrieval method may be used.

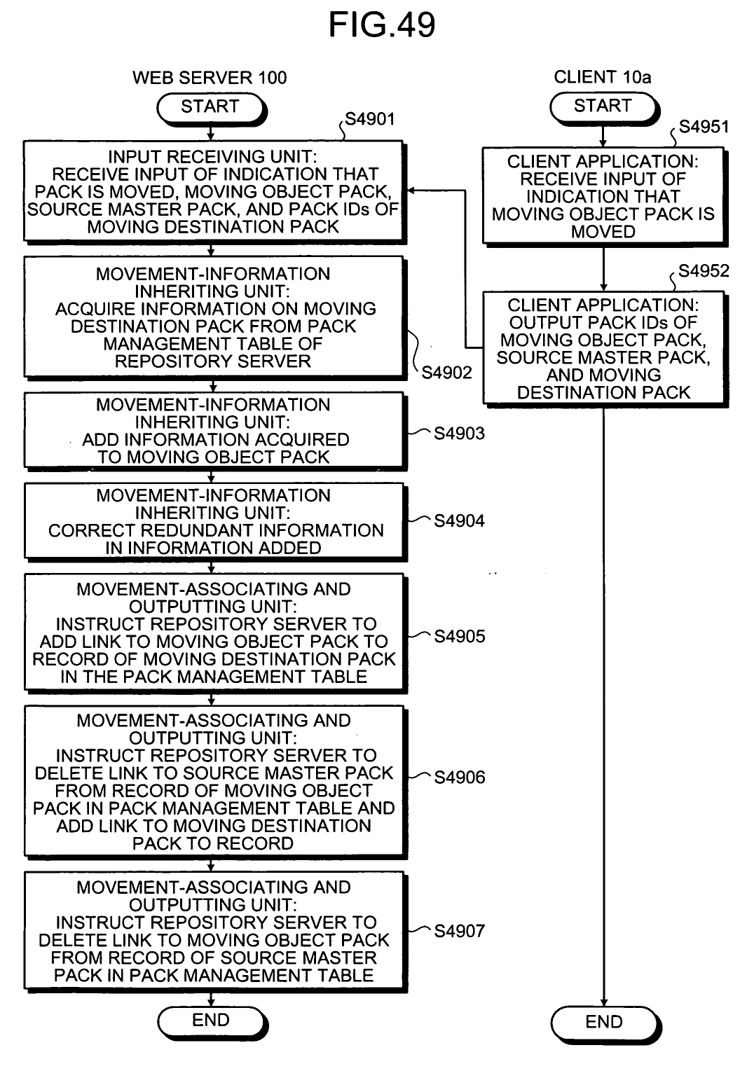

FIG. 49 is a flowchart of a processing procedure in moving a predetermined pack, which is a slave of a certain pack, to a position of a slave of another pack in the tree of packs displayed in the client application 12 of the client 10a in the Web server 100 and the client 10a according to the present embodiment. As an example of such movement of a pack, it is conceivable to move a subject 3-1 below the subject 3 to a position below the subject 4 in the tree shown in the left window 801 of FIG. 8.

First, the client application 12 receives an input for moving a movement object pack displayed in the tree of packs by operation of the mouse or the like of a user (step S4951). Consequently, the movement of the pack is completed in the tree displayed by the client application 12. In the following processing, processing for updating the pack management table that holds links is performed.

When the client application 12 receives operation for moving a pack, the client application 12 outputs pack IDs of a pack to be moved, a master pack of the pack, and a movement destination pack to the Web server 100 together with an indication that the pack is moved (step S4952).

The Web server 100 receives the pack IDs of the pack to be moved, the master pack, and the movement destination pack together with the indication that the pack is moved (step S4901).

The movement-information inheriting unit 123 acquires pack information on the movement destination pack from the pack management table of the repository server 50 (step S4902). The pack information on the movement destination pack acquired is a member list, a reference authority, and an edition authority.

The movement-information inheriting unit 123 adds the pack information acquired to pack information on the movement object pack of the pack management table (step S4903).

The movement-information inheriting unit 123 corrects redundant information in the pack information on the movement object pack of the pack management table of the repository server 50 (step S4904). Consequently, pack information obtained by inheriting the pack information on the movement destination pack and correcting the redundant information is generated.

The movement-association output unit 122 instructs the repository server 50 to add the pack ID of the movement object pack to a link of slave packs of a record of the movement destination pack of the pack management table (step S4905).

The movement-association output unit 122 instructs the repository server 50 to delete the pack ID of the master pack from a link to master packs of a record of the movement object pack of the pack management table and add the pack ID of the movement destination pack to the link (step S4906).

The movement-association output unit 122 instructs the repository server 50 to delete the pack ID of the movement object pack from a link of slave packs of a record of the master pack of the pack management table (step S4907).

The processing procedure described above makes it possible to easily change a link structure held by the Web server 100 and the client 10a among the packs. The processing procedure indicates an example of a processing procedure performed when a pack is moved by the client application 12 in the Web server 100 and the client 10a according to the present embodiment. The present invention is not limited to this processing procedure. Since the information on the movement destination pack is inherited by the movement object pack, processing performed by the user according to the movement of the pack is reduced.

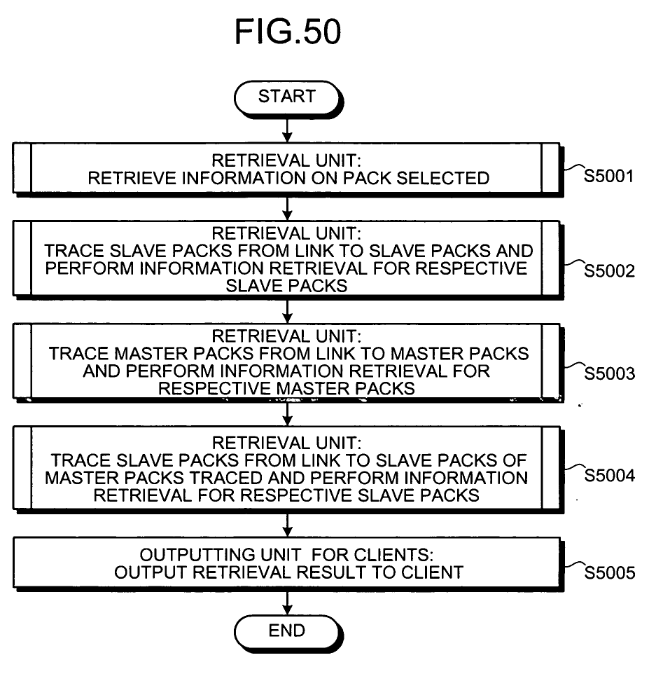

FIG. 50 is a flowchart of a processing procedure in performing keyword retrieval with the client application 12 of the client 10a in the Web server 100 according to the present embodiment. The keyword retrieval is performed based on the keyword retrieval dialog shown in FIG. 15. Processing after the Web server 100 receives an input of a keyword, a pack ID of a pack selected, and an indication that the keyword is retrieved from the client application 12 is explained.

The keyword retrieval means retrieval applied to all packs in a tree including the pack selected. However, the retrieval is not permitted in some cases depending on a level set for each of the packs.

First, the retrieving unit 125 performs information retrieval of the pack selected (step S5001). A detailed procedure of the information retrieval is described later.

The retrieving unit 125 traces a link to slave packs held by the pack management table for the pack selected and applies information retrieval to the respective slave packs (step S5002). The retrieving unit 125 applies the processing for tracing the link to slave packs to all packs in hierarchies below the pack selected.

The retrieving unit 125 traces a link to master packs held by the pack management table for the pack selected and applies information retrieval to the respective master packs (step S5003). The retrieving unit 125 applies the processing for tracing the link to master packs to all packs in hierarchies above the pack to which the user 14 belongs.

In tracing the link to master packs, the retrieving unit 125 traces a link to slave packs that are linked from the master packs and for which information retrieval is not performed and applies information retrieval to the respective slave packs (step S5004). The retrieving unit 125 performs the processing for tracing the link to slave packs and acquires member lists of all slave packs that can be traced through the link from the respective master packs.

The client-information acquiring unit 117 outputs a result of the information retrieval of the retrieving unit 125 to the client 10a that requested the keyword retrieval (step S5005).

The processing procedure describe above allows the Web server 100 and the client 10a to perform tree search. The processing procedure indicates an example of a processing procedure performed when keyword retrieval is performed by the client application 12 of the client 10a in the Web server 100 according to the present embodiment. The present invention is not limited to this processing procedure.

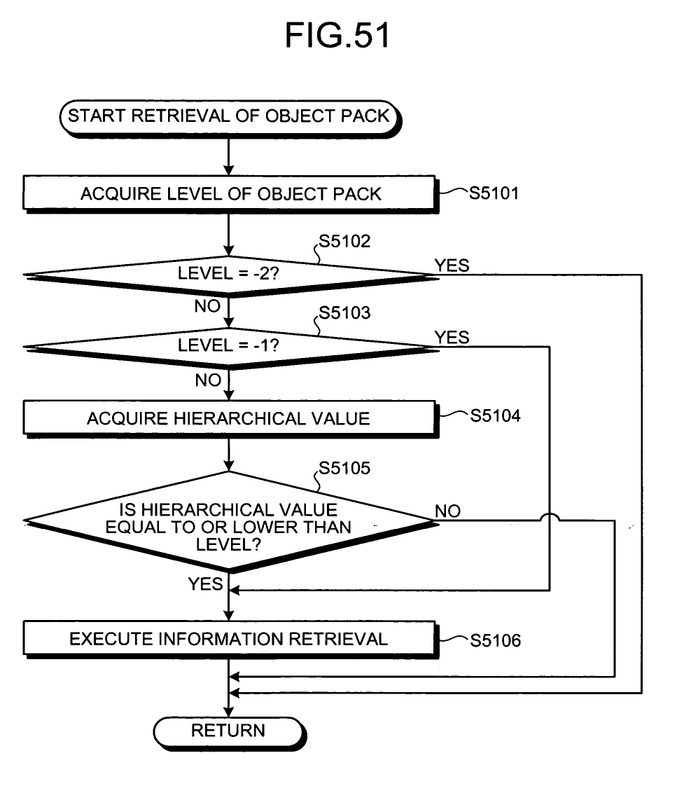

FIG. 51 is a flowchart of a procedure of detailed processing of information retrieval performed for respective packs by the Web server 100 according to the present embodiment.

First, the retrieving unit 125 acquires a level of a retrieval pack from the pack management table of the repository server 50 (step S5101).

The retrieving unit 125 judges whether the level of the retrieval pack is ‘−2’ (step S5102). When the level of the retrieval pack is ‘−2’ (“Yes” at step S5102), the retrieving unit 125 ends the processing considering that information retrieval is not permitted.

The retrieving unit 125 judges whether the level of the retrieval pack is ‘−1’ (step S5103).

When the retrieving unit 125 judges that the level of the retrieval pack is not ‘−1’ (“No” at step S5103), the retrieving unit 125 acquires a hierarchical value (step S5104). The hierarchical value is a value indicating the number of hierarchies between a pack that is an object of information retrieval and a pack selected by the user first. The hierarchical value conceptually indicates a distance to a pack selected.

The retrieving unit 125 judges whether the hierarchical value acquired is equal to or lower than the level of the retrieval pack (step S5105). When the hierarchical value acquired is not equal to or lower than the level of the retrieval pack (“No” at step S5105), the retrieving unit 125 ends the processing considering that information retrieval is not permitted.

When the level of the retrieval pack is ‘−1’ (“Yes” at step S5103) and when the hierarchical value acquired is equal to or lower than the level of the retrieval pack (“Yes” at step S5105), the retrieving unit 125 instructs the repository server 50 to apply retrieval to a bibliographic matter of the retrieval pack and a bibliographic matter of contents information associated by a content ID held by the retrieval pack (step S5106).

The processing procedure described above allows the Web server 100 to perform retrieval for each of the packs. The processing procedure indicates an example of a processing procedure of information retrieval performed for the packs by the Web server 100 according to the present embodiment. The present invention is not limited to this processing procedure.

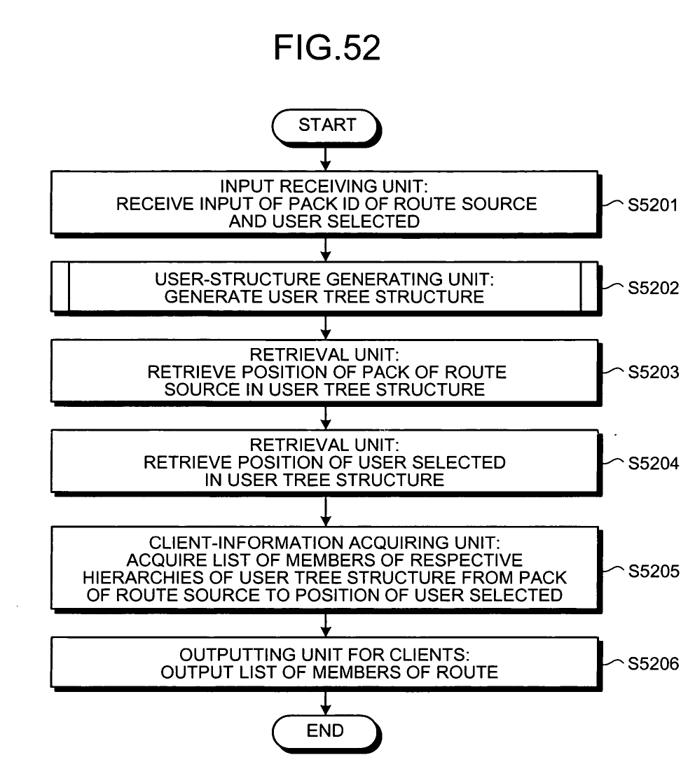

FIG. 52 is a flowchart of a processing procedure until the Web server 100 according to the present embodiment acquires a route to a predetermined person and outputs the route to the client 10a. In the present embodiment, “display a route of a person” is selected from the menu as shown in FIG. 18.

First, the input receiving unit 119 receives an input of a pack ID of a route source and a user ID of a user selected and request for retrieval (step S5201). The pack ID of the route source is, for example, a pack ID of a pack to which the user using the client 10a belongs. The user ID of the user selected is, for example, a user ID of a user selected by right click in FIG. 18.

The user-structure generating unit 127 generates a user tree (step S5202). Since a procedure for generating the user tree is the same as the processing shown in FIG. 48, an explanation of the procedure is omitted.

The retrieving unit 125 retrieves a position of a pack indicated by the pack ID input in the user tree structure (step S5203).

The retrieving unit 125 retrieves a position of the user selected in the user tree structure (step S5204). A pack in which a user ID of a member list included in each pack coincides with the user ID of the user selected is a position of the user.

The client-information acquiring unit 117 acquires a list of members of respective hierarchies of the user tree structure from the pack of the route source to the position of the user selected (step S5205).

The output unit for clients 118 outputs the list of members on a route from the pack of the route source to the user selected, which is acquired by the client-information acquiring unit 117, with the user tree structure held therein (step S5206).

The processing procedure described above allows the client application 12 to display a route to a person selected. The processing procedure indicates an example of a processing procedure until the Web server 100 according to the present embodiment acquires and outputs the route to the person selected. The present invention is not limited to this processing procedure.

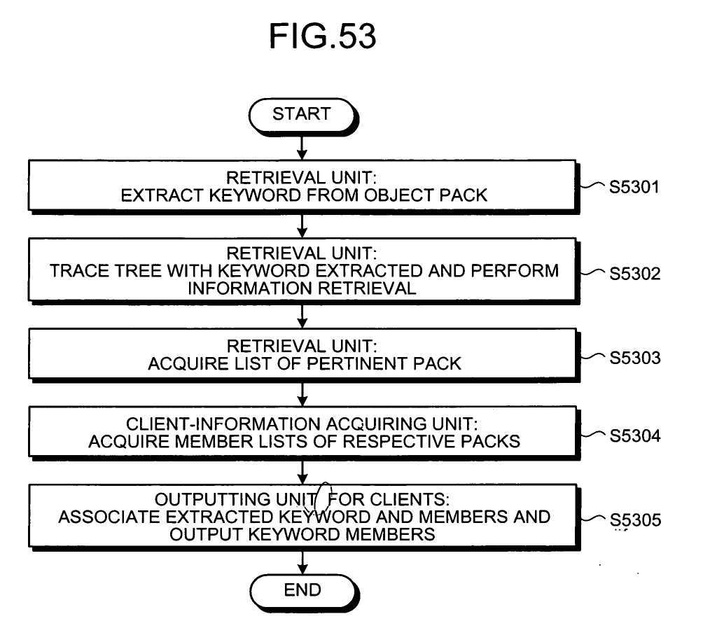

FIG. 53 is a flowchart of a processing procedure until the Web server 100 according to the present embodiment retrieves information with a keyword automatically set and outputs the information. After the automatic keyword retrieval is performed by the Web server 100, the client application 12 displays a screen shown in FIG. 20.

First, the retrieving unit 125 extracts a keyword from an object pack of retrieval referred to by a user (step S5301). Any processing procedure may be used as a processing procedure for extracting a keyword.

The retrieving unit 125 traces the tree with the keyword extracted and performs information retrieval (step S5302). A procedure for tracing the tree performed by the retrieving unit 125 may be any procedure. For example, the procedure shown in FIG. 50 is conceivable. The information retrieval performed for each pack by the retrieving unit 125 is the same as the processing procedure shown in FIG. 51. An explanation of the information retrieval is omitted.

The retrieving unit 125 acquires a list of pack IDs of packs hit by the keyword (step S5303). The retrieving unit 125 holds a correspondence relation between the keyword and the pack IDs indicating the packs hit by the keyword.

The client-information acquiring unit 117 instructs the repository server 50 to acquire member lists of the packs hit by the keyword from the pack management table and the user table based on the pack IDs acquired (step S5304).

The output unit for clients 118 associates the extracted keyword and members based on the association of the extracted keyword and the pack IDs and the association of the pack IDs and the member lists and outputs the keyword and the members to the client 10a (step S5305).

The processing procedure described above allows the client application 12 to display a person having information on a keyword automatically extracted. The processing procedure indicates an example of a processing procedure until the Web server 100 retrieves information with a keyword automatically set and outputs the information. The present invention is not limited to this processing procedure.

A processing procedure performed when the user applies an action to packs displayed on the client application 12 is explained. The action means selection of respective items from the action menu 2101 shown in FIG. 21. Processing performed when the respective items displayed in the action menu 2101 are selected is explained in order below.

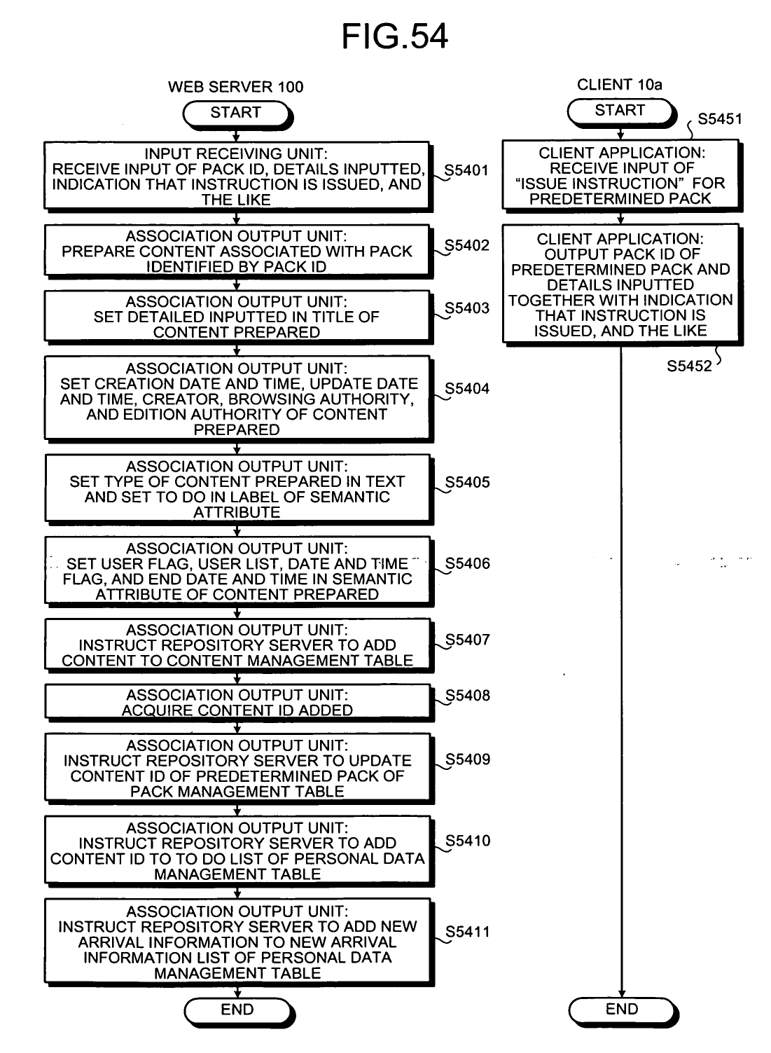

FIG. 54 is a flowchart of a processing procedure performed when “issue an instruction” is selected by the client application 12 of the client 10a in the Web server 100 and the client 10a according to the present embodiment.

The client application 12 receives an input of “issue an instruction” for a predetermined pack (step S5451). This predetermined pack indicates, for example, a pack selected by right click of a user. When the input of “issue an instruction” is received, the display processing unit 15 displays the instruction dialog shown in FIG. 22. This makes it possible to receive instruction details.

The client application 12 outputs, when an “instruct” button is depressed, a pack ID of the predetermined pack, details input from the instruction dialog, a value of a date box, presence or absence of designation of an appointed data of delivery, and an indication of issuance of an instruction to the Web server 100 (step S5452).

The input receiving unit 119 of the Web server 100 receives the input of the pack ID of the predetermined pack, the content input to the instruction dialog, and the indication of issuance of an instruction from the client 10a (step S5401).

The association output unit 120 prepares a content structure of content to be added on the memory (step S5402). After setting predetermined information in this content structure, the association output unit 120 adds the predetermined information to the content management table.

The association output unit 120 sets the content input in a title of the content prepared (step S5403).

The association output unit 120 sets a creation date and time, an update date and time, a creator, a browsing authority, and an edition authority of the content prepared (step S5404). The association output unit 120 sets time when the content is registered as the creation date and time and the update date and time and sets a user ID of the user who issued the instruction. The association output unit 120 uses information acquired from pack information on the predetermined pack by the information inheriting unit 121 as the browsing authority and the edition authority. Acquisition of these kinds of information is realized when the information inheriting unit 121 requests the repository server 50 to acquire predetermined pack information from the pack management table.

The association output unit 120 sets a text in a type of the content prepared and sets “To Do” in a label of a semantic attribute (step S5405).

The association output unit 120 sets a user flag, a user list, a date and time flag, and an end date and time in the semantic attribute of the content prepared (step S5406). This user flag is set as ‘True’, a user of a member list of an object pack is set in the user list, presence or absence of designation of an appointed date of delivery is set in the date and time flag, and a date and time of the date and time box is set in the end date and time. Not started/planned is set in the status.

The association output unit 120 instructs the repository server 50 to add the content set to the content management table (step S5407).

The association output unit 120 acquires a content ID for identifying the content added to the content management table from the repository server 50 (step S5408).

The association output unit 120 instructs the repository server 50 to add the content ID acquired to a content ID of the predetermined pack of the pack management table (step S5409). A record of the predetermined pack of the pack management table is specified according to the pack ID of the predetermined pack.

In the example shown in FIG. 21, the action is applied to the pack named the subject 305. Thus, the association output unit 120 adds a new content ID to a top hierarchy of the tree of the content ID list. When the user right-clicks any one of contents of the content tree of the right window group 802 in FIG. 8 and performs an action for issuing an instruction, the association output unit 120 extracts a content ID of the content selected and adds a new content ID as a slave element of the content ID present in the content ID list of the object pack.

Referring back to FIG. 54, the association output unit 120 instructs the repository server 50 to add a content ID to a To Do list of the personal data management table (step S5410). The user for whom the content ID is added to the To Do list is a user included in the member list of the pack selected. The association output unit 120 specifies personal data of the personal data management table according to a user ID included in the member list and instructs the repository server 50 to add a content ID to a To Do list of the personal data specified.

Moreover, the association output unit 120 instructs the repository server 50 to add new arrival information to the new arrival information list of the persona data management table (step S5411). The user for whom the new arrival information is added to the new arrival information list is a user included in the member list of the pack selected. The association output unit 120 instructs the repository server 50 to add a content ID and new arrival information created from a creation date and time and a creator to personal data of the user.

The processing procedure described above allows the client 10a to issue an instruction to a pack. The processing procedure indicates an example of a processing procedure performed when “issue an instruction” is selected by the client application 12 of the client 10a. The present invention is not limited to this processing procedure.

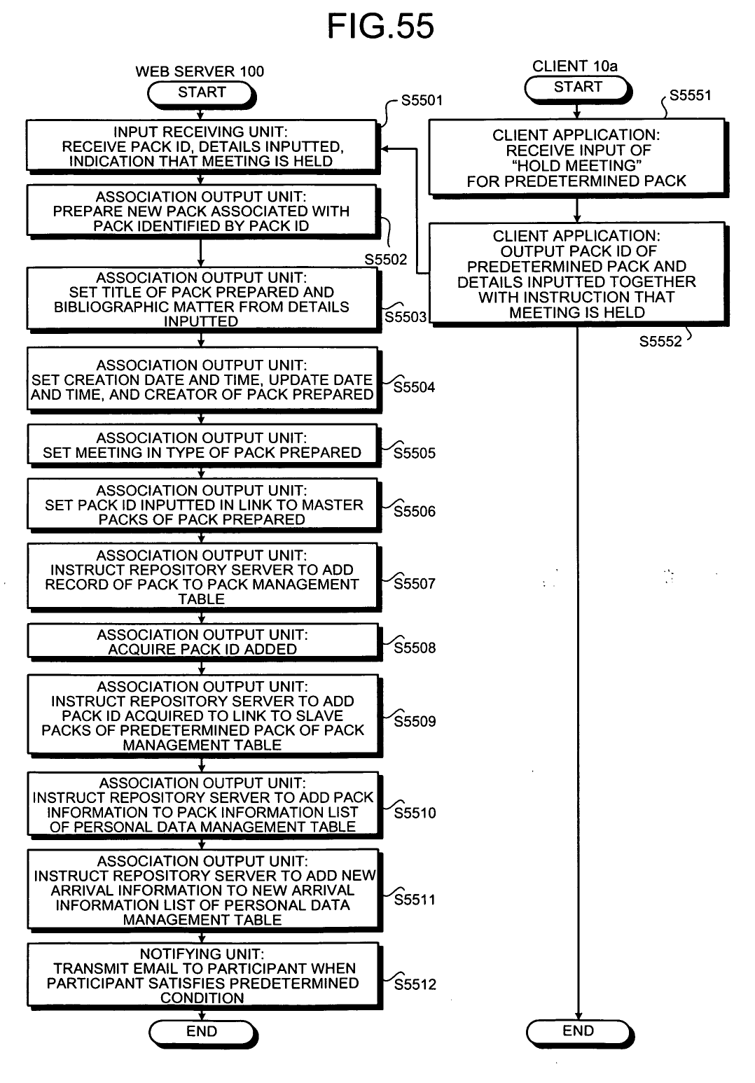

FIG. 55 is a flowchart of a processing procedure performed when “holding a meeting” is selected by the client application 12 of the client 10a in the Web server 100 and the client 10a according to the present embodiment.

First, the client application 12 receives an input of “hold a meeting” for a predetermined pack (step S5551). This predetermined pack indicates, for example, a pack selected by right click of a user. When the client application 12 receives the input of “hold a meeting”, the display processing unit 15 displays the meeting holding dialog shown in FIG. 25. This makes it possible to receive detailed setting of a meeting.

When a “hold a meeting” button is depressed, the client application 12 outputs a pack ID of the predetermined pack, a meeting name, a date and time, a place, participants, and an indication that the meeting is held to the Web server 100 (step S5552).

The input receiving unit 119 of the Web server 100 receives the input of the pack ID of the predetermined pack, the meeting name, the date and time, the place, the participants, and the indication that the meeting is held from the client 10a (step S5501).

The association output unit 120 prepares a pack structure of a pack to be added on the memory (step S5502). After setting predetermined information in this pack structure, the association output unit 120 adds the pack to the pack management table.

The association output unit 120 sets a title and a bibliographic matter of the pack prepared from the details input (step S5503). Specifically, the association output unit 120 sets the meeting name input in a title of a bibliographic matter of the pack, sets the date and time input in a plan start date and time and a plan end date and time of the bibliographic matter of the pack, sets the place input in a place of the bibliographic matter of the pack, and sets the participants input in a member list of the pack.

The association output unit 120 sets a creation date and time, an update date and time, and a creator of the pack prepared (step S5504). The association output unit 120 sets time when the pack is registered as the creation date and time and the update date and time and sets a user ID of the user who instructed the holding of the meeting.

The association output unit 120 sets a meeting in a type of the pack prepared (step S5505).

The association output unit 120 sets the pack ID of the predetermined pack in a link to master packs of the pack prepared (step S5506).

The association output unit 120 instructs the repository server 50 to add the pack set to the pack management table (step S5507).

The association output unit 120 acquires a pack ID for identifying the pack added to the pack management table from the repository server 50 (step S5508).

The association output unit 120 instructs the repository server 50 to add the pack ID acquired to a link to slave packs of a record of the predetermined pack in the pack management table (step S5509). The record of the predetermined pack of the pack management table is specified by the pack ID of the predetermined pack.

The association output unit 120 instructs the repository server 50 to add pack information to the pack information list of the personal data management table (step S5510). The user for whom this pack information is added is a user set as a participant in the meeting. The association output unit 120 specifies the user according to a user ID included in a member list of the pack information added. The association output unit 120 adds the pack information to pack information list of personal data of the user specified. The pack information added includes a pack ID and a pack type.

The association output unit 120 instructs the repository server 50 to add new arrival information to the new arrival information list of the personal data management table (step S5511). A user for whom the new arrival information is added to the new arrival information list is a user included in a member list of the pack added anew. The association output unit 120 instructs the repository server 50 to add new arrival information created from the pack ID, the creation date and time, and the creator to personal data of the user.

When a predetermined condition is met, the notifying unit 113 transmits an email indicating that a meeting is held to participants (step S5512). In the present embodiment, a requirement for transmitting an email is that the checkbox shown in FIG. 25 is checked. However, the predetermined condition is not limited to such a condition and any condition may be adopted.

The processing procedure described above makes it possible to manage, in a database, information corresponding to the action of holding a meeting performed by the client 10a. The processing procedure indicates an example of a processing procedure performed when “hold a meeting” is selected by the client application 12 of the client 10a in the Web server 100 and the client 10a according to the present embodiment. The present invention is not limited to this processing procedure.

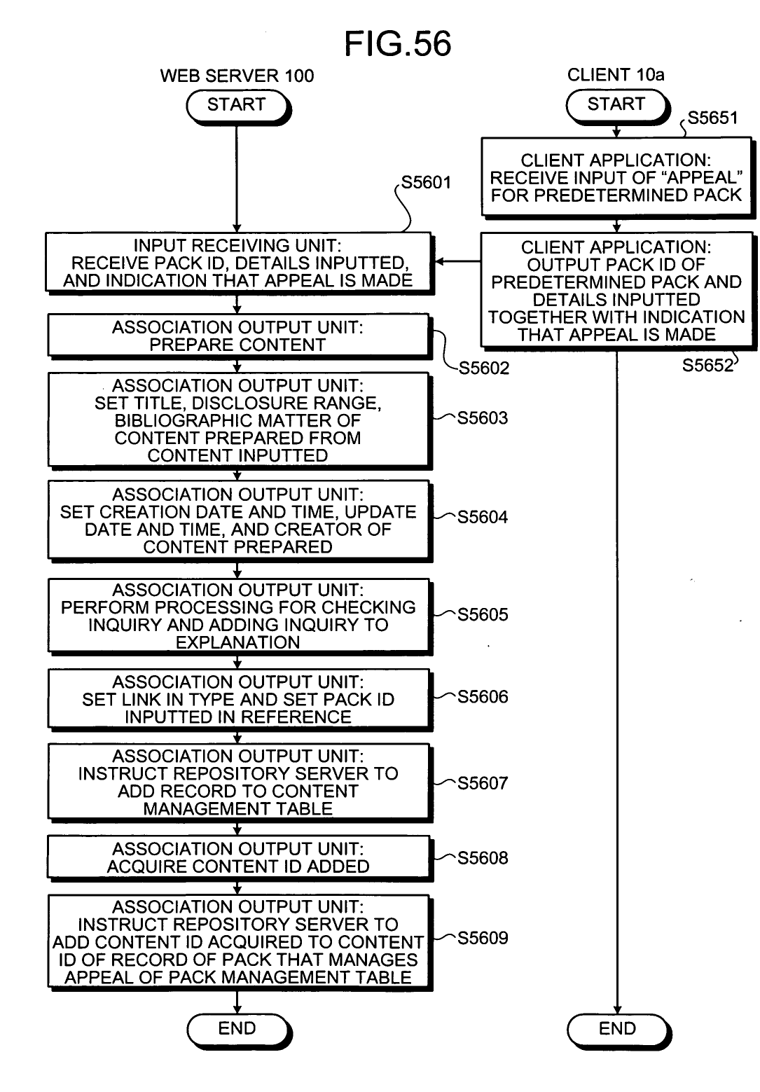

FIG. 56 is a flowchart of a processing procedure performed when “make an appeal” is selected by the client application 12 of the client 10a in the Web server 100 and the client 10a according to the present embodiment.

First, the client application 12 receives an input of “make an appeal” for a predetermined pack (step S5651). This predetermined pack indicates, for example, a pack selected by right click of a user. When the client application 12 receives the input of “make an appeal”, the display processing unit 15 displays the appeal registration dialog shown in FIG. 27. This makes it possible to receive setting of details to be appealed.

When an “appeal” button is depressed, the client application 12 outputs a pack ID, a title, an explanation, and a disclosure range of the predetermined pack, presence or absence of a reference by a checkbox, and an indication that an appeal is made to the Web server 100 (step S5652).

The input receiving unit 119 of the Web server 100 receives, from the client 10a, the pack ID, the title, the explanation, and the disclosure range of the predetermined pack, the presence or absence of a reference by a checkbox, and the indication that an appeal is made (step S5601).

The association output unit 120 prepares a content structure of content to be added on the memory (step S5602). After setting predetermined information in this content structure, the association output unit 120 adds the content to the content management table.

The association output unit 120 sets a title and a bibliographic matter of the content prepared from the details input (step S5603). Specifically, the association output unit 120 sets the title input in a title of the bibliographic matter, sets the explanation input in an explanation of the bibliographic matter, and sets the disclosure range input in a level.

The association output unit 120 sets a creation date and time, an update date and time, and a creator of the content prepared (step S5604). The association output unit 120 sets time when the content is registered as the creation date and time and the update date and time and sets a user ID of the user who input the indication that an appeal is made as the creator.

When there is a reference through a checkbox, the association output unit 120 performs setting for adding a reference in the explanation of the content prepared (step S5605). This reference to be added is realized by acquiring, from the user table of the repository server 50, a name, an email address, and the like of the user who input the indication that an appeal is made. No processing is performed in particular when there is no reference through a checkbox.

The association output unit 120 sets a link in a type of the content prepared and sets the pack ID of the predetermined pack in a reference (step S5606). Consequently, the predetermined pack is set as an object to be appealed.

The association output unit 120 instructs the repository server 50 to add the content set to the content management table (step S5607).

The association output unit 120 acquires a content ID for identifying the content added to the content management table from the repository server 50 (step S5608).

The association output unit 120 instructs the repository server 50 to add the content ID acquired to a content ID of a record for managing an appeal of the pack management table (step S5609). As described above, in the pack management table, there is only one record for managing an appeal. In other words, it is possible to easily specify the record by retrieving the record on condition that a pack type of the record is an appeal.

The processing procedure described above makes it possible to manage, in a database, information corresponding to the action of making an appeal performed by the client 10a. The processing procedure indicates an example of a processing procedure performed when “make an appeal” is selected by the client application 12 of the client 10a in the Web server 100 and the client 10a according to the present embodiment. The present invention is not limited to this processing procedure. Processing in displaying appeal information registered is described later.

The present embodiment does not limit a record with a pack type of “appeal” only to one in the pack management table but allows a plurality of records to be present in the pack management table. As processing performed when a plurality of records are present, for example, it is conceivable to cause a user to select to which pack a content created should be added.

It is assumed that a record for holding appeal information in the pack management table is created in advance when setting for the repository server 50 is performed.

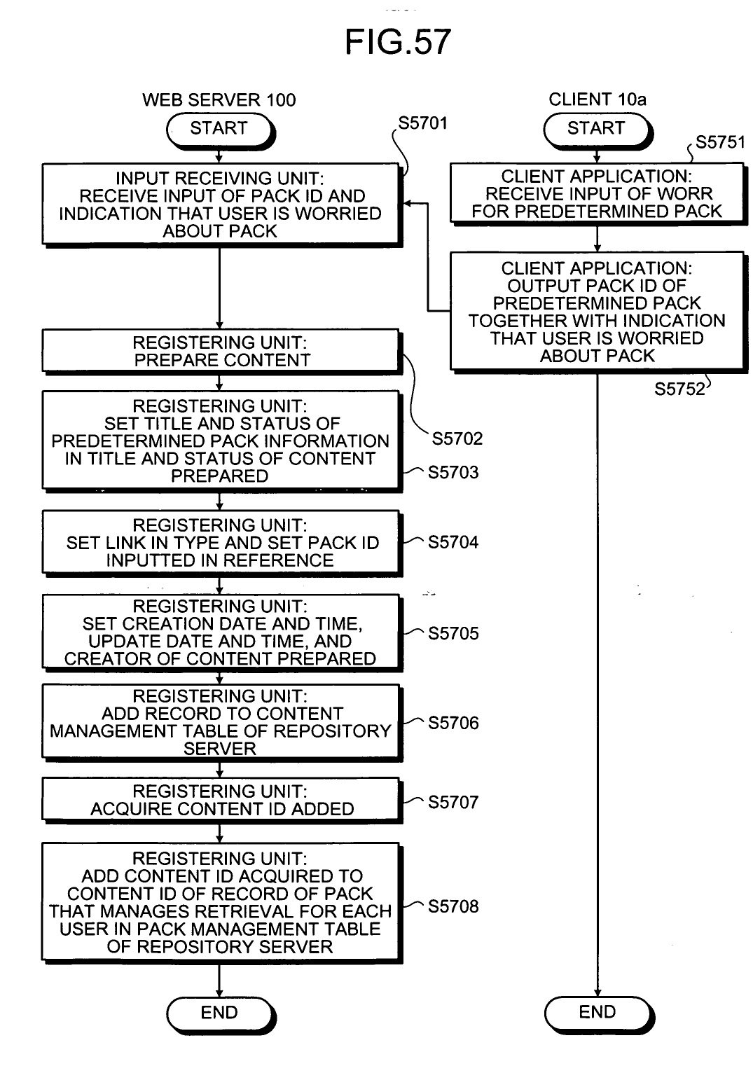

FIG. 57 is a flowchart of a processing procedure performed when “worried” is selected by the client application 12 of the client 10a in the Web server 100 and the client 10a according to the present embodiment.

First, the client application 12 receives an input of “worried” for a predetermined pack (step S5751). This predetermined pack indicates, for example, a pack selected by right click of a user.

When a “worry” button is depressed, the client application 12 outputs a pack ID of the predetermined pack and an indication that the user is worries about the pack to the Web server 100 (step S5752).

The input receiving unit 119 of the Web server 100 receives the input of the pack ID of the predetermined pack and the indication that the user is worried about the pack from the client 10a (step S5701).

The registering unit 111 prepares a content structure of content to be added on the memory (step S5702). After setting predetermined information in this content structure, the registering unit 111 adds the content to the content management table.

The registering unit 111 sets a title of a bibliographic matter of the predetermined pack in a title of a bibliographic matter of the content prepared and sets a status of the predetermined pack in a status of the content prepared (step S5703).

The registering unit 111 sets a link in a type of the content prepared and sets the pack ID of the predetermined pack in a reference (step S5704). Consequently, the predetermined pack is set as an object that the user is worried about.

The registering unit 11 sets a creation date and time, an update date and time, and a creator of the pack prepared (step S5705). The registering unit 111 sets time when the pack is registered as the creation date and time and the update date and time and sets a user ID of the user who input the indication that the user is worried about the pack as the creator.

The registering unit 111 instructs the repository server 50 to add the content set to the content management table (step S5706).

The registering unit 111 acquires a content ID for identifying the content added to the content management table from the repository server 50 (step S5707).

The registering unit 111 instructs the repository server 50 to add the content ID acquired to a content ID of a record of a pack for managing retrieval for each user of the pack management table (step S5708). As described above, in the pack management table, one record for managing information that the user is worried about is prepared for each user. It is possible to easily specify the record by setting retrieval in a type and setting a user ID of the user in a member list to retrieval of the record.

The processing procedure described above makes it possible to manage, in a database, information corresponding to the action of “worried” performed by the client 10a. The processing procedure indicates an example of a processing procedure performed when “worried” is selected by the client application 12 of the client 10a in the Web server 100 and the client 10a according to the present embodiment. The present invention is not limited to this processing procedure. Processing in displaying “worried” information registered is described later.

After the processing of “worried” described above ends, the display processing unit 15 displays the confirmation dialog shown in FIG. 28. This allows the user to confirm that a pack is registered as an object that the user is worried about.

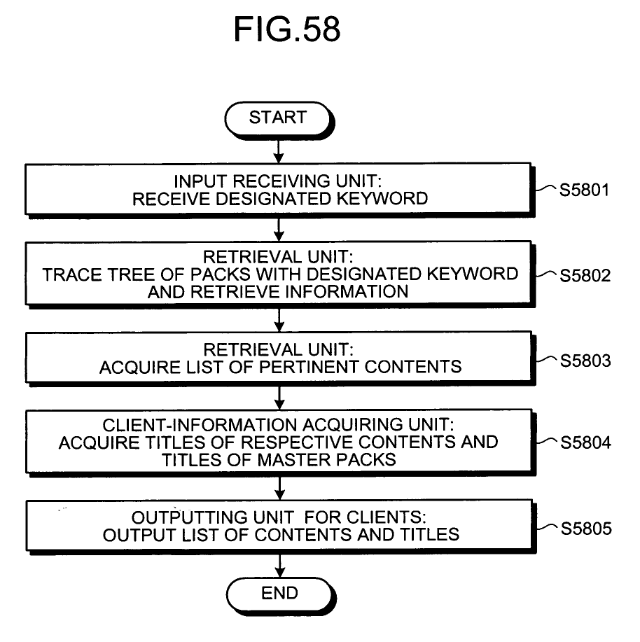

FIG. 58 is a flowchart of a processing procedure performed when “retrieve similar content” is selected by the client application 12 of the client 10a in the Web server 100 according to the present embodiment.

First, processing performed in the client 10a before the processing in the Web server 100 is explained. The client 10a displays the similarity retrieval dialog shown in FIG. 29. After a keyword is selected by a user, when a “retrieval” button is depressed, the client application 12 outputs a pack ID indicating a pack selected by right click, the keyword selected, and an indication that a similar content is retrieved. A method of extracting a keyword displayed in the similarity retrieval dialog is the same as the extraction method described above. The keyword is extracted from a bibliographic matter of the pack selected and a bibliographic matter of contents information associated with a content ID in a content ID list in the content management table.

The input receiving unit 119 of the Web server 100 receives the input of the indication that a similar content is retrieved together with the pack ID and the keyword designated (step S5801).

The retrieving unit 125 applies retrieval to packs included in the tree in the same manner with the keyword designated as the processing procedure in FIG. 50 (step S5802). The retrieval is not applied to the bibliographic matter of the pack and is applied only to the bibliographic matter of the contents information associated with the content ID managed by the pack in the content management table. Otherwise, a method of retrieval is the same as the processing procedure shown in FIGS. 51 and 52. An explanation of the method is omitted.

The retrieving unit 125 acquires a list of contents including a bibliographic matter coinciding with the keyword (step S5803).

The client-information acquiring unit 117 acquires titles of the respective contents included in the list of contents acquired and titles of master packs that manage the contents (step S5804).

The client-information acquiring unit 117 outputs a title and a title of a master pack for each of the contents included in the list of contents acquired (step S5805).

The processing procedure described above allows the Web server 100 to perform processing corresponding to the action of retrieving a similar content performed by the client 10a. The processing procedure indicates an example of a processing procedure performed when “retrieve a similar content” is selected by the client application 12 of the client 10a in the Web server 100 according to the present embodiment. The present invention is not limited to this processing procedure.

When a retrieval result is input by the Web server 100, the client application 12 displays the dialog shown in FIG. 30.

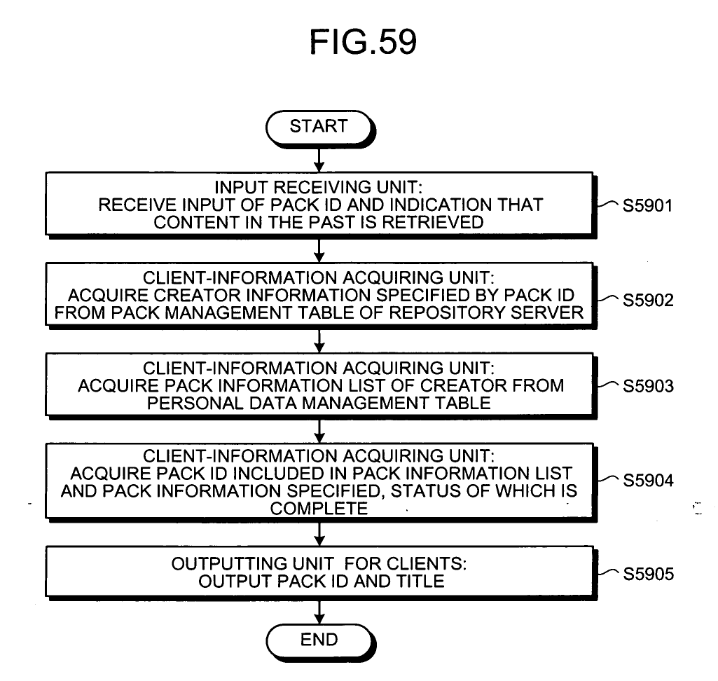

FIG. 59 is a flowchart of a processing procedure performed when “retrieve content in the past” is selected by the client application 12 of the client 10a in the Web server 100 according to the present embodiment.

First, the input receiving unit 119 of the Web server 100 receives an input of a pack ID selected and an indication that content in the past is retrieved (step S5901).

The client-information acquiring unit 117 acquires creator information associated with the pack ID from a bibliographic matter of a record specified by the pack ID received of the pack management table of the repository server 50 (step S5902). The creator information is a user ID indicating a creator.

The client-information acquiring unit 117 acquires pack information list included in personal data associated with the user ID indicating the creator from the personal data management table of the repository server 50 (step S5903).

The client-information acquiring unit 117 acquires a pack ID included in the pack information list acquired and pack information, a status of which is complete, from the pack management table of the repository server 50 (step S5904).

The output unit for clients 118 outputs a pack ID and a title included in the pack information acquired from the pack management table to the client 10a (step S5905).

The processing procedure described above allows the Web server 100 to perform processing corresponding to an action of retrieving content in the past performed by the client 10a. The processing procedure indicates a processing procedure performed when “retrieve content in the past” is selected by the client application 12 of the client 10a in the Web server 100 according to the present embodiment. The present invention is not limited to this processing procedure.

The client application 12 displays the dialog shown in FIG. 31 according to the pack ID and the title input by the processing described above.

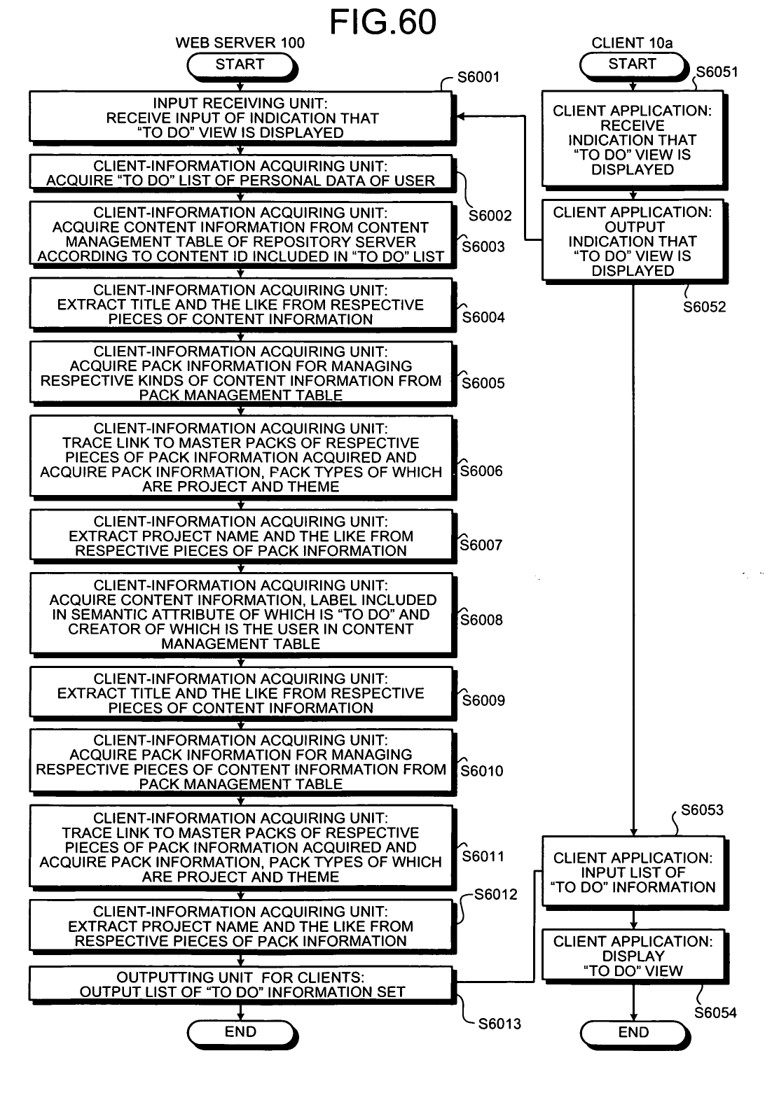

FIG. 60 is a flowchart of a processing procedure performed when the client application 12 of the client 10a receives request to display a To Do view in the Web server 100 and the client 10a according to the present embodiment.

The client application 12 of the client 10a receives an indication that a To Do view is displayed from a user (step S6051). The indication of display of a To Do view is received, for example, when the To-Do tag 807 is depressed on the screen shown in FIG. 8.

The client application 12 outputs the indication that a To Do view is displayed and a user ID of the login user (step S6052).

The input receiving unit 119 of the Web server 100 receives the input of the indication that a To Do view is displayed and the user ID (step S6001).

The client-information acquiring unit 117 acquires a To Do list included in personal data of the user specified by the user ID from the personal data management table of the repository server 50 (step S6002).

The client-information acquiring unit 117 acquires, based on respective content IDs included in the To Do list acquired, contents information corresponding to the respective content IDs from the content management table of the repository server 50 (step S6003).

The client-information acquiring unit 117 extracts a title and the like used for a To Do view from the contents information acquired (step S6004). After outputting the title and the like to the client application 12, the client-information acquiring unit 117 sets a title of a bibliographic matter extracted in details, sets an end date and time of a semantic attribute extracted in an appointed date of delivery, and sets a status extracted to be displayed as a state.

The client-information acquiring unit 117 acquires pack information for managing respective pieces of contents information from the pack management table of the repository server 50 (step S6005).

The client-information acquiring unit 117 traces a link to master packs of the pack information acquired and acquires pack information, pack types of which are a project and a theme (step S6006).

The client-information acquiring unit 117 extracts a project name and the like used for a To Do view from the pack information acquired (step S6007). The client-information acquiring unit 117 sets a title included in a bibliographic matter of the pack information, a pack type of which is a project, as a project name. The client-information acquiring unit 117 sets a title included in a bibliographic matter of the pack information, a pack type of which is a theme, as a theme name. When a pack acquired as a pack that manages contents information is a project, the client-information acquiring unit 117 sets the title of the bibliographic matter in the project name and sets “ - - - ” in the theme name.

The client-information acquiring unit 117 acquires contents information, a label included in a semantic attribute of which is “To Do” and a creator of which is the user who requested display of a To Do view, from the content management table of the repository server 50 (step S6008). The client-information acquiring unit 117 extracts a title and the like used for a To Do view from the contents information acquired from the content management table (step S6009). After outputting the title and the like to the client application 12, the client-information acquiring unit 117 sets a title of a bibliographic matter extracted in details, sets a first user in a user list of a semantic attribute extracted in a person in charge, sets an end date and time of the semantic attribute in an appointed date of delivery, and sets a status extracted to be displayed as a state.

The client-information acquiring unit 117 acquires pack information for managing the respective pieces of contents information acquired at step S6008 from the pack management table of the repository server 50 (step S6010).

The client-information acquiring unit 117 traces a link to master packs of the pack information acquired and acquires pack information, pack types of which are a project and a theme (step S6011).

The client-information acquiring unit 117 extracts a project name and the like used for a To Do view from the pack information acquired (step S6012). The client-information acquiring unit 117 sets a title included in a bibliographic matter of the pack information, a pack type of which is a project, as a project name. The client-information acquiring unit 117 sets a title included in a bibliographic matter of the pack information, a pack type of which is a theme, as a theme name. When a pack acquired as a pack that manages the contents information is a project, the client-information acquiring unit 117 sets the title of the bibliographic matter in the project name and sets “ - - - ” in the theme name.

The client-information acquiring unit 117 outputs a list of To Do information including information on the title and the like set to the client 10a (step S6013).

The client application 12 subjects the list of To Do information from the Web server 100 to input processing (step S6053).

The display processing unit 15 of the client application 12 displays a To Do view generated from the list of To Do information input (step S6054). As an example of the To Do view, there is the screen shown in FIG. 32.

The processing procedure described above allows the client 10a to display the To Do view. The processing procedure indicates an example of a processing procedure performed when the client application 12 of the client 10a according to the present embodiment receives request to display “To Do”. The present invention is not limited to this processing procedure.

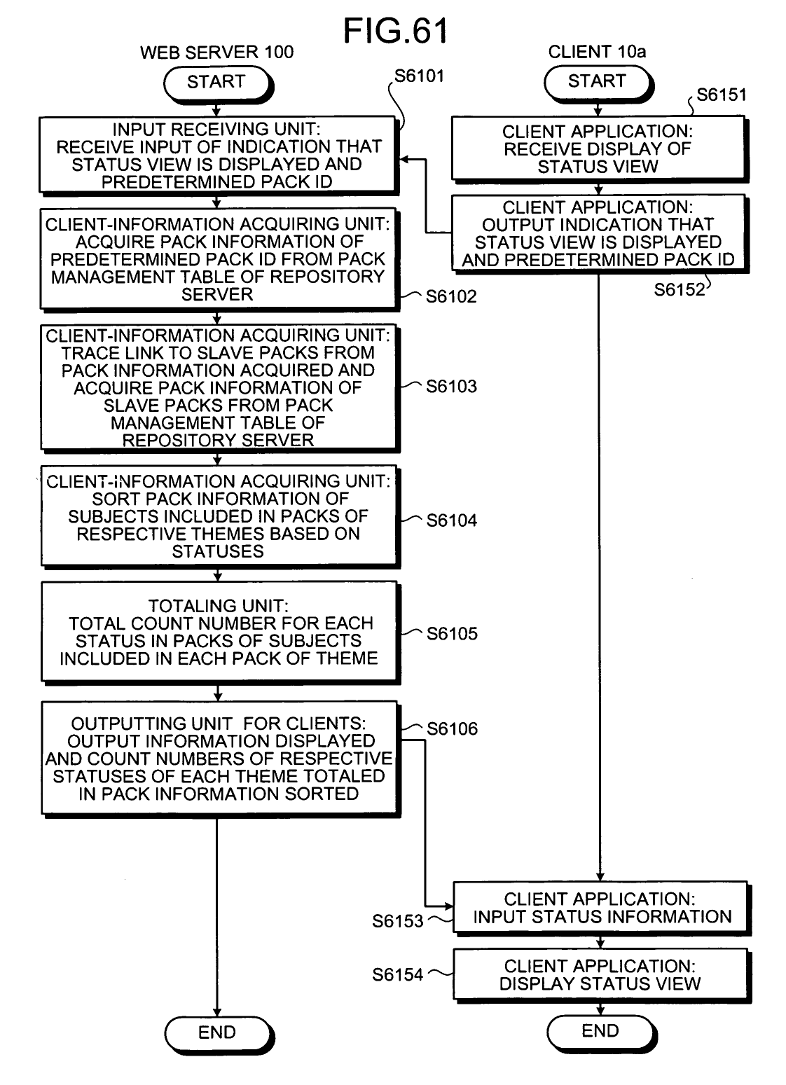

FIG. 61 is a flowchart of a processing procedure performed when the client application 12 of the client 10a receives request to display a status view in the Web server 100 and the client 10a according to the present embodiment.

The client application 12 of the client 10a receives an indication that a status view is displayed from a user (step S6151). The indication that a status view is displayed is received, for example, when the status tag 808 is depressed on the screen shown in FIG. 8.

The client application 12 outputs the indication that a status view is displayed and a pack ID of a pack selected before the status tag 808 is depressed (step S6152).

The input receiving unit 119 of the Web server 100 receives an input of the indication that a status view is displayed and a predetermined pack ID (step S6101).

The client-information acquiring unit 117 acquires pack information on the predetermined pack ID from the pack management table of the repository server 50 (step S6102).

The client-information acquiring unit 117 traces a link to slave packs included in the pack information acquired and acquires pack information on all packs in hierarchies below the pack information from the pack management table of the repository server 50 (step S6103).

The client-information acquiring unit 117 sorts pack information on subjects included in packs of respective themes based on a status in a state in which a tree structure is held in the pack information acquired (step S6104). Specifically, the client-information acquiring unit 117 checks statuses for the respective subjects included in the respective themes and apportions the statuses as a subject started, a subject not started, and a subject completed. In apportioning the statuses, if a status is not “completed”, the client-information acquiring unit 117 compares a plan end date and time of a bibliographic matter with a present date and time, calculates the number of days, and sets the number of days in a space of days until an appointed date of delivery.

The totaling unit 128 totals a count number of packs for each status in packs of subjects included in each pack of a theme (step S6105).

The output unit for clients 118 outputs pack information that keeps a sorted state based on a status and count numbers of the respective statuses for each theme totaled (step S6106).

The client application 12 inputs the pack information that keeps the sorted state and the count numbers of the respective status for each theme totaled from the Web server 100 (step S6153).

The display processing unit 15 of the client application 12 displays a status view generated from the pack information input and the count numbers of the respective status for each theme totaled (step S6154). As an example of the status view, there is the screen shown in FIG. 33.

The processing procedure described above allows the client 10a to display the status view. The processing procedure indicates an example of a processing procedure performed when the client application 12 of the client 10a according to the present embodiment receives request to display a status view. The present invention is not limited to this processing procedure.

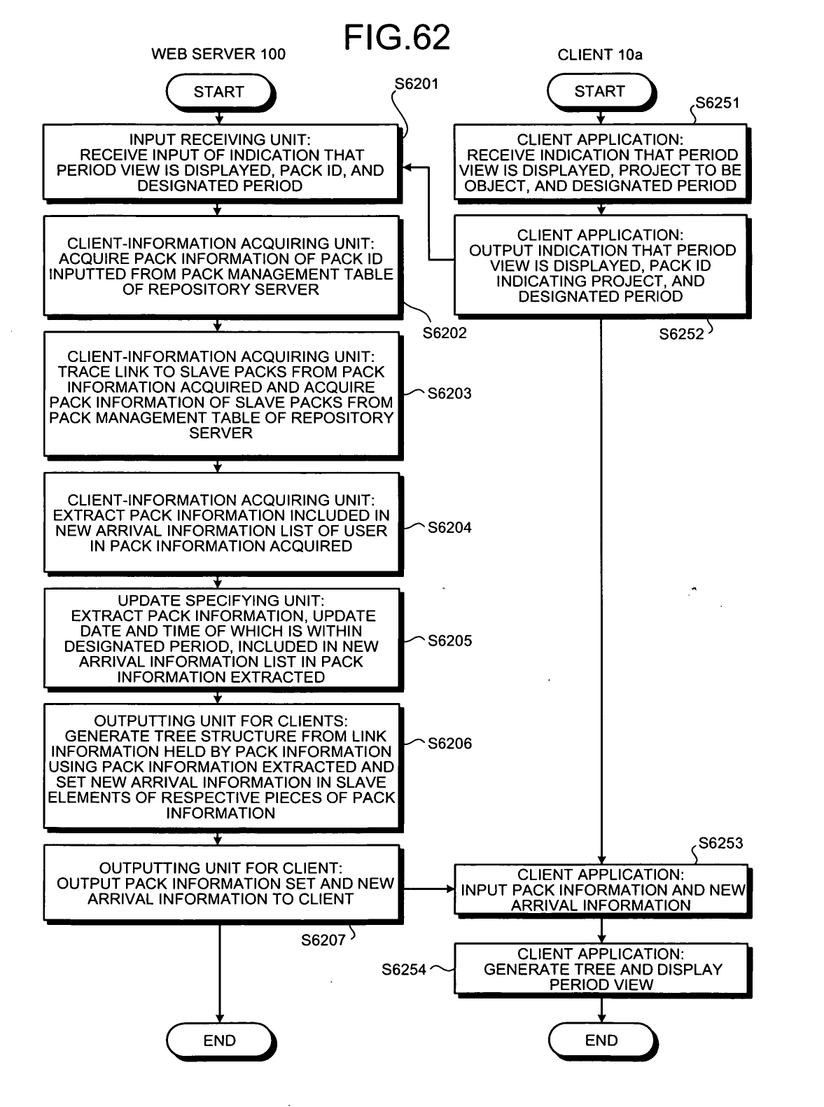

FIG. 62 is a flowchart of a processing procedure performed when the client application 12 of the client 10a receives request to display a period view in the Web server 100 and the client 10a according to the present embodiment.

The client application 12 of the client 10a receives an indication that a period view is displayed from the user (step S6251). The indication of display of the period view is received, for example, when the period tag 809 is depressed on the screen shown in FIG. 8.

The client application 12 outputs the indication what a period view is displayed, a pack ID of a pack selected before the period tag 809 is depressed, and a designated period (step S6252). The designated period is a period changeable by operation of the user.

The input receiving unit 119 of the Web server 100 receives the input of the indication that a period view is displayed, the predetermined ID, and the designated period (step S6201).

The client-information acquiring unit 117 acquires pack information on the predetermined pack ID from the pack management table of the repository server 50 (step S6202).

The client-information acquiring unit 117 traces a link to slave packs included in the pack information acquired and acquires pack information on all packs in hierarchies below the pack information from the pack management table of the repository server 50 (step S6203).

The client-information acquiring unit 117 extracts pack information included in new arrival information list of personal data of the user who requested display of a period view from the pack information acquired (step S6204). The client-information acquiring unit 117 acquires the new arrival information list of the personal data of the user from the personal data management table of the repository server 50. The new arrival information included in the new arrival information list is added when a pack is changed, for example, when the pack is created, a bibliographic matter of the pack is updated, or a status of the pack is changed. This makes it possible to judge whether an update date and time of the new arrival information is within the designated period.

The update specifying unit 129 judges, in the pack information extracted, whether an update date and time included in new arrival information associated with the pack information by a pack ID is within the designated period and extracts pack information, an update date and time of which is within the designated period (step S6205).

The output unit for clients 118 generates a tree structure according to link information on a link to master packs held by the pack information using the pack information extracted and sets new arrival information in the respective pieces of pack information as slave elements of the tree (step S6206).

The output unit for clients 118 outputs the pack information and the new arrival information set to the client 10a in a state in which the tree structure is held (step S6207).

The client application 12 inputs the pack information and the new arrival information that hold the tree structure from the Web server 100 (step S6253).

The display processing unit 15 of the client application 12 displays a period view generated from the pack information and the new arrival information input (step S6254). As an example of the period view, there is the screen shown in FIG. 34.

The processing procedure described above allows the client 10a to display the period view. The processing procedure indicates an example of a processing procedure performed when the client application 12 of the client 10a according to the present embodiment receives request to display a period view. The present invention is not limited to this processing procedure.

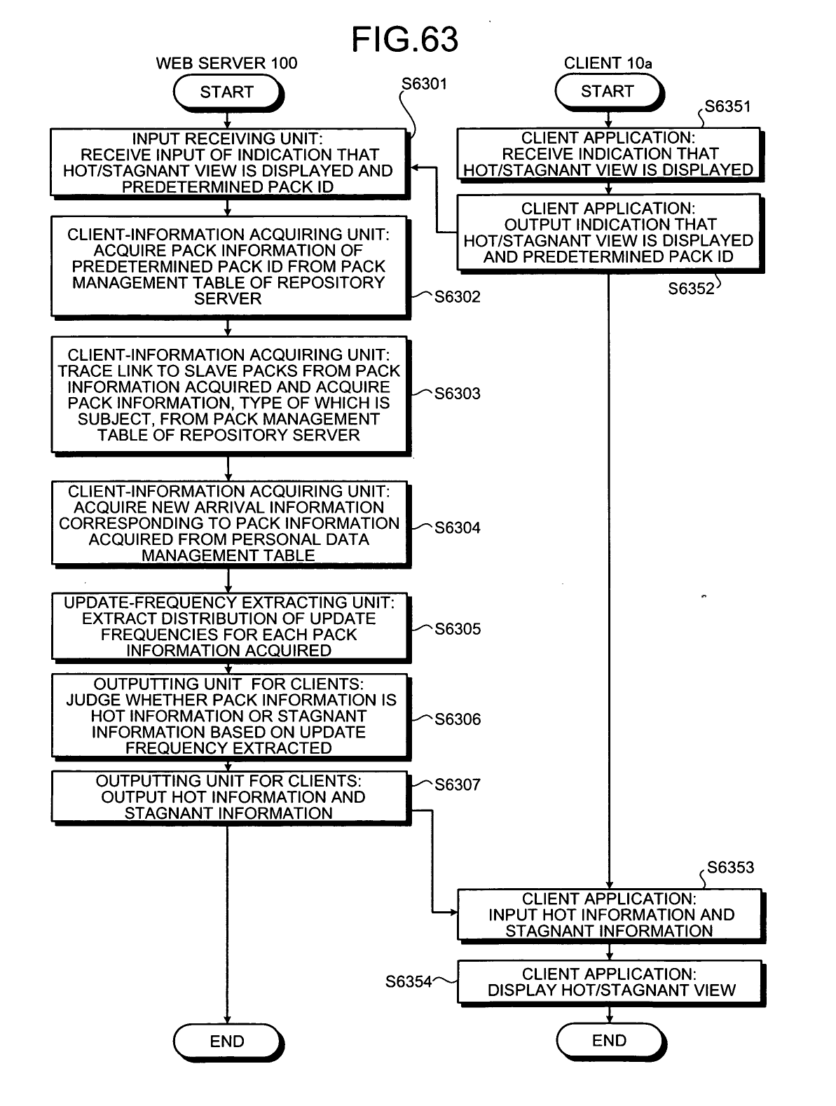

FIG. 63 is a flowchart of a processing procedure performed when the client application 12 of the client 10a receives request to display a hot/stagnant view in the Web server 100 and the client 10a according to the present embodiment.

The client application 12 of the client 10a receives an indication that a hot/stagnant view is displayed from a user (step S6351). The indication of display of the hot/stagnant view is received, for example, when the hot/stagnant tag 806 is depressed on the screen shown in FIG. 8.

The client application 12 outputs the indication that a hot-stagnant view is displayed and a pack ID of a pack selected before the hot/stagnant tag 806 is depressed (step S6352).

The input receiving unit 119 of the Web server 100 receives an input of the indication that a hot/stagnant view is displayed and the predetermined pack ID (step S6301).

The client-information acquiring unit 117 acquires pack information on the predetermined pack ID from the pack management table of the repository server 50 (step S6302).

The client-information acquiring unit 117 traces a link to slave packs included in the pack information acquired and acquires pack information on all packs in hierarchies below the pack information from the pack management table of the repository server 50 (step S6303).

The client-information acquiring unit 117 acquires new arrival information corresponding to the pack information from a new arrival information list of personal data of a user that is a member list of the pack (step S6304). The client-information acquiring unit 117 extracts only pack information in which the new arrival information is present from the pack information acquired.

The update-frequency extracting unit 130 checks an update date and time of the new arrival information and extracts a distribution of update frequencies with respect to a time axis (step S6305).

The output unit for clients 118 compares distributions extracted from all subjects acquired. The output unit for clients 118 judges pack information having a high update frequency and a center of gravity of a distribution close to the present date and time as a hot subject and judges a subject having a low update frequency and a center of gravity of a distribution far from the present date and time as a stagnant subject (step S6306). In this case, the client-information acquiring unit 117 traces links to master packs of the respective subjects, acquires pack information on a master theme, and acquires a title of a bibliographic matter included in the pack information acquired.

The output unit for clients 118 outputs hot information and stagnant information to the client 10a together with titles included in the master packs (step S6307).

The client application 12 subjects the hot information and the stagnant information transmitted from the Web server 100 to input processing together with the titles included in the master packs (step S6353).

The display processing unit 15 of the client application 12 displays a hot/stagnant view generated from the hot information and the stagnant information and the titles included in the master packs (step S6354). As an example of the hot/stagnant view, there is the screen shown in FIG. 35.

The processing procedure described above allows the client 10a to display the hot/stagnant view. The processing procedure indicates an example of a processing procedure performed when the client application 12 of the client 10a according to the present embodiment receives request to display a hot/stagnant view. The present invention is not limited to this processing procedure.

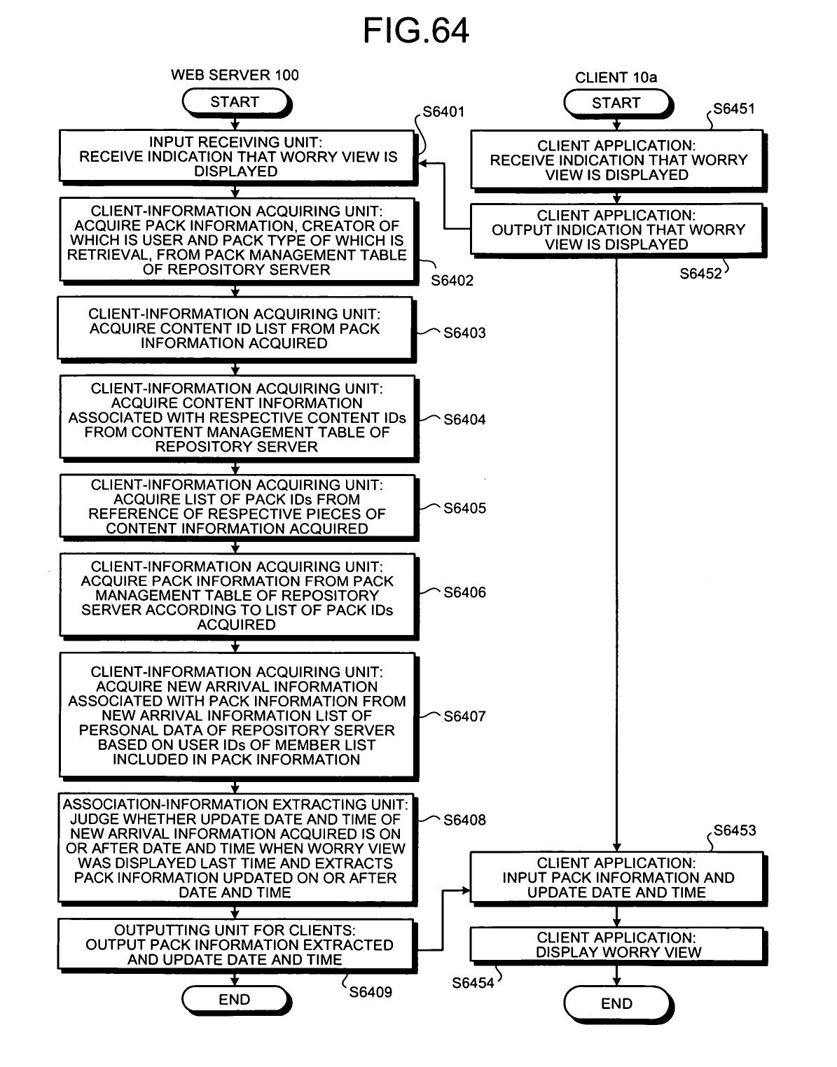

FIG. 64 is a flowchart of a processing procedure performed when the client application 12 of the client 10a receives request to display a worry view in the Web server 100 and the client 10a according to the present embodiment.

The client application 12 of the client 10a receives an indication that a worry view is displayed from a user (step S6451). The indication of display of a worry view is received, for example, when the “worried” tag 804 is depressed on the screen shown in FIG. 8.

The client application 12 outputs an indication that a worry view is displayed (step S6452).

The input receiving unit 119 of the Web server 100 receives an input of the indication that a worry view is displayed (step S6401).

The client-information acquiring unit 117 acquires pack information, the user who performed the request to display a worry view of which is a creator of a bibliographic matter and a pack type of which is retrieval, from the pack management table of the repository server 50 (step S6402).

The client-information acquiring unit 117 acquires a content ID list from the pack information acquired (step S6403).

The client-information acquiring unit 117 acquires, from the content management table of the repository server 50, contents information associated with content IDs acquired (step S6404).

The client-information acquiring unit 117 acquires pack IDs from “reference” of the respective pieces of contents information acquired (step S6405). Since a pack ID is held for each reference of the contents information, the client-information acquiring unit 117 can hold pack IDs as a list by acquiring pack IDs of all the pieces of contents information.

The client-information acquiring unit 117 acquires pack information from the pack management table of the repository server 50 according to the list of the pack IDs acquired (step S6406).

The client-information acquiring unit 117 acquires, based on user IDs of a member list included in the pack information acquired, new arrival information on the pack information from a new arrival information list of personal data associated with the respective user IDs (step S6407). The client-information acquiring unit 117 acquires the new arrival information list of the personal data from the personal data management table of the repository server 50.

The association-information extracting unit 126 judges whether an update date and time included in the new arrival information acquired is on or after a date and time when the user displayed a worry view last time and extracts pack information associated with new arrival information, an update date and time of which is on or after the date and time when the user displayed the worry view last time (step S6408). The association-information extracting unit 126 judges whether the new arrival information is updated according to whether the update date and time of the new arrival information is on or after an update date and time of a bibliographic matter of content. When the update date and time of the new arrival information is on or after the update date and time of the bibliographic matter of the content, the association-information extracting unit 126 regards that the new arrival information is updated. The association-information extracting unit 126 sets the update date and time of the content in the present date and time and updates the update date and time in the content table. Consequently, a date and time when an update state is checked in the worry view is set in an update date and time of a bibliographic matter of a content list. Thus, it is possible to always check a new update.

The output unit for clients 118 outputs the pack information extracted to the client 10a together with the update date and time (step S6409).

The client application 12 subjects the extracted pack information transmitted from the Web server 100 to input processing together with the update date and time (step S6453).

The display processing unit 15 of the client application 12 displays a worry view generated from the pack information and the update date and time input (step S6454). As an example of the worry view, there is the screen shown in FIG. 36.

The processing procedure described above allows the client 10a to display the worry view. The processing procedure indicates an example of a processing procedure performed when the client application 12 of the client 10a according to the present embodiment receives request to display a worry view. The present invention is not limited to this processing procedure.

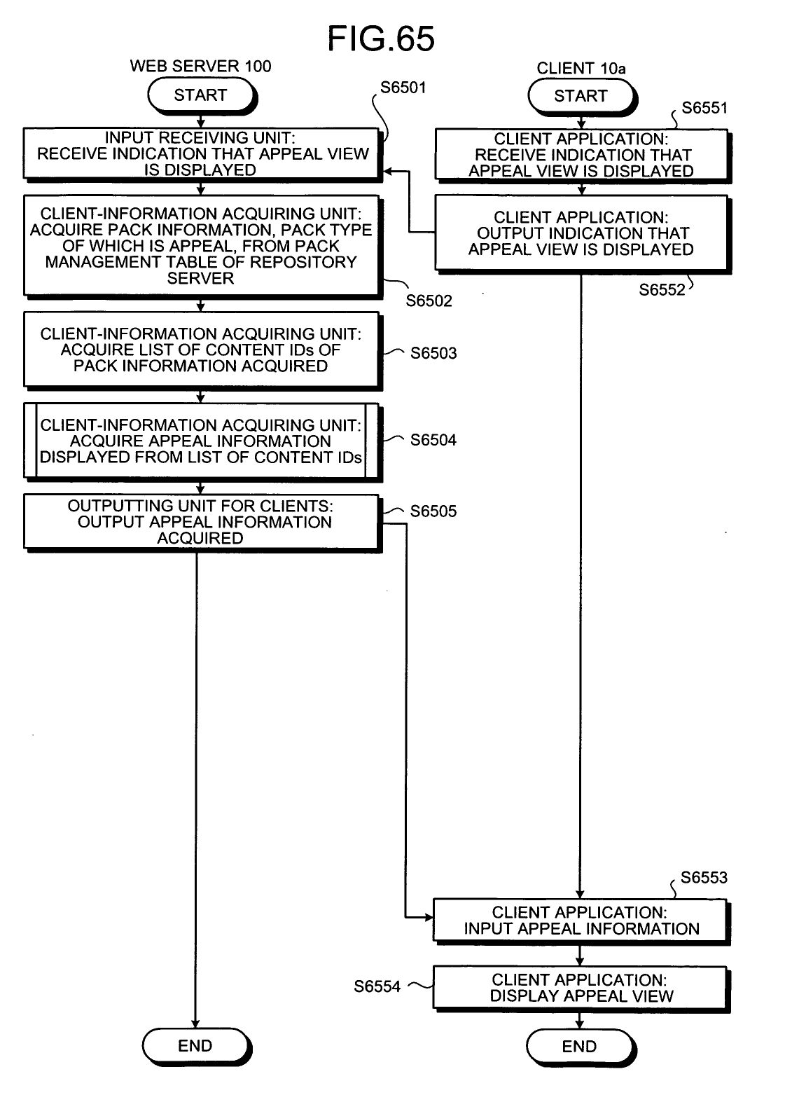

FIG. 65 is a flowchart of a processing procedure performed when the client application 12 of the client 10a receives request to display an appeal view in the Web server 100 and the client 10a according to the present embodiment.

The client application 12 of the client 10a receives an indication that an appeal view is displayed from a user (step S6551). The indication of display of the appeal view is received, for example, when the appeal tag 805 is depressed on the screen shown in FIG. 8.

The client application 12 outputs an indication that an appeal view is displayed (step S6552).

The input receiving unit 119 of the Web server 100 receives an input of the indication that an appeal view is displayed (step S6501).

The client-information acquiring unit 117 acquires pack information, a pack type of which is an appeal, from the pack management table of the repository server 50 (step S6502).

The client-information acquiring unit 117 acquires a list of content IDs from the pack information acquired (step S6503).

The client-information acquiring unit 117 acquires appeal information displayed by processing of an appeal display subroutine described later (step S6504).

The output unit for clients 118 outputs the appeal information acquired to the client 10a (step S6505).

The client application 12 subjects the extracted appeal information transmitted from the Web server 100 to input processing (step S6553).

The display processing unit 15 of the client application 12 displays an appeal view generated from the appeal information input (step S6554). As an example of the appeal view, there is the screen shown in FIG. 37.

The processing procedure described above allows the client 10a to display the appeal view. The processing procedure indicates an example of a processing procedure performed when the client application 12 of the client 10a according to the present embodiment receives request to display an appeal view. The present invention is not limited to this processing procedure.

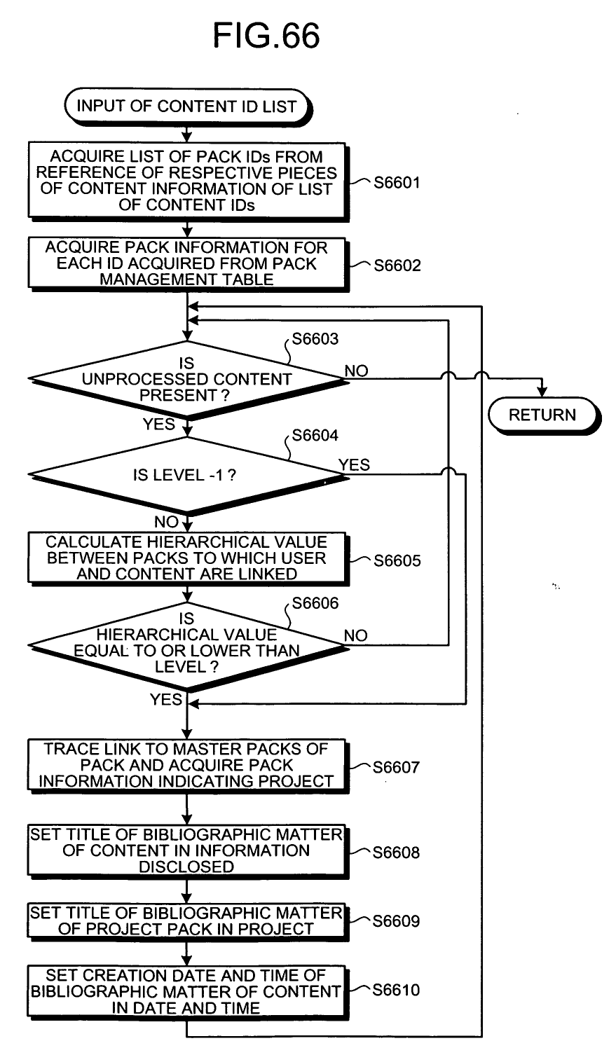

FIG. 66 is a flowchart of a processing procedure performed by the appeal display subroutine at step S6504 in FIG. 65 in the Web server 100 according to the present embodiment.

The client-information acquiring unit 117 acquires contents information specified from respective content IDs of a content ID list input and acquires pack IDs from the respective pieces of contents information (step S6601). Consequently, the client-information acquiring unit 117 acquires a list of pack IDs.

The client-information acquiring unit 117 acquires pack information for each of the pack IDs from the pack management table of the repository server 50 (step S6602).

The client-information acquiring unit 117 judges whether there is contents information, for which the following processing is not performed, in contents information associated with the content IDs input (step S6603).

When the client-information acquiring unit 117 judges that there is an unprocessed content (“Yes” at step S6603), the client-information acquiring unit 117 judges whether a level held by the contents information is ‘−1’ (step S6604).

When the client-information acquiring unit 117 judges that the level is not ‘−1’ (“No” at step S6604), the client-information acquiring unit 117 calculates a hierarchical value between a position of a pack to which a user intending to display an appeal view belongs and a position of a pack linked from reference of the contents information (step S6605).

The client-information acquiring unit 117 judges whether the hierarchical value calculated is equal to or lower than the level held by the contents information (step S6606). When the client-information acquiring unit 117 judges that the hierarchical value is not equal to or lower than the level (“No” at step S6606), the client-information acquiring unit 117 starts the processing from the judgment on whether there is unprocessed contents information at step S6603 again.

When the client-information acquiring unit 117 judges that the hierarchical value is equal to or lower than the level (“Yes” at step S6606) or when the level is ‘−1’, the client-information acquiring unit 117 traces a link to master packs included in pack information of a pack with a level equal to or lower than the level or a pack linked from reference of the contents information with the level ‘−1’ and acquires pack information, a pack type of which is a project (step S6607).

Such processing is performed when a level of content is ‘−1’ because all users can browse the content.

The client-information acquiring unit 117 sets a title of a bibliographic matter of the contents information in disclosed information on appeal information (step S6608). The appeal information means information in which information necessary for display in the appeal view is set from the contents information and the pack information. Pack IDs are included in the appeal information as non-display information.

The client-information acquiring unit 117 sets a title of a bibliographic matter, a type of which is a project, in a project of the appeal information (step S6609).

The client-information acquiring unit 117 sets a creation date and time of the bibliographic matter of the content in a date and time of the appeal view (step S6610).

The client-information acquiring unit 117 starts the processing from the judgment on whether there is unprocessed contents information at step S6603 again.

When there is no unprocessed contents information (“No” at step S6603), the client-information acquiring unit 117 ends the processing by the subroutine.

The processing procedure described above allows the Web server 100 to acquire appeal information displayed. The processing procedure indicates an example of a processing procedure until appeal information is acquired performed by the Web server 100 according to the present embodiment. The present invention is not limited to this processing procedure.

The user can select a retrieval function or a notice function from the screen shown in FIG. 37 displayed by the client application 12. The retrieval and notice functions are explained below.

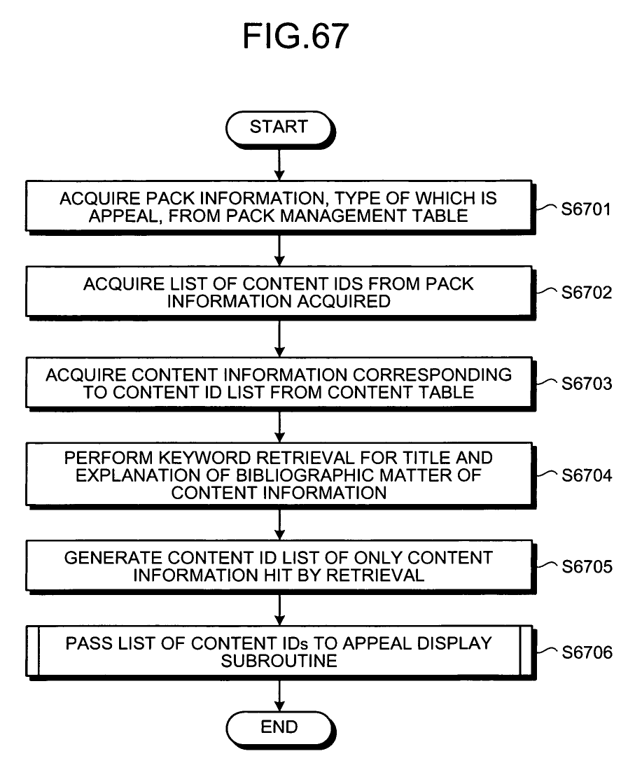

FIG. 67 is a flowchart of a processing procedure performed when retrieval of an appeal view displayed by the client application 12 is selected in the Web server 100 according to the present embodiment.

First, the client application 12 outputs a keyword used for retrieval and an indication that a retrieval button is depressed in the appeal view to the Web server 100. When the Web server 100 receives an input of the keyword and the indication that the retrieval button is depressed in the appeal view, the Web server 100 performs processing described later.

The client-information acquiring unit 117 of the Web server 100 acquires pack information, a pack type of which is a pack, from the pack management table of the repository server 50 (step S6701).

The client-information acquiring unit 117 acquires a list of content IDs from the pack information acquired (step S6702).

The client-information acquiring unit 117 acquires contents information corresponding to the respective content IDs in the list of content IDs from the content management table of the repository server 50 (step S6703).

The retrieving unit 125 performs retrieval to find whether the keyword is included in a title of a bibliographic matter and an explanation of the contents information acquired (step S6704).

The client-information acquiring unit 117 generates a list of content IDs consisting only of contents information including the keyword (step S6705).

The client-information acquiring unit 117 acquires appeal information displayed by the processing of the appeal display subroutine (step S6706).

The processing procedure described above allows the Web server 100 to acquire a result of retrieval by a keyword in the appeal view displayed. The processing procedure indicates an example of a processing procedure of retrieval performed when the retrieval button of the appeal view is depressed in the Web server 100 according to the present embodiment. The present invention is not limited to this processing procedure.

The appeal information acquired by the processing shown in FIG. 67 is outputted to the client 10a by the output unit for clients 118. Consequently, client application 12 displays a retrieval result.

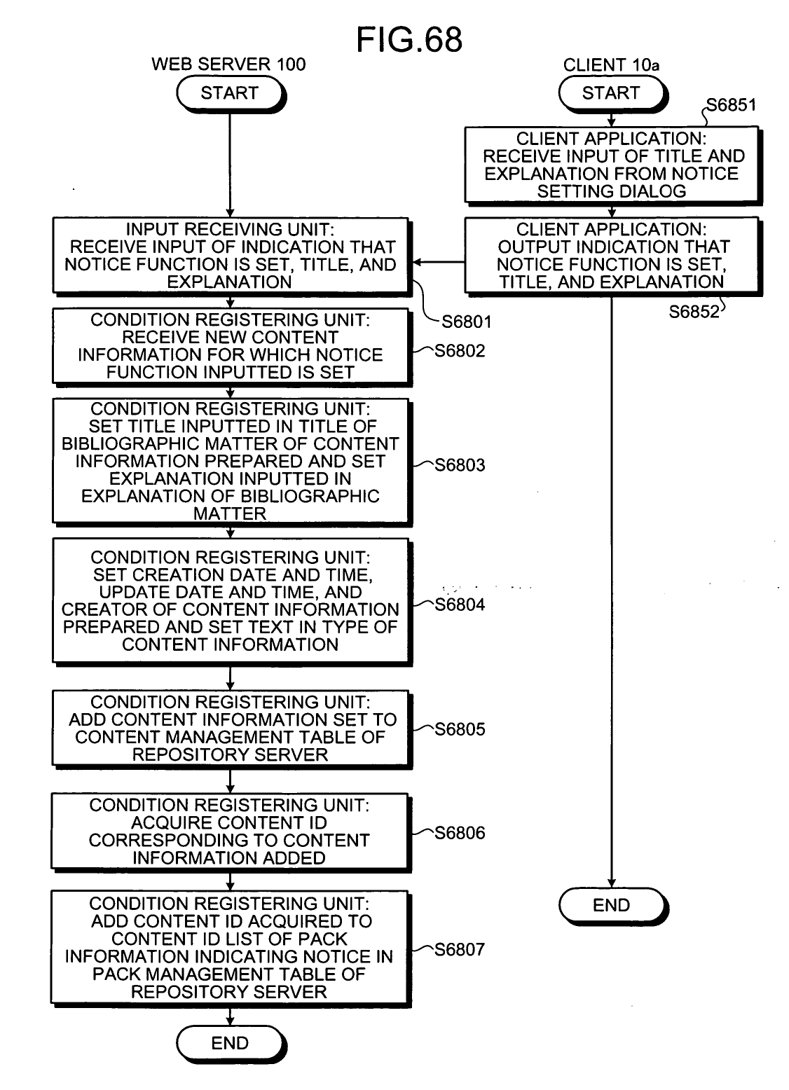

FIG. 68 is a flowchart of a processing procedure performed when the client application 12 of the client 10a receives an input of setting for the notice function in the appeal view in the Web server 100 and the client 10a according to the present embodiment.

The client application 12 of the client 10a receives an input of a title and an explanation from the notice setting dialog shown in FIG. 39 (step S6851).

The client application 12 outputs an indication that the notice function is set and the title and the explanation input (step S6852).

The input receiving unit 119 of the Web server 100 receives an input of the indication that the notice function is set and the title and the explanation (step S6801).

The condition registering unit 114 prepares, on the memory, new contents information for setting the notice function input (step S6802).

The condition registering unit 114 sets the title input in a title of a bibliographic matter of contents information prepared and sets the explanation input in an explanation of the bibliographic matter (step S6803).

The condition registering unit 114 sets the present time in a creation date and time and an update date and time of the contents information prepared, sets a user ID of the user who requested setting of the notice function in a creator of the contents information, and sets a text in a type of the contents information (step S6804).

The condition registering unit 114 instructs the repository server 50 to add the contents information set to the content management table (step S6805).

The condition registering unit 114 acquires a content ID corresponding to the contents information added from the repository server 50 (step S6806).

The condition registering unit 114 instructs the repository server 50 to add the content ID acquired to a content ID list of pack information, a pack type of which is notice (step S6807). A pack, a pack type of which is notice, is created in advance and, for example, automatically created at the time of installation of a system.

According to the processing procedure described above, the notice function is set in the client 10a. The client 10a can notify the user that content or the like coinciding with a keyword is registered. The processing procedure indicates an example of a processing procedure performed when the client application 12 of the client 10a according to the present embodiment receives request for setting the notice function. The present invention is not limited to this processing procedure.

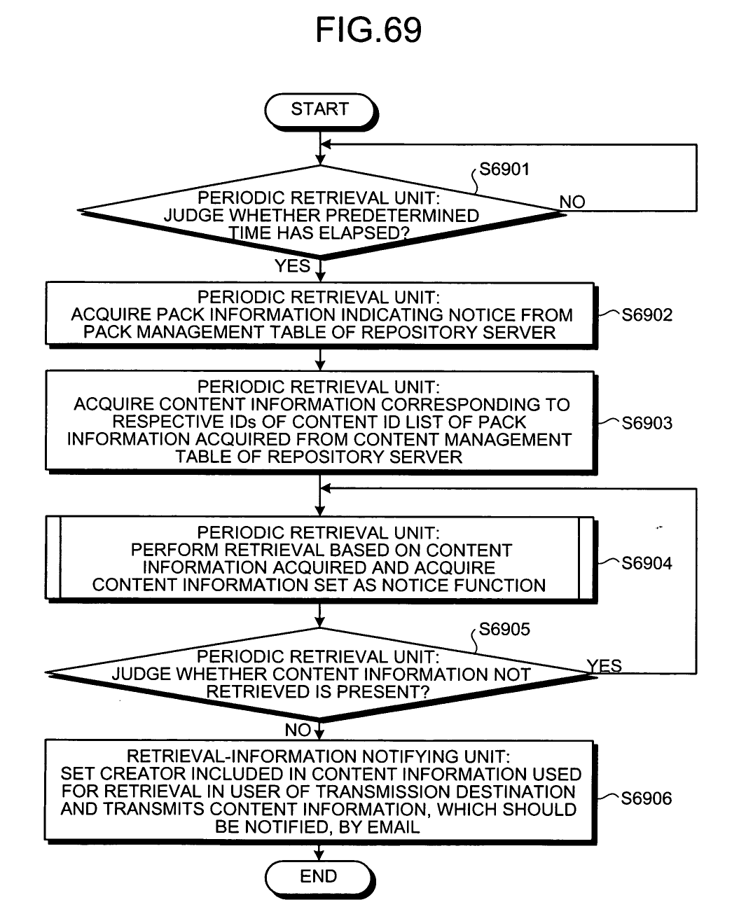

FIG. 69 is a flowchart of a processing procedure for performing retrieval based on the notice function in the Web server 100 according to the present embodiment.

First, the periodic retrieval unit 115 judges whether a predetermined time has elapsed since the last retrieval (step S6901). When the periodic retrieval unit 115 judges that the predetermined time has not elapsed (“No” at step S6901), the periodic retrieval unit 115 is on standby until the predetermined time elapses.

When the periodic retrieval unit 115 judges that the predetermined time has elapsed (“Yes” at step S6901), the periodic retrieval unit 115 acquires pack information, a pack type of which is notice, from the pack management table of the repository server 50 (step S6902).

The periodic retrieval unit 115 acquires contents information corresponding to respective content IDs of a list of content IDs of the pack information from the content management table of the repository server 50 (step S6903).

The periodic retrieval unit 115 performs retrieval based on the contents information acquired and acquires contents information set as the notice function (step S6904). A detailed procedure of the retrieval is described later.

The periodic retrieval unit 115 judges whether there is contents information for which retrieval is not performed in the contents information acquired (step S6905). When the periodic retrieval unit 115 judges that there is contents information for which retrieval is not performed (“Yes” at step S6905), the periodic retrieval unit 115 performs retrieval processing at step S6904.

The retrieval-information notifying unit 116 sets a creator included in the contents information specified by the content ID held by the pack information, a pack type of which is notice, in a user of a transmission destination, includes the creator in information for specifying contents information that should be notified, and transmits the contents information by email (step S6906). An email address corresponding to a user ID of the creator is acquired from the user table of the repository server 50. A title of the email may be any sentence, for example, “a notice function: a designated article is found”. As the information for specifying the contents information, for example, a URL of content hit by the keyword used for the retrieval is set in a text of the email.

According to the processing procedure described above, retrieval is periodically performed by the notice function set. This makes it possible to notify information retrieved. The processing procedure indicates an example of a processing procedure for performing retrieval based on the notice function in the Web server 100 according to the present embodiment. The present invention is not limited to this processing procedure.

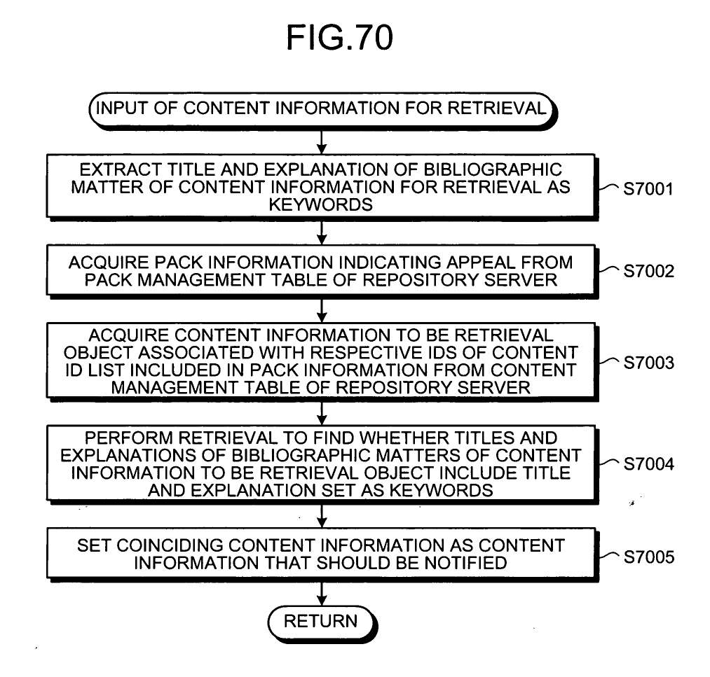

FIG. 70 is a flowchart of a procedure of detailed processing of the retrieval at step S6904 in FIG. 69 in the Web server 100 according to the present embodiment.

The periodic retrieval unit 115 extracts, as keywords used for the retrieval, a title and an explanation of a bibliographic matter of the contents information set as the notice function (step S7001).

The periodic retrieval unit 115 acquires pack information, a pack type of which is an appeal, from the pack management table of the repository server 50 (step S7002).

The periodic retrieval unit 115 acquires contents information associated with respective content IDs of a list of content IDs included in the pack information from the content management table of the repository server 50 (step S7003). The contents information acquired at step S7003 is an object of the retrieval.

The periodic retrieval unit 115 performs retrieval to find whether titles and explanations included in a bibliographic matter of the contents information, which is an object of the retrieval, include the title and the explanation set as the keywords (step S7004).

When the titles and the explanations include the title and the explanation set as the keywords, the periodic retrieval unit 115 sets the contents information, which is an object of the retrieval, as contents information that should be notified (step S7005).

The processing procedure described above allows the Web server 100 to perform retrieval of contents information with the notice function. The processing procedure indicates an example of a processing procedure for performing retrieval of contents information with the notice function in the Web server 100 according to the present embodiment. The present invention is not limited to this processing procedure.

In the present embodiment, the processing described above is performed by the Web server 100. However, an apparatus that performs the processing is not limited to the Web server 100. For example, when an input from a user is received, the client application 12 may directly perform the processing. In this case, the client application 12 directly requests an instruction from the repository server 50 and directly receives a result of processing from the repository server 50. The client application 12 holds an SOAP interface to make it possible to access a database via an interface of a repository service.

The respective components included in the Web server 100 may be provided in separate apparatuses as required. Various forms are conceivable, for example, components or the like equivalent to the input receiving unit 119 and the association output unit 120 are held by the client 10a and components corresponding to the retrieving unit 125 and the like are held by the repository server 50.

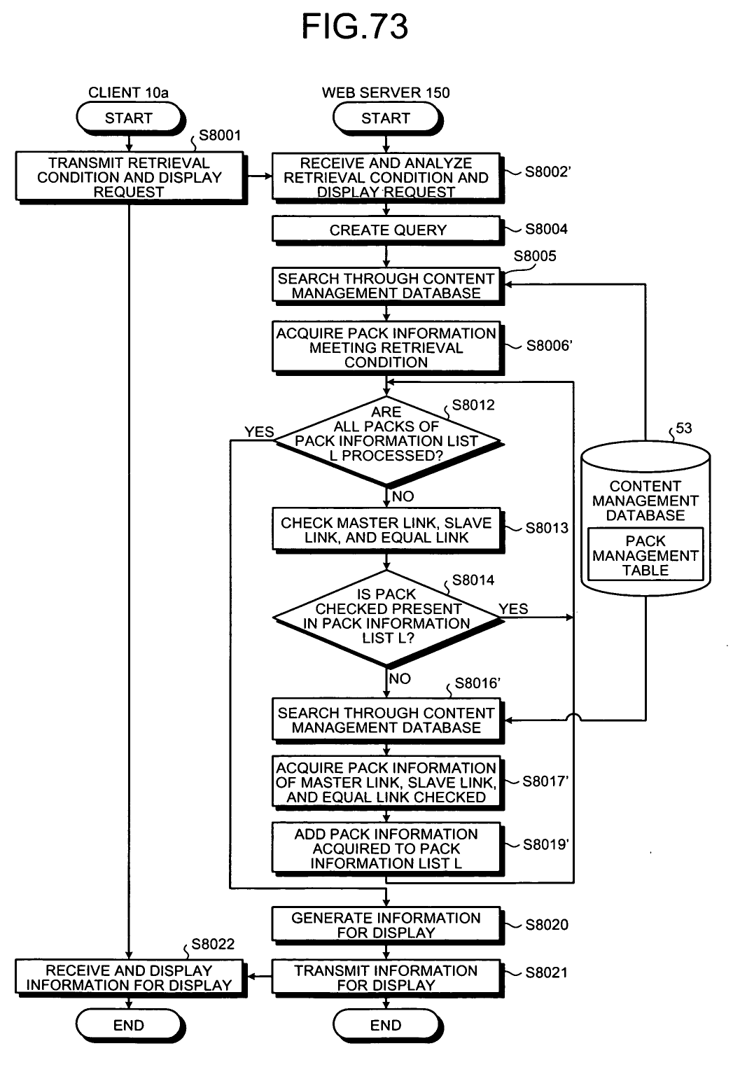

Components that make it possible to realize the processing in this way may be realized by any components of the Web server 100, the clients 10a to 10n, the repository server 50, and the like. A contents information management system is not limited to a structure including the Web server 100, the clients 10a to 10n, and the repository server 50. One server may realize the functions of the Web server 100 and the repository server 50 that perform the processing described above. A server that holds a database may hold an apparatus that performs the processing. When one server realizes the functions of the Web server 100 and the repository server 50, for example, in the processing shown in FIG. 72, the server only has to perform the processing as described below. FIG. 73 is a flowchart of a procedure of the processing performed by the server (a server 150). The server 150 receives, at step S8002′, a retrieval condition and a display request transmitted from the client 10a at step S8001. After analyzing the retrieval condition and the display request, the server 150 performs the same processing as steps S8004 and S8005. Thereafter, the server 150 acquires pack information meeting the retrieval condition from the pack management table at step S8006′ and performs the same processing as steps S8012 to 8014. When a result of the judgment at step S8014 is affirmative, the server 150 searches through the content management database 53 at step S8016′ and acquires a pertinent pack from the pack management table at step S8017′. Subsequently, at step S8019′, the server 150 applies the same processing as step S8019 to the pack information acquired at step S8016. When a result of the judgment at step S8012 is affirmative, the server 150 performs the processing at steps S8020 and S8021.

In the explanation of the present embodiment described above, an organization, a project, a theme, and a subject are present as packs. However, the packs are not limited to such types. Any types of packs may be used.

A user does not intentionally register packs and contents according to the present embodiment in a Web server from a client as in the past. In the clients 10a to 10n and the Web server 100 according to the present embodiment, the user executes some action on information displayed in the client application 12. As a result, details of the action are transmitted from the client application 12 to the Web server 100. The Web server 100 can register new information in association with a system in the table of the repository server.

The information management system including the Web server 100 and the clients 10a to 10n according to the present embodiment is characterized in that such an action not making the user aware of the registration is defined.

For example, in the conventional group ware, when a user depresses a button such as “new creation” in a menu of an application, a form is displayed. The user sets information indicating to which information the information corresponds in the form displayed, inputs details of the information, and depresses a button such as “registration” to register the information in a system. In this conventional method, the user feels as if the user performs work for registering the user's own information in the system. In other words, there is an obstacle in that the user performs another kind of work in the middle of a flow of the user's own work. Thus, in the present embodiment, action performed by the user are defined with respect to contents information or pack information to allow the user to select an action for contents information or pack information. This makes it possible to reduce obstacles such as complexity in performing work.

The contents information or the pack information managed by the contents information management system is not simply provided to the user. The structure and the processing, which make it easy to perform processing and extraction, are provided. This allows the user to easily browse and edit information. For example, the contents information management system according to the present embodiment can extract, in contents information and pack information on a hierarchical structure, user information from user lists held by the respective kinds of information and represent the user information in a hierarchical structure. In other words, it is possible to generate a human tree structure from a tree structure formed by contents information or pack information. Since it is possible to use this human tree structure for retrieval of a person, convenience is improved.

The contents information management system according to the present embodiment makes it possible to provide various views rather than simply displaying contents or packs for the user. It is possible to realize this with a data structure of the content management database 53 managed by the repository server 50 and various components that access the content management database 53. Specifically, the contents information management system make it possible to provide, for an arbitrary hierarchy of the hierarchical structure, various views for the user to display information below the hierarchy as a list, freely change a hierarchy to be browsed, extract only data of a predetermined state and display the data as a list, and collect information automatically retrieved and displayed by the system. This allows the user to easily browse desired information.

In the present embodiment, the database for managing the tables and the like is not limited to a relational database. Any database may be used. For example, it is conceivable to use an object-oriented database.

An application of the present embodiment is not limited to the system that manages projects. It is possible to apply the present embodiment to all apparatuses that manage information. For example, it is conceivable to provide the components described above in a system that manages contents of blogs, electronic bulletin boards, and the like. In the system that manages such contents, for example, it is conceivable to provide a pack for each individual and hold a diary in the pack as content. In this case, when an individual makes a comment or the like on another individual, it is possible to hold a link relation between the individuals. This makes it possible to form a tree structure based on comments and display the tree structure.

As other examples of use of the contents information management system, for example, in creating a catalogue or a manual, sharing of work is determined for each individual and this sharing is managed as a pack. In this way, as the contents information management system, it is possible to use any system as long as a plurality of users uses a group of united pieces of information.

The present invention is not limited to the above embodiments and various modifications such that explained below can be applicable.

According to the embodiments of the present invention, the tree is generated in the Web server 100, the generated tree is transmitted to the client 10a, and the transmitted tree is received and displayed by the client 10a. However, it is not limited to generate the tree through the Web server 100. As an example of a modification, it is explained that the tree is generated through the client 10a.

According to the example of the modification, each client 10a to 10n further includes a tree-structure generating unit in addition to the configuration shown in FIG. 1.

The input/output processing unit 14 in the client 10a performs input processing of an instruction for specifying the tree structure. The instruction includes instructions for, for example, displaying the tree including contents browsed or selected by a user, displaying the tree including a pack that manages the contents browsed or selected by the user, and the like. The contents and the pack are used as a basis for generating the tree. At the same time when the instruction is input, data for determining a type of the tree to be displayed is also input. The type of the tree can be arbitrary, including a tree that shows a flow of people, a tree of the pack, or the tree explained in the above embodiments.

The instructed contents and/or the instructed pack, and the data for determining the type of the tree are transmitted to the Web server 100.

The Web server 100 communicates to the repository server 50, based on the received contents and/or the received pack, and the data for determining the type of the tree, and acquires data necessary for generating the tree. The Web server 100 transmits the received data to the client 10a. An explanation of the processing procedure for the operation of acquiring the data by the Web server 100 is omitted as the procedure is the same as that explained in the above embodiments.

The tree-structure generating unit in the client 10a generates the tree from the received data, based on the data for determining the type of the tree. Thereafter, the generated tree is displayed on the client application 12 in the client 10a. Accordingly, the user can browse the tree including the contents and/or the pack, of which the user has browsed or selected, and the pack that manages the contents, resulting in easily getting to know a relation between the contents and the pack.

The tree is not necessarily displayed on the client application 12 and can be displayed on a Web browser 11. For example, the tree can be displayed on the Web browser 11 as a Java® application, based on the data received from the Web server 100. The processing procedure for the operation of displaying the tree is omitted as the procedure is the same as that above explained.

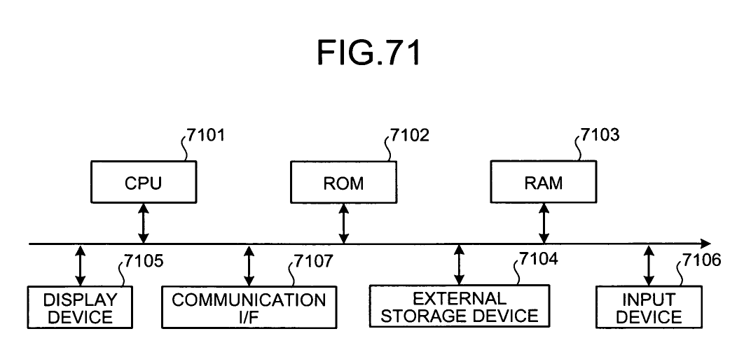

FIG. 71 is a diagram of a hardware configuration of a personal computer (PC) that executes a program for realizing the functions of the Web server 100, the clients 10a to 10n, or the repository server 50. The Web server 100, the clients 10a to 10n, or the repository server 50 according to the present embodiment includes a control device such as a central processing unit (CPU) 7101, storage devices such as a read only memory (ROM) 7102 and a random access memory (RAM) 7103, an external storage device 7104 such as a hard disk drive (HDD) or a compact disk (CD) drive device, a display device 7105 such as a display, an input device 7106 such as a keyboard or a mouse, an communication interface (I/F) 7107 that makes connection to a network, and a bus 7108 that connects these devices. The hardware configuration is a usual hardware configuration that uses a computer.

An information processing program executed by the Web server 100, the clients 10a to 10n, or the repository server 50 according to the present embodiment is recorded in a computer readable recording medium such as a compact disk-read only memory (CD-ROM), a flexible disk (FD), a compact disk-recordable (CD-R), or a digital versatile disk (DVD) as a file of an installable format or an executable format and provided.

The information processing program executed by the Web server 100, the clients 10a to 10n, or the repository server 50 according to the present embodiment may be stores on a computer connected to a network such as the Internet and provided to a user by causing the user to download the program through the network. The information processing program executed by the Web server 100, the clients 10a to 10n, or the repository server 50 according to the present embodiment may be provided or distributed through the network such as the Internet.

The information processing program according to the present embodiment may be stored in a ROM or the like in advance and provided.

The information processing program executed by the Web server 100, the clients 10a to 10n, or the repository server 50 according to the present embodiment is formed as a module including the components described above (the registering unit, the monitoring unit, the notifying unit, the condition registering unit, the periodic retrieval unit, the retrieval information notifying unit, the client-information acquiring unit, the output unit for clients, the input receiving unit, the association output unit, the information inheriting unit, the movement-association output unit, the movement-information inheriting unit, the user authenticating unit, the retrieving unit, the association-information extracting unit, the user-structure generating unit, the totaling unit, the update specifying unit, and the update-frequency extracting unit). As actual hardware, when the CPU reads out and executes the information processing program from the recording medium, the respective components are loaded on a main storage device and the registering unit, the monitoring unit, the notifying unit, the condition registering unit, the periodic retrieval unit, the retrieval information notifying unit, the client-information acquiring unit, the output unit for clients, the input receiving unit, the association output unit, the information inheriting unit, the movement-association output unit, the movement-information inheriting unit, the user authenticating unit, the retrieving unit, the association-information extracting unit, the user-structure generating unit, the totaling unit, the update specifying unit, and the update-frequency extracting unit are generated on the main storage device.

As describe above, according to an embodiment of the present invention, there is an effect that it is possible to easily provide information included in one or both of contents information and contents collection information according to request of a user.

Moreover, according to an embodiment of the present invention, there is an effect that it is easy to set information in the contents collection information and convenience is improved.

Furthermore, according to an embodiment of the present invention, there is an effect that it is possible to easily provide information included in predetermined kinds of contents information according to request of a user.

Moreover, according to an embodiment of the present invention, there is an effect that, since predetermined information is inherited when a position of the contents collection information held as a hierarchical structure is changed, it is easy to realize consistency of information.

Furthermore, according to an embodiment of the present invention, there is an effect that it is possible to easily provide, with an output not depending on an access right, information included in one or both of contents information and contents collection information according to request of a user and, since a range in which the output is possible is defined, security is improved by blocking browsing of information having a weak relation with the user.

Moreover, according to an embodiment of the present invention, there is an effect that a user can grasp a relation with other users.

Furthermore, according to an embodiment of the present invention, there is an effect that it is possible to perform retrieval even if a user does not input information and convenience is improved.

Moreover, according to an embodiment of the present invention, there is an effect that security is improved by access right control.

Furthermore, according to an embodiment of the present invention, there is an effect that it is possible to easily provide information corresponding to request of a user.

Moreover, according to an embodiment of the present invention, there is an effect that a user can check contents information or contents collection information changed within a predetermined period.

Furthermore, according to an embodiment of the present invention, there is an effect that a user can grasp an update state of content.

Moreover, according to an embodiment of the present invention, there is an effect that a user can grasp contents information or contents collection information changed.

Furthermore, according to an embodiment of the present invention, there is an effect that a user can grasp contents information or contents collection information added.

Moreover, according to an embodiment of the present invention, there is an effect that a user can easily grasp a relation among pieces of contents information or among pieces of contents collection information.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus that processes contents information that holds contents and contents collection information for managing a collection of contents information in a hierarchical structure, the information processing apparatus comprising:
an input receiving unit that receives an input of contents information or contents collection information capable of forming a hierarchical structure;
an association output unit that associates the contents information or the contents collection information received by the input receiving unit with predetermined contents information or predetermined contents collection information, and outputs the contents information or the contents collection information associated with the predetermined contents information or the predetermined contents collection information, to register in a storing unit; and
a contents output unit that outputs, from the contents information or the contents collection information that forms a tree structure including the predetermined contents information or the predetermined contents collection information according to the association by the association output unit, arbitrary contents information or arbitrary contents collection information included in the tree structure in response to a request from a user.

2. The information processing apparatus according to claim 1, wherein
upon receiving the input of the contents information, the input receiving unit further receives an input of contents-collection identification information for identifying the contents collection information for managing the contents information, and
the association output unit associates the contents information received by the input receiving unit with the contents collection information identified by the contents-collection identification information received by the input receiving unit, and outputs the contents information associated with the contents collection information identified by the contents-collection identification information, to register in the storing unit.

3. The information processing apparatus according to claim 1, wherein
upon receiving an input of first contents collection information, the input receiving unit further receives an input of contents-collection identification information for identifying second contents collection information serving as a master in a master-slave relation with the first contents collection information, and
the association output unit associates the first contents collection information as a slave and the second contents collection information identified by the contents-collection identification information as a master, and outputs the first contents collection information associated with the second contents collection information, to register in the storing unit.

4. The information processing apparatus according to claim 1, wherein
the input receiving unit receives an input of a predetermined kind of contents information, and
the association output unit associates the predetermined kind of contents information with a predetermined kind of contents collection information for managing the predetermined kind of contents information, and outputs the predetermined kind of contents information associated with the predetermined kind of contents collection information, to register in the storing unit.

5. The information processing apparatus according to claim 1, wherein
the input receiving unit further receives an input of a movement for setting slave contents collection information that is associated as a slave of arbitrary contents collection information by the association output unit as a slave of other contents collection information, and
the information processing apparatus further comprises a movement-association output unit that outputs the association for setting the slave contents collection information as a slave of the other contents collection information to register in the storing unit, and outputs a request for deleting the association between the slave contents collection information and the arbitrary contents collection information.

6. The information processing apparatus according to claim 5, further comprising:
a movement-information inheriting unit that sets, when the slave contents collection information is associated with the other contents collection information by the movement-association output unit, predetermined information associated with the other contents collection information in predetermined information associated with the slave contents collection information.

7. The information processing apparatus according to claim 1, further comprising:
an association-information extracting unit that determines whether predetermined information associated with the contents information or the contents collection information satisfies a predetermined condition, and when it is determined that the predetermined information satisfies the predetermined condition, extracts the contents information or the contents collection information associated with the predetermined information that satisfies the predetermined condition, wherein
the contents output unit outputs the contents information or the contents collection information extracted by the association-information extracting unit.

8. The information processing apparatus according to claim 1, wherein
the contents output unit outputs, upon outputting permitted-contents collection information in which an access right for permitting a user to access is set in response to a request from the user, at least one of the contents collection information forming a tree structure including the permitted-contents collection information and the contents information managed by the contents collection information regardless of the access right set in the contents collection information or the contents information.

9. The information processing apparatus according to claim 8, wherein
the contents output unit outputs, upon outputting the permitted-contents collection information, at least one of the contents collection information that forms the tree structure and that is included in an hierarchy of a predetermined range with the permitted-contents collection information as a reference and the contents information managed by the contents collection information included in the hierarchy of the predetermined range regardless of the access right set in the contents collection information or the contents information.

10. The information processing apparatus according to claim 1, further comprising:
a user-structure generating unit that generates a user tree structure indicating an association between users identified by user identification information based on the user identification information associated for each piece of contents collection information and a tree structure formed by an association between pieces of contents collection information by the association output unit.

11. The information processing apparatus according to claim 1, further comprising:
a retrieving unit that retrieves at least one of the contents information and the contents collection information based on a retrieval condition input by a user, wherein
the contents output unit acquires, upon outputting the contents information and the contents collection information retrieved by the retrieving unit, arbitrary information from the contents information or contents collection information forming a tree structure including the contents information or the contents collection information retrieved based on the association by the association output unit.

12. The information processing unit according to claim 11, wherein
the retrieving unit extracts a retrieval condition from predetermined contents collection information and predetermined contents information managed by the predetermined contents collection information, and retrieves at least one of the contents information and the contents collection information based on the extracted retrieval condition.

13. The information processing apparatus according to claim 11, wherein
the contents output unit outputs, upon outputting the contents information and the contents collection information retrieved by the retrieving unit, at least one of contents information and contents collection information, in which permission of an access by the user is set, between the contents information and the contents collection information forming a tree structure including the contents information and the contents collection information retrieved based on the association by the association output unit.

14. The information processing apparatus according to claim 1, wherein
when generator identification information for identifying a user who generates the contents information or the contents collection information or processor identification information for identifying a user, for whom predetermined processing corresponding to the contents information or the contents collection information is performed coincides with user identification information for identifying a user who makes a request for acquiring the contents information and the contents collection information, the contents output unit outputs the corresponding contents information and the corresponding contents collection information.

15. The information processing apparatus according to claim 1, further comprising:
a totaling unit that totals values held as predetermined information associated with the respective pieces of contents collection information forming a tree structure including the predetermined contents collection information, and acquires a count number for each of different values totaled according to association by the association output unit, wherein
the contents output unit outputs the count number for each of the different values acquired by the totaling unit.

16. The information processing apparatus according to claim 1, further comprising:
an update-frequency extracting unit that extracts an update frequency of at least one of an update frequency for each piece of contents information and an update frequency for each piece of contents collection information updated within a predetermined period from user update association information that associates user identification information, a date and time of update, and identification information for identifying contents information or contents collection information updated, wherein
when the update frequency extracted by the update-frequency extracting unit satisfies a predetermined standard, the contents output unit acquires at least one of the contents information and the contents collection information corresponding to the update frequency satisfying the predetermined standard.

17. The information processing apparatus according to claim 1, further comprising:
a registering unit that registers at least one of the contents information and the contents collection information designated by a user in monitoring contents collection information for managing an object to be monitored; and
a monitoring unit that detects an update of predetermined information associated with the contents information or the contents collection information managed by the monitoring contents collection information, wherein
when the monitoring unit detects the update of the predetermined information associated with the contents information or the contents collection information, the contents output unit outputs contents information or contents collection information associated with the predetermined information.

18. The information processing apparatus according to claim 1, further comprising:
a condition registering unit that registers a retrieval condition input by a user; and
a periodic retrieval unit that retrieves at least one of contents information and contents collection information for each predetermined period based on the registered retrieval condition.

19. An information display apparatus comprising:
an input processing unit that inputs contents information, contents collection information for managing the contents information in a hierarchical structure, and a hierarchical structure between pieces of the contents collection information, from an information processing apparatus; and
a display processing unit that displays the contents information and the contents collection information input by the input processing unit in a hierarchical structure.

20. An information processing method of processing contents information that holds contents and contents collection information for managing a collection of contents information in a hierarchical structure, the information processing method comprising:
receiving an input of contents information or contents collection information capable of forming a hierarchical structure;
association outputting including
associating the contents information or the contents collection information received at the receiving with predetermined contents information or predetermined contents collection information; and
outputting the contents information or the contents collection information associated with the predetermined contents information or the predetermined contents collection information, to register in a storing unit; and
outputting, from the contents information or the contents collection information that forms a tree structure including the predetermined contents information or the predetermined contents collection information according to the association at the association outputting, arbitrary contents information or arbitrary contents collection information included in the tree structure in response to a request from a user.
